(19) United States
(12) Patent Application Publication
(10) Pub. No.: US 2017/0153117 A1
(43) Pub. Date: Jun. 1, 2017

(54) INFORMATION PROVIDING SYSTEM, MOUNTED APPARATUS, AND INFORMATION PROCESSING APPARATUS

(71) Applicants: Tsutomu KAWASE, Kanagawa (JP); Michiaki SHINOTSUKA, Kanagawa (JP)

(72) Inventors: Tsutomu KAWASE, Kanagawa (JP); Michiaki SHINOTSUKA, Kanagawa (JP)

(73) Assignee: Ricoh Company, Ltd., Tokyo (JP)

(21) Appl. No.: 15/351,800

(22) Filed: Nov. 15, 2016

(30) Foreign Application Priority Data
Nov. 30, 2015 (JP) 2015-233685
Jun. 17, 2016 (JP) 2016-120643

(51) Int. Cl. G01C 21/36; G10L 19/018; G08G 1/133

(52) U.S. Cl. CPC G01C 21/3629; G08G 1/133; G10L 19/018; G01C 21/362; G01C 21/3655; G01C 21/3679

(57) ABSTRACT

An information providing system for providing information associated with a transport status of a transport vehicle includes a mounted apparatus mounted in the transport vehicle and an information processing apparatus that can communicate with the mounted apparatus. The mounted apparatus includes an audio information storage device that stores a plurality of items of audio information having predetermined identification information embedded in an audible sound range, and a processor configured to provide guidance information associated with the transport status of the transport vehicle through audio broadcast using the plurality of items of audio information. The information processing apparatus includes a processor configured to receive from an information terminal that has acquired the predetermined identification information included in the guidance information, request information including the predetermined identification information and terminal identification information identifying the information terminal, and provide to the information terminal, information that is associated with the predetermined identification information.

### CROSS-REFERENCE TO RELATED APPLICATIONS

The present application claims priority under 35 U.S.C. §119 to Japanese Patent Application No. 2015-233685 filed on Nov. 30, 2015 and Japanese Patent Application No. 2016-120643 filed on Jun. 17, 2016, the entire contents of which are incorporated herein by reference.

### BACKGROUND OF THE INVENTION

1. Field of the Invention

The present invention relates to an information providing system, a mounted apparatus, and an information processing apparatus.

2. Description of the Related Art

Information providing systems are known that provide information, such as bus operation status and information on bus stops, to users of a bus through audio broadcast.

For example, Japanese Unexamined Patent Publication No. 2006-209574 describes a bus guidance broadcast apparatus that detects a current position of a bus and controls a broadcast output unit based on a positional relationship between the current position of the bus and the positions of bus stops or corresponding ranges of the bus stops that are registered in advance.

### SUMMARY OF THE INVENTION

According to one embodiment of the present invention, an information providing system for providing information associated with a transport status of a transport vehicle is provided. The information providing system includes a mounted apparatus that is mounted in the transport vehicle and is configured to provide guidance information associated with the transport status of the transport vehicle through audio broadcast, and an information processing apparatus that is capable of establishing communication with the mounted apparatus. The mounted apparatus includes an audio information storage device configured to store in advance a plurality of items of audio information having predetermined identification information embedded in an audible sound range of the audio information, and a first processor configured to execute a first program stored in a first memory to implement a process of providing the guidance information associated with the transport status of the transport vehicle through audio broadcast using the plurality of items of audio information stored in the audio information storage device. The information processing apparatus includes a second processor configured to execute a second program stored in a second memory to implement processes of receiving from an information terminal that has acquired the predetermined identification information included in the guidance information, request information including the predetermined identification information and terminal identification information identifying the information terminal, and providing to the information terminal, information that is associated with the predetermined identification information included in the received request information.

### BRIEF DESCRIPTION OF THE DRAWINGS

FIG. 1 is a diagram illustrating an example configuration of an information providing system according to a first embodiment of the present invention;

FIG. 2 is a diagram illustrating an example configuration of a vehicle-mounted system according to the first embodiment;

FIG. 3 is a table indicating examples of audio information and identification information embedded in the audio information according to the first embodiment;

FIGS. 4A and 4B are diagrams illustrating an example method of embedding identification information into audio information according to the first embodiment;

FIGS. 5A and 5B are diagrams illustrating example display screens of an information terminal according to the first embodiment;

FIG. 6 is a diagram illustrating an example hardware configuration of a computer according to the first embodiment;

FIG. 7 is a diagram illustrating an example hardware configuration of a vehicle-mounted apparatus according to the first embodiment;

FIG. 8 is a diagram illustrating an example hardware configuration of an information terminal according to the first embodiment;

FIG. 9 is a diagram illustrating an example functional configuration of the information providing system according to the first embodiment;

FIGS. 10A-10C are tables indicating examples of audio information according to the first embodiment;

FIG. 11 is a table indicating examples of operation information according to the first embodiment;

FIGS. 12A and 12B are tables indicating examples of the content information according to the first embodiment;

FIG. 13 is a sequence chart illustrating an example operation information providing process according to the first embodiment;

FIG. 14 is a sequence chart illustrating an example content providing process according to the first embodiment;

FIG. 15 is a sequence chart illustrating another example content providing process according to the first embodiment;

FIGS. 16A and 16B are diagrams illustrating example display screens of the information terminal according to a second embodiment of the present invention;

FIG. 17 is a sequence chart illustrating an example bus stop registration process according to the second embodiment;

FIG. 18 is a diagram illustrating an example display screen of the vehicle-mounted system according to the second embodiment;

FIG. 19 is a flowchart illustrating an example notification process implemented by the information terminal according to the second embodiment;

FIG. 20 is a diagram illustrating an example configuration of the information providing system according to a third embodiment of the present invention;

FIGS. 21A and 21B are diagrams illustrating example display screens of the information terminal according to the third embodiment;

FIG. 22 is a flowchart illustrating an example process implemented by the information terminal according to the third embodiment;

FIG. 23 is a flowchart illustrating another example process implemented by the information terminal according to the third embodiment;

FIGS. 24A and 24B are diagrams illustrating an example ship layout according to a fourth embodiment of the present invention;

FIG. 25 is a diagram illustrating an example method of embedding identification information into audio information according to the fourth embodiment;

FIG. 26 is a diagram illustrating an example hardware configuration of an output device according to the fourth embodiment;

FIG. 27 is a diagram illustrating an example hardware configuration of a mounted apparatus according to the fourth embodiment;

FIG. 28 is a diagram illustrating an example functional configuration of the information providing system according to the fourth embodiment;

FIGS. 29A-29C are tables indicating examples of audio information according to the fourth embodiment;

FIGS. 30A-30C are tables indicating examples of information managed by the information providing system according to the fourth embodiment;

FIG. 31 is a sequence chart illustrating an example information providing process according to the fourth embodiment;

FIGS. 32A and 32B are diagrams illustrating example display screens of the information terminal according to the fourth embodiment;

FIG. 33 is a diagram illustrating an example functional configuration of the information providing system according to a fifth embodiment of the present invention;

FIG. 34 is a diagram illustrating an example seat layout of an aircraft according to the fifth embodiment;

FIGS. 35A-35C are tables indicating examples of audio information according to the fifth embodiment;

FIG. 36 is a sequence chart illustrating an example information providing process according to the fifth embodiment;

FIGS. 37A and 37B are diagrams illustrating example display screens of the information terminal according to the fifth embodiment;

FIG. 38 is a diagram illustrating an example configuration of the information providing system according to a sixth embodiment of the present invention;

FIG. 39 is a diagram illustrating an example functional configuration of the information providing system according to the sixth embodiment;

FIGS. 40A-40C are tables indicating examples of audio information according to the sixth embodiment;

FIG. 41 is a sequence chart illustrating an example information providing process according to the sixth embodiment; and

FIGS. 42A and 42B are diagrams illustrating example display screens of the information terminal according to the sixth embodiment.

### DESCRIPTION OF THE EMBODIMENTS

An aspect of the present invention is directed to providing a user of a transport vehicle, such as a bus, a ship, an aircraft, or a train, with detailed information associated with the transport status of the transport vehicle to thereby improve convenience for the user.

In the following, embodiments of the present invention are described with reference to the accompanying drawings.

<System Configuration>

An overall configuration of an information providing system 100 according to an embodiment of the present invention will be described below.

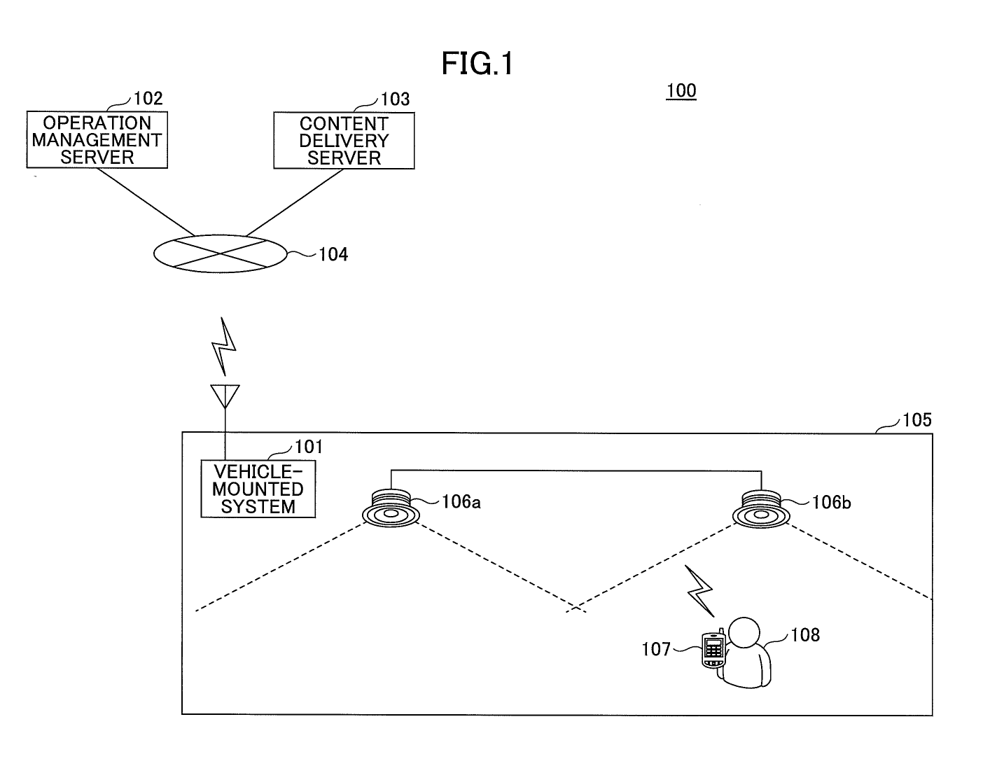

FIG. 1 is a diagram illustrating an example configuration of the information providing system 100 according to a first embodiment of the present invention. The information providing system 100 illustrated in FIG. 1 is a system for providing a user of a bus with relevant information associated with the operation status of the bus, for example. The relevant information associated with the operation status of the bus may include various items of information, such as the destination of the bus, the next bus stop for the bus, the estimated arrival time of the bus at each bus stop, traffic congestion information, and delay information, for example.

The information providing system 100 also provides various items of additional information associated with the operation status of the bus (e.g., ad information and warning information) along with the relevant information associated with the operation status of the bus.

Note that a bus is an example of a transport vehicle for transporting a passenger (user). Other examples of transport vehicles include land vehicles, such as a train, a monorail, and a tram, as well as non-land vehicles, such as a ship, an aircraft, and an elevator, for example. Also, a bus stop is an example of a place where a passenger can get on or off the transport vehicle, and the operation status of the bus is an example of information on the transport status (e.g., operation status, navigation status, or flight operation status) of the transport vehicle.

In the example of FIG. 1, the information providing system 100 includes an operation management server 102, a content delivery server 103, a vehicle-mounted system 101 that is mounted on a bus 105, and an information terminal 107 carried by a user 108 of the bus 105. The operation management server 102 and the content delivery server 103 are connected to a network 104 such as the Internet or a LAN (Local Area Network), for example. Further, the vehicle-mounted system 101 and the information terminal 107 are connected to the network 104 using wireless communication, such as LTE (Long Term Evolution) or a wireless LAN, to establish communication with the content delivery server 103 and the operation management server 102, for example.

The vehicle-mounted system 101 includes devices, such as an audio broadcast device, a fare indicator, a fare box, and stop buttons that are typically mounted on a bus, for example. The vehicle-mounted system 101 provides the user 108 of the bus 105 with audio information associated with the operation status of the bus 105 (e.g., announcements on the destination of the bus and/or the next bus stop) using internal speakers 106a and 106b that are installed in the bus 105, for example.

Also, in the present embodiment, vehicle identification information identifying the bus 105 (hereinafter referred to as “vehicle ID”) and position identification information identifying the position of the bus 105 (hereinafter referred to as “bus stop ID”) are embedded in an audible sound range of audio information provided by the vehicle-mounted system 101. For example, identification information, such as the vehicle ID and the bus stop ID, may be embedded as digital watermarks in a frequency band from 100 Hz to 12 kHz of the audio information according to the present embodiment. Note that the vehicle ID is one example of transport vehicle identification information.

Also, in another example, identification information, such as the vehicle ID and the bus stop ID, may be embedded in the audio information as a characteristic service sound. In this case, the service sound may be played at the beginning or end of an audio broadcast or in the background, for example. Specific examples of service sounds include an alert sound before the audio broadcast, a sound of the forest, a sound of waterfalls, and a sound of a particular season that may be output in the audible sound range along with the audio information.

In this way, the vehicle-mounted system 101 according to the present embodiment can convey audio information including identification information, such as the vehicle ID and the bust stop ID, throughout the entire bus 105 using existing devices, such as the internal speakers 106a and 106b and other broadcast equipment. Note that digital watermarking of identification information is described in detail below.

With the above configuration, the information terminal 107 may be able to acquire audio information provided by the vehicle-mounted system 101 using a microphone included in the information terminal 107 and extract information, such as the vehicle ID of the bus 105 and the bus stop ID identifying the position of the bus 105, from the acquired audio information.

The operation management server 102 is a system including one or more information processing apparatuses that manage information relating to the operation status of the bus 105 (hereinafter, referred to as “operation information”). The operation management server 102 may receive from the bus 105 information indicating the position of the bus 105 via the network 104 and manage operation information, such as the current position, position history, and the destination of the bus 105, and the estimated arrival time of the bus 105 at each bus stop, for example. Note that the information indicating the position of the bus 105 may include positioning information obtained by the bus 105 using a GPS (Global Positioning System) device, for example. Further, because positioning information obtained by a GPS device may include some errors, the information indicating the position of the bus 105 preferably includes a bus stop ID or some other identification information based on a predetermined operation by a driver of the bus 105 (e.g., output operation of audio information notifying the next bus stop), for example.

Also, the operation management server 102 receives, from the information terminal 107, the vehicle ID of the bus 105 that has been acquired by the information terminal 107, and provides at least a part of the operation information of the bus 105 managed by the operation management server 102 based on the received vehicle ID. Note that operation information is an example of transport information associated with the transport status of a transport vehicle.

The content delivery server 103 provides various content (e.g., ad information concerning shops and establishments around a bus stop) to the information terminal 107 based on the operation status of the bus 105. For example, identification information identifying predetermined content (hereinafter referred to as “content ID”) may be embedded in the audio information provided by the vehicle-mounted system 101 as a digital watermark or the like. The content delivery server 103 receives request information including a content ID extracted from audio information by the information terminal 107 and provides predetermined content associated with the content ID to the information terminal 107 in response to the request information.

(Configuration of Vehicle-Mounted System)

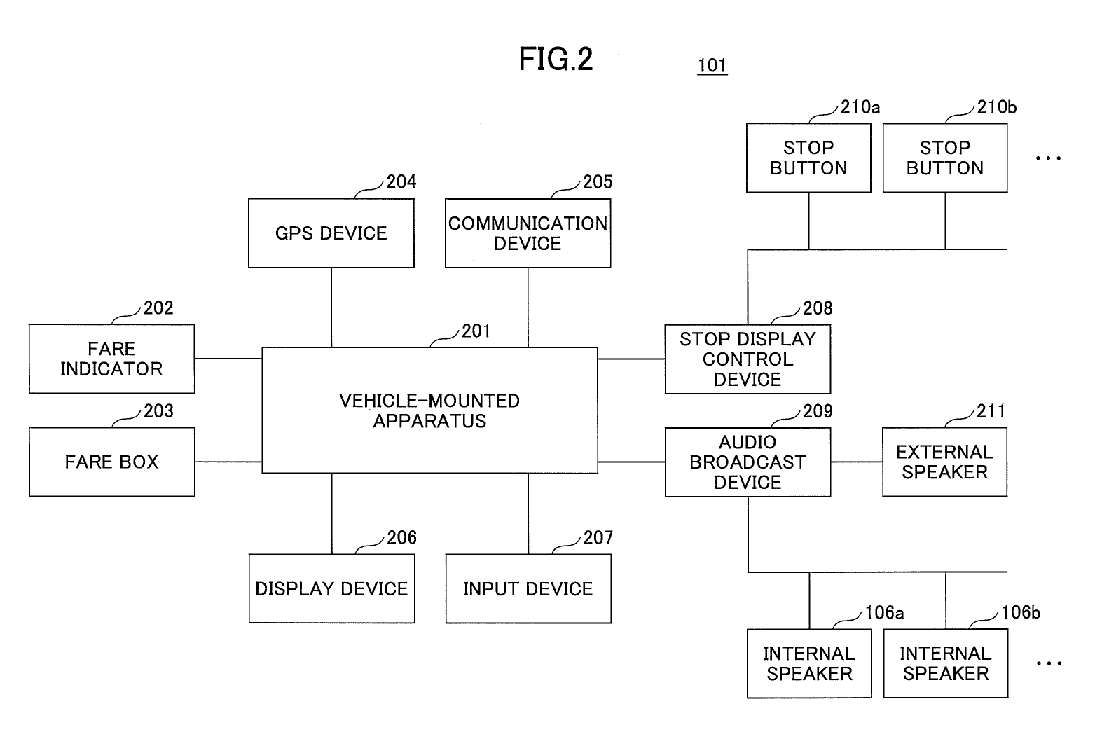

FIG. 2 is a diagram illustrating an example configuration of the vehicle-mounted system 101 according to the present embodiment. In the example of FIG. 2, the vehicle-mounted system 101 includes a vehicle-mounted apparatus (mounted apparatus) 201, a fare indicator 202, a fare box 203, a GPS (Global Positioning System) device 204, a communication device 205, a display device 206, an input device 207, a stop display control device 208, an audio broadcast device 209, a plurality of stop buttons 210a and 210b, an external speaker 211, and a plurality of internal speakers 106a and 106b.

The vehicle-mounted apparatus 201 has a general computer configuration and is configured to control the vehicle-mounted system 101 by executing a program of the vehicle-mounted apparatus 201.

The fare indicator 202 is a device for indicating fare information within the bus 105. For example, the fare indicator 202 may be controlled by the vehicle-mounted apparatus 201 to indicate the fare for travelling each section within the route of the bus 105 so that the user of the bus 105 may be able to easily determine the fare the user has to pay.

The fare box 203 is a device installed in the bus 105 for collecting bus fares. For example, the fare box 203 may accept coins, bills, and IC card payments from users of the bus 105.

The GPS device 204 receives radio waves transmitted from a GPS satellite and measures the current position of the bus 105 based on the received radio waves, for example.

The communication device 205 is connected to the network 104 by wireless communication, such as LTE, to establish communication with the operation management server 102 and the content delivery server 103, for example. Note that in some embodiments, the communication device 205 may be included in the vehicle-mounted apparatus 201, for example.

The display device 206 may be controlled by the vehicle-mounted apparatus 201 to display various items of display information associated with the operation status of the bus 105 to the driver (operation staff) of the bus 105, for example. In the following, it is assumed that the display device 206 is a touch panel display. However, in other embodiments, the display device 206 may also include various types of lamps, for example.

The input device 207 accepts an input operation from the driver of the bus 105, for example. The input device 207 may be a touch panel that is integrated with the display device 206, or a device having buttons and/or switches, for example.

The stop display control unit 208 notifies the driver of the bus 105 that one of the stop buttons 210a and 210b has been pushed by a user (passenger) that wishes to get off the bus 105. For example, the stop display control unit 208 may notify the vehicle-mounted apparatus 201 that one of the stop buttons 210a and 210b has been pushed, and the vehicle-mounted apparatus 201 may control the display device 206 to display information indicating that a stop button has been pushed. Alternatively, the stop display control unit 208 may turn on a lamp or the like that is installed near the driver's seat to notify the driver that the stop button has been pushed. The audio broadcast device 209 is controlled by the vehicle-mounted apparatus 201 to output audio information to the internal speakers 106a, 106b, and the external speaker 211.

Note that the present embodiment contemplates implementing the above-described functions and features of the vehicle-mounted system 101 using existing devices that are typically installed in the bus 105.

(Audio Information)

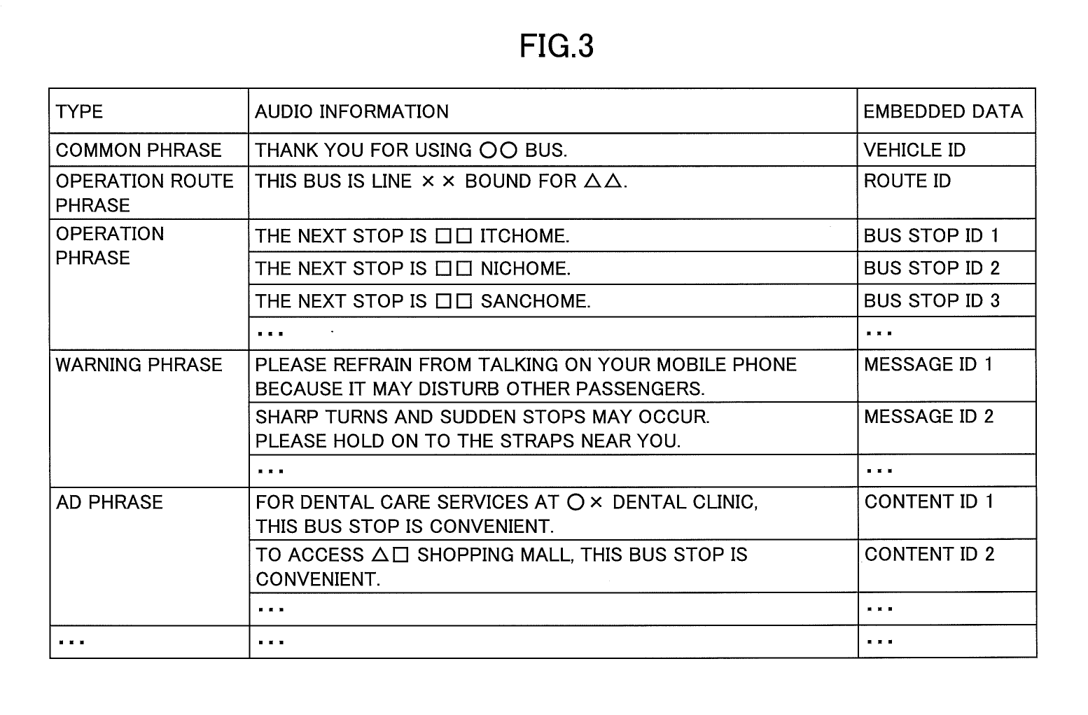

FIG. 3 is a table indicating examples of audio information and identification information embedded in the audio information according to the present embodiment. Example types of audio information provided by the vehicle-mounted apparatus 201 of the bus 105 using the audio broadcast device 209 include “common phrase” “operation route phrase”, “operation phrase”, “warning phrase”, and “ad phrase” as listed under “type” in FIG. 3.

The common phrase is common audio information commonly included in the audio information provided by the vehicle-mounted apparatus 201, such as “Thank you for using ◯◯ bus.” In the present embodiment, a bus ID for identifying the bus 105 is embedded in the common phrase as a digital watermark, for example.

The operation route phrase is common audio information commonly included in the audio information provided by the vehicle-mounted apparatus 201 of the bus 105 on a particular route, such as “This bus is XX line bound for ΔΔ.” In the present embodiment, identification information identifying the particular route (hereinafter, referred to as “route ID”) is embedded in the operation route phrase as a digital watermark, for example.

Note that the common phrase and the operation route phrase are examples of common audio information commonly included in the audio information provided by the bus 105.

The operation phrase is individual audio information included in the audio information provided by the vehicle-mounted apparatus 201, such as “The next stop is □□ itchome,” that varies depending on the current position of the bus 105. In the present embodiment, a bus stop ID identifying a bus stop is embedded in the operation phrase as a digital watermark, for example. Note that the bus stop ID is an example of identification information identifying the position of the bus 105. Also, the operation phrase is an example of individual audio information having identification information identifying the position of the bus 105 embedded therein as a digital watermark, for example. Note that different operation phrases are associated with different bus stops and one of the operation phrases may be selectively provided by the vehicle-mounted apparatus 201 according to the current position of the bus 105.

The warning phrase is additional audio information, such as “Please refrain from talking on your mobile phone call because it may disturb other passengers,” that may be included in the audio information provided by the vehicle-mounted apparatus 201. In the present embodiment, identification information identifying a message (hereinafter referred to as “message ID”) is embedded in the warning phrase as a digital watermark, for example.

The ad phrase is additional audio information, such as “For dental care services at ◯X dental clinic, this bus stop is convenient,” corresponding to advertisement information (an example of content) associated with a particular bus stop that may be included in the audio information provided by the vehicle-mounted apparatus 201. In the present embodiment, identification information identifying the content (hereinafter, referred to as “content ID”) is embedded in the ad phrase as a digital watermark, for example.

Note that the warning phrase and the ad phrase are examples of additional audio information that may be added to the audio information provided by the vehicle-mounted apparatus 201. Further, the message ID and the content ID are examples of content identification information identifying predetermined content.

For example, when the next bus stop is “□□ itchome”, the vehicle-mounted apparatus 201 of the bus 105 may provide audio information as follows: “Thank you for using ◯◯ bus. This bus is XX line bound for ΔΔ. The next stop is □□ itchome.” In this way, the information terminal 107 that acquires the audio information may analyze the digital watermark included in the acquired audio information to obtain information, such as the vehicle ID and the route ID of the bus 105 and the bus stop ID indicating the position of the bus 105, for example.

(Digital Watermark)

Example methods of embedding identification information in audio information include conveying the identification information using an inaudible sound range close to ultrasound (e.g., high frequency range greater than 16 kHz), and embedding the identification information in an audible sound range (e.g., frequency band from 20 Hz to 16 kHz) of audio information as a digital watermark, for example.

In the present embodiment, identification information is embedded as a digital watermark in the audible sound range of audio information representing an announcement to be broadcast in the bus 105, for example. Note that techniques such as steganography may be used to embed the identification information, for example. Example steganography methods for embedding identification information in the audible sound range of audio information include spread spectrum, echo, and modulation, all of which involve embedding information in a certain frequency range.

Note that the certain frequency range may consist of a plurality of encoded frequency bands within a sound range from 100 Hz to 12 kHz (that can be easily spread by an ordinary speaker), for example, of an audible sound range of a typical adult which may be from around 20 Hz to 16 kHz, for example.

Note that digital watermarking in the present embodiment involves embedding identification information by slightly altering the audio information itself to an extent unrecognizable by a human being, and in some cases, the audio information and the identification information may not be easily separated from one another. That is, digital watermarking according to the present embodiment does not include a technique of simply transmitting identification information using a different frequency band (e.g., 16 kHz to 20 kHz).

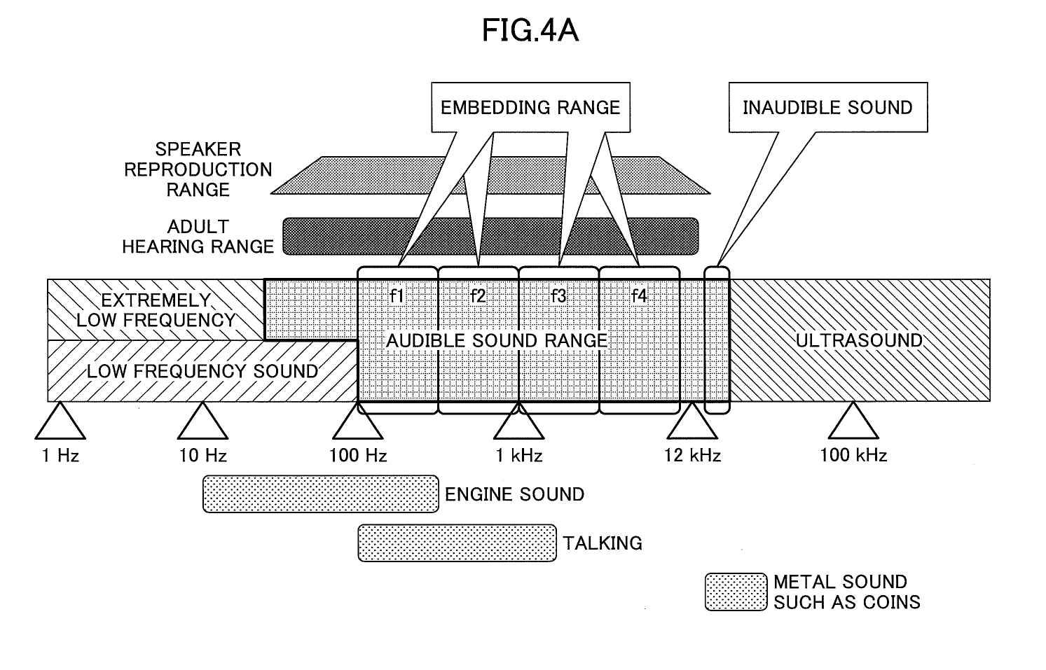

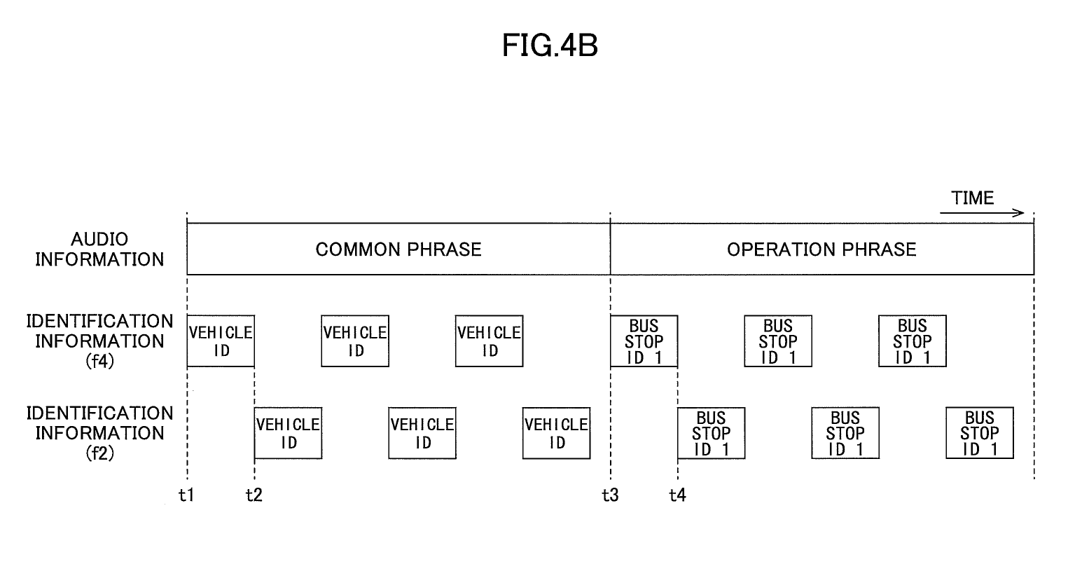

FIGS. 4A and 4B are diagrams illustrating an example method of embedding identification information in audio information according to the present embodiment.

FIG. 4A illustrates example frequency bands for embedding identification information. As represented by a “speaker reproduction range” of FIG. 4A, typical speakers (e.g., including the internal speakers 106a and 106b of the bus 105) are capable of outputting sound waves within an “audible sound range”, which is in between an “extremely low frequency” and “ultrasound”.

Note that sound waves of a frequency range higher than 12 kHz of the above audible sound range have high linearity, and as such, it is difficult to propagate such sound waves throughout the entire bus 105 using internal speakers typically provided in a bus. Further, this frequency range is susceptible to influences from metallic sounds generated by coins used to pay bus fares, for example.

Also, sound waves of a low frequency range (e.g., frequency less than 100 Hz) of the above audible sound range may be susceptible to influences from engine sounds of the bus 105 and road noise of tires, for example.

Therefore, digital watermarks embedded in audio information are preferably embedded within a frequency range from 100 Hz to 12 kHz, for example, of the audible sound range of the audio information. In this way, influences of engine sounds and road noise of the bus 105 may be reduced and identification information may be conveyed throughout the entire bus 105 using existing internal speakers 106a and 106b of the bus 105, for example.

Note, however, that a frequency range susceptible to influences of engine sounds and road noise may vary depending on the type of the bus 105, for example, and such variations are preferably taken into account. Further, as shown in FIG. 4A, a frequency range from about 100 Hz to 1 kHz is susceptible to influences from the sound of people talking, and this should also be taken into account.

Thus, in a preferred example, as shown in FIG. 4A, the frequency range from 100 Hz to 12 kHz may be divided into a plurality of frequency bands, and identification information may be embedded in at least two of the frequency bands. In the example of FIG. 4A, the frequency range from 100 Hz to 12 kHz is divided into four frequency bands f1, f2, f3, and f4, and identification information may be embedded in each of the above frequency bands. In this way, for example, even when identification information embedded in the frequency band “f1” is canceled out due to influences from engine sounds, the information terminal 107 may still be able to acquire identification information embedded in the frequency bands f2, f3, and f4.

FIG. 4B illustrates example timings for embedding identification information. In FIG. 4B, it is assumed that the common phrase has a length of about 5 to 10 seconds depending on the content of the message, for example. On the other hand, it is assumed that the vehicle ID embedded as a digital watermark is approximately 1 second. In this case, the vehicle ID may be embedded multiple times within the common phrase as illustrated in FIG. 4B, for example.

Specifically, in the example of FIG. 4B, the vehicle ID is embedded as a digital watermark three times in the frequency band f4 and three times in the frequency band f2 of the audio information representing the common phrase. In this way, for example, even when the second half of the common phrase receives influences of noise, the information terminal 107 may be able to acquire the vehicle ID included in the first half of the common phrase.

Also, because the vehicle ID is embedded as a digital watermark in multiple frequency bands (f2 and f4), for example, even when noise is generated in the frequency band f4, the information terminal 107 may be able to acquire the vehicle ID embedded in the frequency band f2. Note that the vehicle IDs embedded in different frequency bands are preferably embedded at different temporal positions (different timings). For example, in the example of FIG. 4B, with respect to the frequency band f4, the vehicle ID is embedded at predetermined time intervals (e.g., 1-second intervals) starting from time t1, and with respect to the frequency band f2, the vehicle ID is embedded at predetermined time intervals starting from time t2. In this way, the information terminal 107 does not have to process multiple frequency bands at the same time and the processing load of the information terminal 107 may be reduced.

Similarly, in the operation phrase, a bus stop ID is embedded multiple times in multiple frequency bands. In the example of FIG. 4B, with respect to the frequency band f4, the bus ID is embedded at predetermined time intervals starting from time t3, and with respect to the frequency band f2, the bus stop ID is embedded at predetermined time intervals starting from time t4.

Note that the method of embedding identification information as illustrated in FIGS. 4A and 4B is merely one example. That is, according to preferred embodiments of the present invention, audio information provided by a mounted apparatus has the same identification information embedded at least twice at different times and/or in different frequency bands of the audio information.

(Display Screen of Information Terminal)

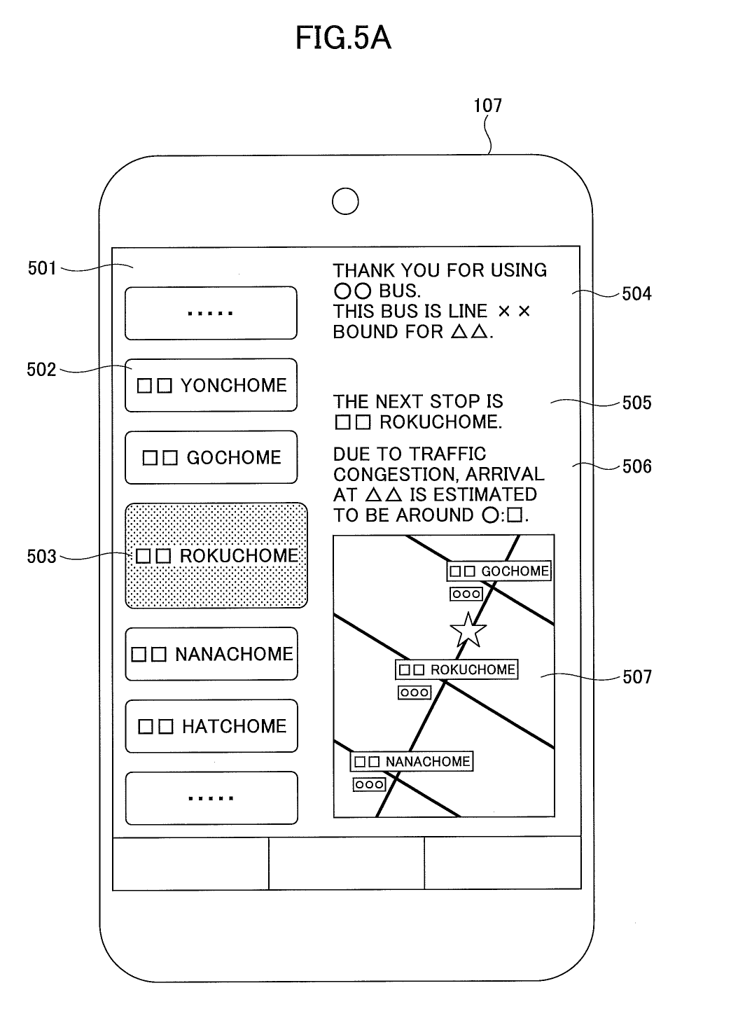

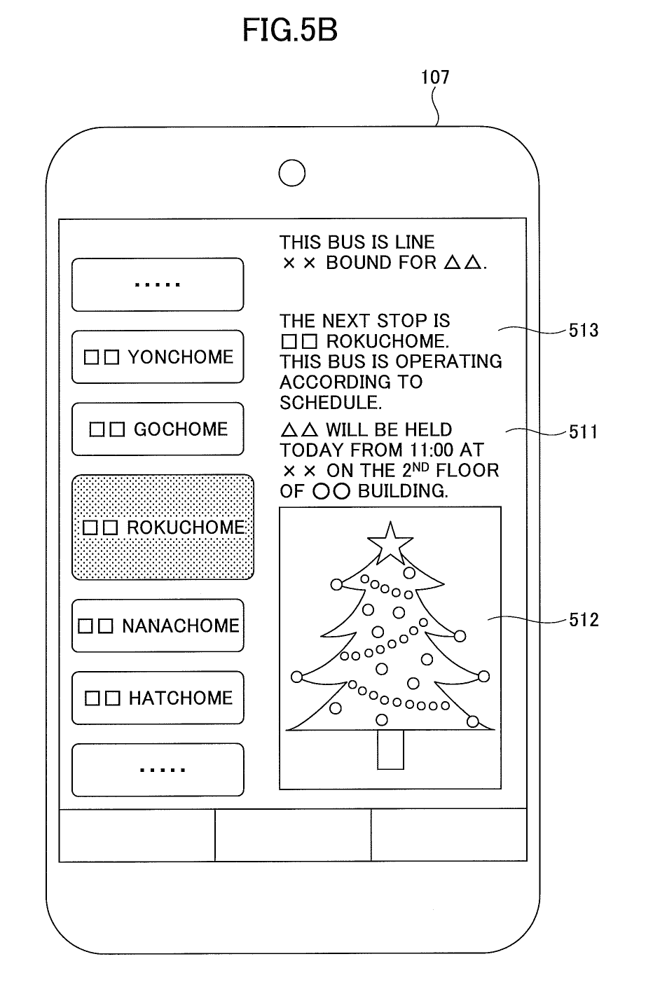

FIGS. 5A and 5B are diagrams illustrating example display screens of the information terminal 107 according to the present embodiment. The information terminal 107 may execute an application program (hereinafter referred to as “app”) for implementing the information providing system 100 to acquire audio information inside the bus 105, for example, and display information such as that illustrated in FIGS. 5A and 5B on a display screen based on the acquired audio information.

FIG. 5A illustrates an example display screen 501 of the information terminal 107. In the present example, it is assumed that the app installed in the information terminal 107 has route information including information on a plurality of bus stops of a plurality of bus routes that may be traveled by the bus 105. Further, it is assumed that when the information terminal 107 acquires audio information provided by the bus 105, the information terminal 107 is configured to extract information, such as a vehicle ID, a route ID, a bus stop ID, that are embedded in the acquired audio information.

In the example of FIG. 5A, on the left side of the display screen 501 of the information terminal 107, information on a plurality of bus stops 502 is displayed in sequential order based on the route ID and the bus ID extracted from the audio information provided by the bus 105. Further, the information on the plurality of bus stops 502 includes information on the next bus stop 503, which is distinguishably displayed in a different size and/or a different color, for example, from the other bus stops. Note that the information on the plurality of bus stops 502 may be scrolled by a swiping operation, for example, to display information on other bus stops.

Also, on the right side of the display screen 501, display information, such as a common message 504, a message indicating the next bus stop 505, are displayed based on the route ID and the bus stop ID extracted from the audio information of the bus 105.

Further, on the right side of the display screen 501, an operation status message 506 indicating the operation status of the bus 105 is displayed based on operation information received from the operation management server 102. Note that the manner in which the operation management server 102 provides the operation information is described in detail below.

Also, on the right side of the display screen 501, map information 507 indicating the current position of the bus 105 may be displayed, for example. The map information 507 may be displayed based on the operation information (e.g., positioning information) from the operation management server 102 and a route map stored in the information terminal 107 beforehand, for example.

In the example of FIG. 5B, on the right side of the display screen of the information terminal 107, content delivered from the content delivery server 103, such as message information 511 and image information 512, may be displayed. Note that content, such as the message information 511 and the image information 512, is preferably displayed along with an operation status message 513 relating to the operation status of the bus 105. Note that the manner in which content is delivered by the content delivery server 103 is described in detail below.

As described above, in the information providing system 100 according to the present embodiment, existing audio equipment installed in the bus 105 may be used to provide detailed information associated with the operation status of the bus 105 to the user 108 of the information terminal 107 such that convenience for the user 108 may be improved, for example.

<Hardware Configuration>

(Hardware Configuration of Operation Management Server and Content Delivery Server)

The operation management server 102 and the content delivery server 103 may have hardware configurations of general purpose computers, for example. In the following, an example hardware configuration of a computer that may be used to implement the functions of the operation management server 102 and the content delivery server 103 is described.

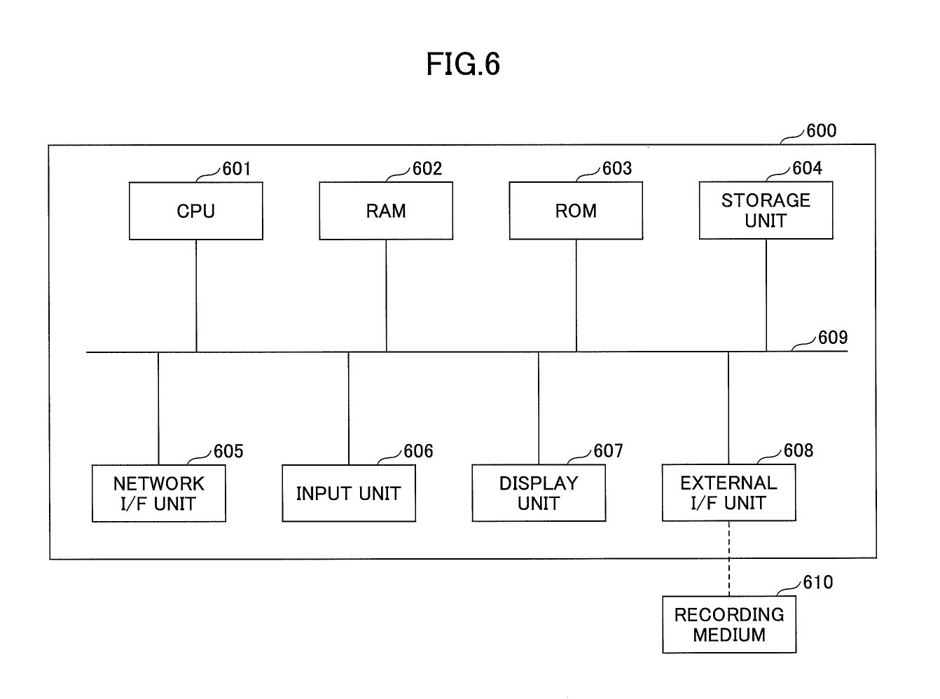

FIG. 6 is a block diagram illustrating an example hardware configuration of a computer 600 according to an embodiment of the present invention. The computer 600 includes a CPU (Central Processing Unit) 601, a RAM (Random Access Memory) 602, a ROM (Read-Only Memory) 603, a storage unit 604, a network I/F (interface) unit 605, an input unit 606, a display unit 607, an external I/F unit 608, and a bus 609.

The CPU 601 is a processor that implements various functions of the computer 600 by loading programs and data stored in a storage device, such as the ROM 603 or the storage unit 604, in the RAM 602, and executing processes based on the loaded programs and data. The RAM 602 is a volatile memory used as a working area for the CPU 601. The ROM 603 is a nonvolatile memory that is capable retaining programs and data even when the power is turned off.

The storage unit 604 may be a large-capacity storage device, such as an HDD (Hard Disk Drive) or an SSD (Solid State Drive), for example. The storage unit 604 may store programs and data, such as an OS (Operation System), application programs, and various types of data.

The network I/F unit 605 is a communication interface for connecting the computer 600 to the network 104.

The input unit 606 is an input device, such as a mouse or some other pointing device and/or a keyboard, for example, that is used to input operation signals to the computer 600.

The display unit 607 is a display device for displaying information such as processing results obtained by the computer 600, for example.

The external I/F unit 608 is an interface with an external device. The external device may be a recording medium 610, for example. The computer 600 may read/write data from/in the recording medium 610 via the external I/F unit 608, for example. The recording medium 610 may be an optical disk, a magnetic disk, a memory card, a USB (Universal Serial Bus) memory, or the like. Also, a predetermined program may be stored in the recording medium 610, and the program stored in the recording medium 610 may be installed in the computer 600 via the external I/F unit 608. In this way, the computer 600 may be able to execute the predetermined program.

The bus 609 is connected to the above hardware elements of the computer 600 and conveys address signals, data signals, and various control signals, for example.

Note that the above hardware configuration of the computer 600 is merely one example configuration. In other examples, the computer 600 may include the input unit 606 and the display unit 607 as external devices, or the input unit 606 and the display unit 607 may be integrated into a display/input device such as a touch panel, for example.

(Hardware Configuration of Vehicle-Mounted Apparatus)

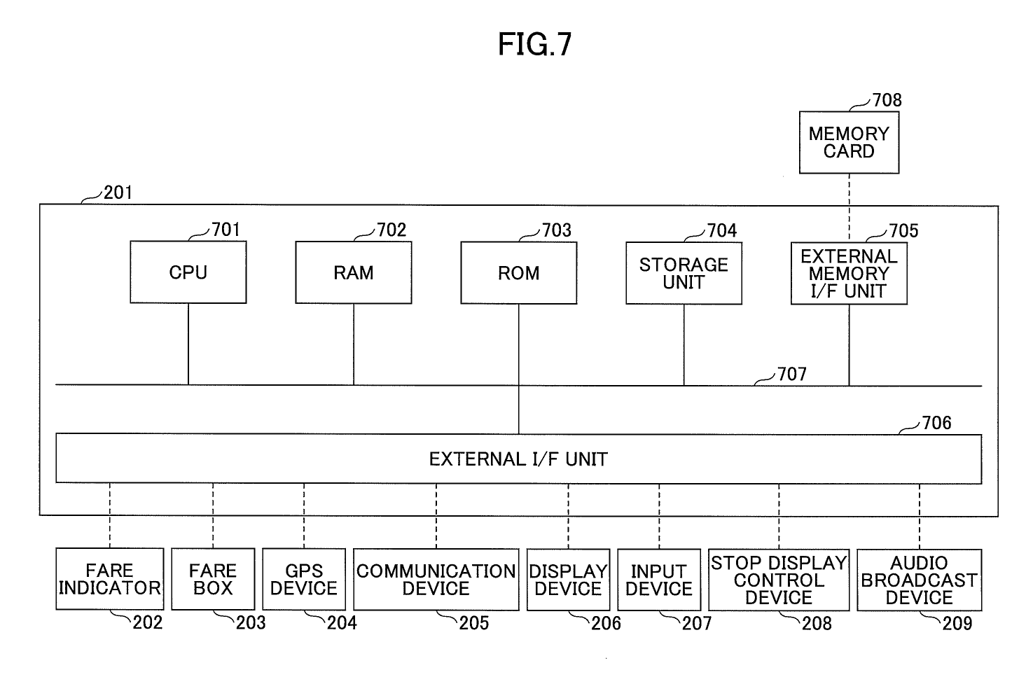

FIG. 7 is a block diagram illustrating an example hardware configuration of the vehicle-mounted apparatus 201 according to an embodiment of the present invention. The vehicle-mounted apparatus 201 has a hardware configuration of a general purpose computer including a CPU 701, a RAM 702, a ROM 703, a storage unit 704, an external memory I/F unit 705, an external I/F unit 706, and a bus 707.

The CPU 701 is a processor that implements various functions of the vehicle-mounted apparatus 201 by loading programs and data stored in a storage device, such as the ROM 703 or the storage unit 704, in the RAM 702, and executing processes based on the loaded programs and data. The RAM 702 is a volatile memory used as a working area for the CPU 701. The ROM 703 is a nonvolatile memory that is capable retaining programs and data even when the power is turned off.

The storage unit 704 may be a large-capacity storage device, such as an HDD or an SSD, for example. The storage unit 704 may store programs and data, such as an OS, application programs, and various types of data.

The external memory I/F unit 705 is an interface for connecting a memory card 708 to the vehicle-mounted apparatus 201 such that the vehicle-mounted apparatus 201 may read/write data from/in the memory card 708.

The external I/F unit 706 is an interface with external devices. The bus 707 is connected to the above hardware elements of the vehicle-mounted apparatus 201 and conveys address signals, data signals, and various control signals, for example.

The external devices connected to the vehicle-mounted apparatus 201 via the external I/F unit 706 may include the devices of the vehicle-mounted system 101 illustrated in FIG. 2, such as the fare indicator 202, the fare box 203, the GPS device 204, the communication device 205, the display device 206, the input device 207, the stop display control device 208, and the audio broadcast device 209, for example. Note that these external devices may be implemented using existing devices that are installed in the bus 105, and as such, descriptions of the hardware configurations of these external devices are omitted. The functions of these external devices are described above with reference to FIG. 2.

(Hardware Configuration of Information Terminal)

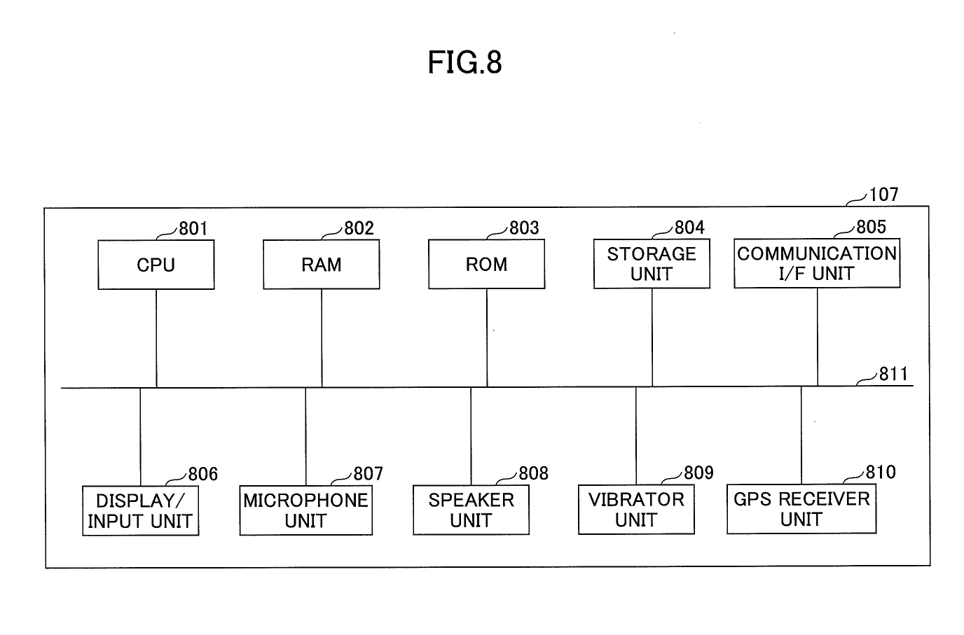

FIG. 8 is a block diagram illustrating an example hardware configuration of the information terminal 107 according to an embodiment of the present invention. The information terminal 107 may have a hardware configuration of a general purpose computer including a CPU 801, a RAM 802, a ROM 803, a storage unit 804, a communication I/F unit 805, a display/input unit 806, a microphone unit 807, a speaker unit 808, a vibrator unit 809, a GPS receiver unit 810, and a bus 812.

The CPU 801 is a processor that implements various functions of the information terminal 107 by loading programs and data stored in a storage device, such as the ROM 803 or the storage unit 804, in the RAM 802, and executing processes based on the loaded programs and data. The RAM 802 is a volatile memory used as a working area for the CPU 801. The ROM 803 is a nonvolatile memory that is capable retaining programs and data even when the power is turned off. The storage unit 804 may be a storage device, such as an HDD, an SSD, or a flash ROM, for example. The storage unit 804 may store programs and data, such as an OS, application programs, and various types of data.

The communication I/F unit 805 is a communication interface conforming to a communication system using a mobile communication network such as LTE, or a communication system using a wireless LAN, for example. The information terminal 107 establishes connection with the network 107 via the communication I/F unit 805 to communicate with the operation management server 102 and the content delivery server 103, for example.

The display/input unit 806 is a display/input device such as a touch panel display that displays a display screen generated by a program executed by the information terminal 107 and accepts input operations by the user 108. Note that in some embodiments, the display/input unit 806 may be separated into a display unit and an input unit, for example.

The microphone unit 807, converts sounds, such as ambient sounds of the information terminal 107 and the voice of the user 108, into audio signals. The speaker unit 808 converts the audio signals into audio and outputs the audio. The vibrator unit 809 may generate a vibration under control by the CPU 801 to provide notifications to the user 108 of the information terminal 107, for example. The GPS receiver unit 810 receives radio waves from a GPS satellite and outputs the received data and/or position information in a predetermined data format.

The bus 812 is connected to the above hardware elements of the information terminal 107 and conveys address signals, data signals, and various control signals, for example.

Note that the information terminal 107 may download the application program (app) for implementing functions of the information providing system 100 via the communication I/F unit 805 and execute the downloaded app.

<Functional Configuration>

In the following, a functional configuration of the information providing system 100 is described.

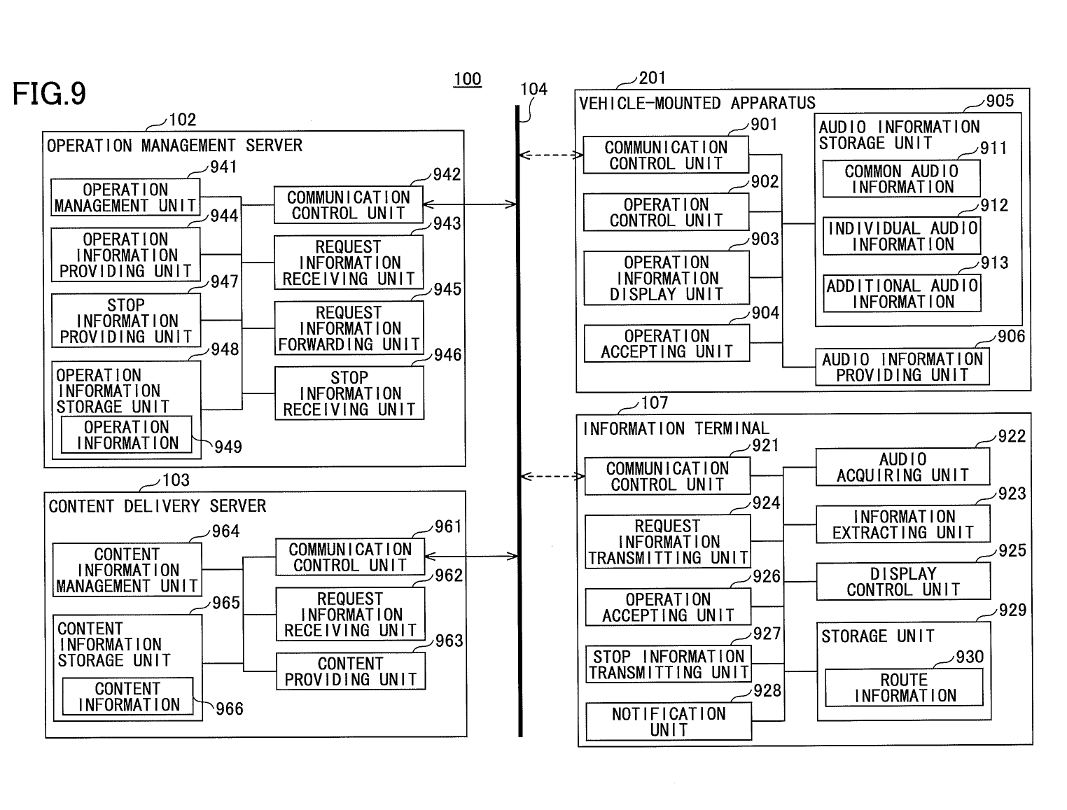

FIG. 9 is a block diagram illustrating an example functional configuration of the information providing system 100 according to the present embodiment. In FIG. 9, the information providing system 100 includes the vehicle-mounted apparatus 201, the information terminal 107, the operation management server 102, and the content delivery server 103 that are communicably connected to each other via the network 104. Note that the functional configuration illustrated in FIG. 9 is merely one example, and in other example configurations, the operation management server 102 may include one or more functions of the content delivery server 103. In another example, the vehicle-mounted apparatus 201 may be configured to manage the operation status of the bus 105 without using the operation management server 102 and provide operation information of the bus 105 to the information terminal 107.

(Functional Configuration of Vehicle-Mounted Apparatus)

The vehicle-mounted apparatus 201 includes a communication control unit 901, an operation control unit 902, an operation information display unit 903, an operation accepting unit 904, an audio information storage unit 905, and an audio information providing unit 906.

The communication control unit 901 may use communication device 205 to establish communication with the operation management server 102, the content delivery server 103, and the information terminal 107, for example. Note that the communication control unit 901 may be implemented by a program run on the CPU 701 of FIG. 7, for example.

The operation control unit 902 may use the fare indicator 202, the fare box 203, and the stop display control unit 208 of the vehicle-mounted system 101, for example, to control various aspects relating to the operation of the bus 105. Further, the operation control unit 902 transmits information associated with the operation of the bus 105 (e.g., position information, bus stop information, delay information) to the operation management server 102 based on position information acquired from the GPS device 204 and operations of the driver of the bus 105 accepted via the input device 207, for example. Note that the operation control unit 902 may be implemented by a program run on the CPU 701 of FIG. 7, for example.

The operation information display unit 903 controls the display device 206 to display various items of information associated with the operation status of the bus 105 (e.g., bus stop information, information on users getting off, map information). Note that the operation information display unit 903 may be implemented by a program run on the CPU 701 of FIG. 7, for example.

The operation accepting unit 904 uses the input device 207 to accept operations from the driver of the bus 105, for example. Note that the operation accepting unit 904 may be implemented by a program run on the CPU 701 of FIG. 7, for example.

The audio information storage unit 905 stores in advance the common audio information 911 having the vehicle ID of the bus 105 embedded therein as a digital watermark, for example, and a plurality of items of the individual audio information 912 each having a bus stop ID for identifying the position of the bus 105 embedded therein as a digital watermark, for example. Also, the audio information storage unit 905 stores in advance the additional audio information 913 having content identification information identifying predetermined content embedded therein as a digital watermark, for example. Note that the audio information storage unit 905 may be implemented by the storage unit 704, the memory card 708, and a program run on the CPU 701 of FIG. 7, for example.

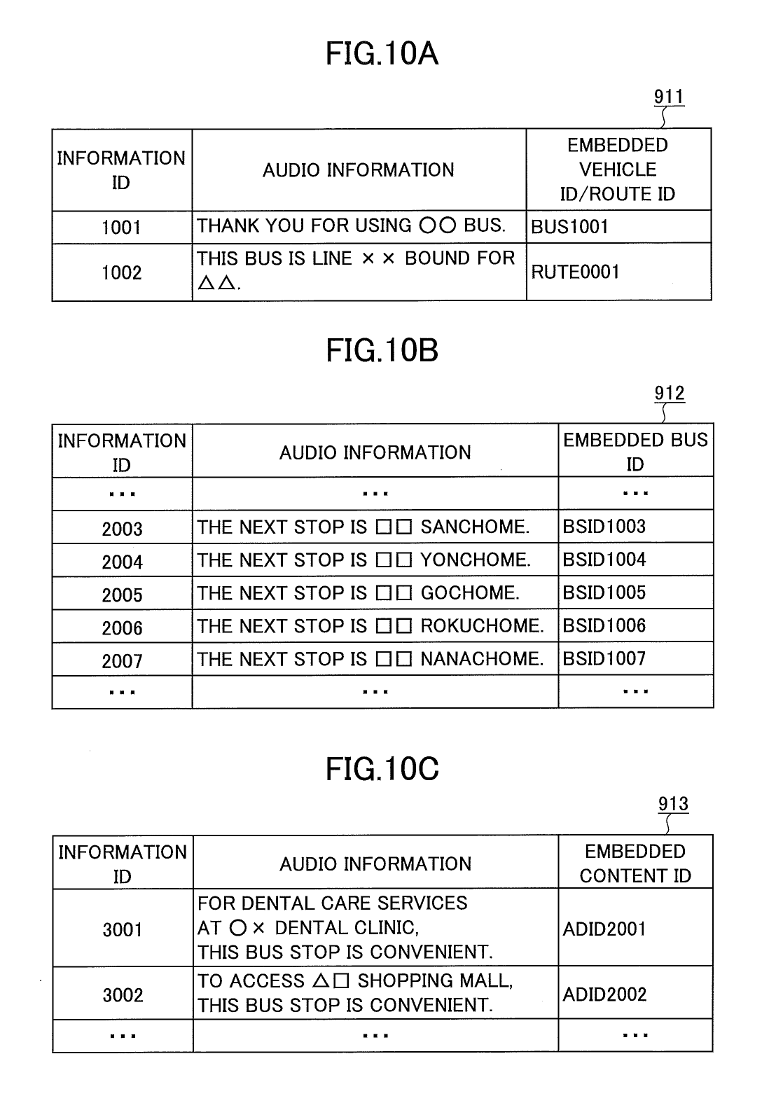

FIGS. 10A-10C are tables indicating examples of audio information according to the present embodiment.

FIG. 10A indicates examples of the common audio information 911 stored in the audio information storage unit 905. The common audio information 911 may include audio data of a common phrase, such as “Thank you for using ◯◯ bus,” having a vehicle ID, such as “BUS1001,” embedded as a digital watermark, for example. Also, the common audio information 911, may include audio data of an operation route phrase, such as “This bus is XX line bound for ΔΔ,” having a route ID, such as “RUTE0001,” embedded as a digital watermark, for example. Note that “information ID” in FIG. 10A corresponds to identification information for managing each item of audio data stored as the common audio information 911.

FIG. 10B indicates examples of the individual audio information 912 stored in the audio information storage unit 905. The individual audio information 912 may include an operation phrase, such as “The next stop is □□ sanchome,” having a bus stop ID, such as “BSID11003,” embedded as a digital watermark, for example. The individual audio information 912 may include audio data for each of a plurality of bus stop IDs. Note that “information ID” in FIG. 10B corresponds to identification information for managing each item of audio data stored as the individual audio information 912.

FIG. 10C indicates examples of the additional audio information 913 stored in the audio information storage unit 905. The additional audio information 913 may include an ad phrase, such as “For dental care services at ◯X dental clinic, this bus stop is convenient,” having a content ID, such as “ADID2001” embedded as a digital watermark, for example. The additional audio information 913 may include audio data for a plurality of content IDs. Note that “information ID” in FIG. 10C corresponds to identification information for managing each item of audio data stored as the additional audio information 913.

Referring back to FIG. 9, the other functional elements of the vehicle-mounted apparatus 201 are described below.

The audio information providing unit 906 uses the audio broadcast device 209 to provide, through audio broadcast, guidance information including the common audio information stored in the audio information storage unit 905 and individual audio information corresponding to the operation status of the bus 105. For example, if the next bus stop of the bus 105 is “□□ rokuchome”, the audio information providing unit 906 provides, through audio broadcast, guidance information including the common audio information with the information IDs “1001” and “1002” of FIG. 10A and the individual audio information with the information ID “2006” of FIG. 10B.

Preferably, the audio information providing unit 906 also includes additional information associated with the bus stop ID of the next bus stop in the guidance information when providing the guidance information.

In this way, guidance information having the vehicle ID of the bus 105, the bus stop ID identifying the current position of the bus 105, and the content ID of predetermined content embedded therein may be provided as audio information of the bus 105.

(Functional Configuration of Information Terminal)

The information terminal 107 includes a communication control unit 921, an audio acquiring unit 922, an information extracting unit 923, a request information transmitting unit 924, a display control unit 925, an operation accepting unit 926, a stop information transmitting unit 927, a notification unit 928, and a storage unit 929.

The communication control unit 921 may use the communication I/F unit 805 of FIG. 8, for example, to establish communication with the operation management server 102, the content delivery server 103, and the vehicle-mounted apparatus 201, for example. Note that the communication control unit 921 may be implemented by a program run on the CPU 801 of FIG. 8, for example.

The audio acquiring unit 922 may use the microphone unit 807 of FIG. 8, for example, to acquire audio from the surrounding environment, for example. Note that the audio acquiring unit 922 may be implemented by a program run on the CPU 801 of FIG. 8, for example.

The information extracting unit 923 extracts information (e.g., vehicle ID, bus stop ID, content ID) embedded in audio information acquired by the audio acquiring unit 922. Note that the information extracting unit 923 may be implemented by a program run on the CPU 801 of FIG. 8, for example.

The request information transmitting unit 924 transmits request information, including identification information (e.g., vehicle ID) extracted from audio information by the information extracting unit 923 and identification information of the information terminal 107 (hereinafter, referred to as “app ID”), to the operation management server 102 via the communication control unit 921. Note that the request information transmitting unit 924 may be implemented by a program run on the CPU 801 of FIG. 8, for example.

Note that the app ID is identification information identifying the app installed in the information terminal 107 for implementing the information providing system 100. The app ID may be generated when the app is initially installed in the information terminal 107, for example. Note that a unique app ID identifying the app to be run by the information terminal 107 may be generated with respect to each information terminal 107 based on unique identification information, such as IMEI (International Mobile Equipment Identity), of the information terminal 107. By using such app ID, the information providing system 100 may be able to identify the information terminal 107 or the user 108 of the information terminal 107 without relying on personal information of the user 108, for example.

Note that the app ID is an example of terminal identification information for identifying the information terminal 107. In other examples, the terminal identification information may be identification information (device ID) uniquely assigned to each information terminal 107, a phone number, or an IP address (or MAC address).

The display control unit 925 controls the display/input unit 806 of the information terminal 107 to display various types of information. Note that the display control unit 925 may be implemented by a program run on the CPU 801 of FIG. 8, for example.

Based on the bus stop ID extracted by the information extracting unit 923 and map information 930 included in the app run on the information terminal 107, the display control unit 925 controls the display/input unit 806 to display information on a plurality of bus stops 502 in a selectable format as illustrated in FIG. 5A, for example. Also, when the communication control unit 921 receives operation information of the bus 105 from the operation management server 102, the display control unit 925 controls the display/input unit 806 to display the operation status message 506 indicating the operation status of the bus 105 based on the received operation information as illustrated in FIG. 5B, for example.

The operation accepting unit 926 accepts an input operation of the user 108 via the display/input unit 806, for example. Note that the operation accepting unit 926 may be implemented by a program run on the CPU 801 of FIG. 8, for example.

The stop information transmitting unit 927 transmits stop information on a selected bus stop (stopover location) to the operation management server 102 via the communication control unit 921 when a bus stop is selected from the information on the plurality of bus stops 502 that is selectably displayed on the display/input unit 806 by display control unit 925. Note that the stop information transmitting unit 927 may be implemented by a program run on the CPU 801 of FIG. 8, for example.

The notification unit 928 provides a predetermined notification to the user 108 of the information terminal 107 by displaying information on the display/input unit 806 of FIG. 8, generating a vibration using the vibrator unit 809, or outputting a sound using the speaker unit 808, for example. Note that the notification unit 928 may be implemented by a program run on the CPU 801 of FIG. 8, for example.

The storage unit 929 stores the app run on the information terminal 107 and information used by the app, for example. Note that the storage unit 922 may be implemented by the storage unit 804, the RAM 802, and a program run on the CPU 801 of FIG. 8, for example.

(Functional Configuration of Operation Management Server)

The operation management server 102 includes an operation management unit 941, a communication control unit 942, a request information receiving unit 943, an operation information providing unit 944, a request information forwarding unit 945, a stop information receiving unit 946, a stop information providing unit 947, and an operation information storage unit 948.

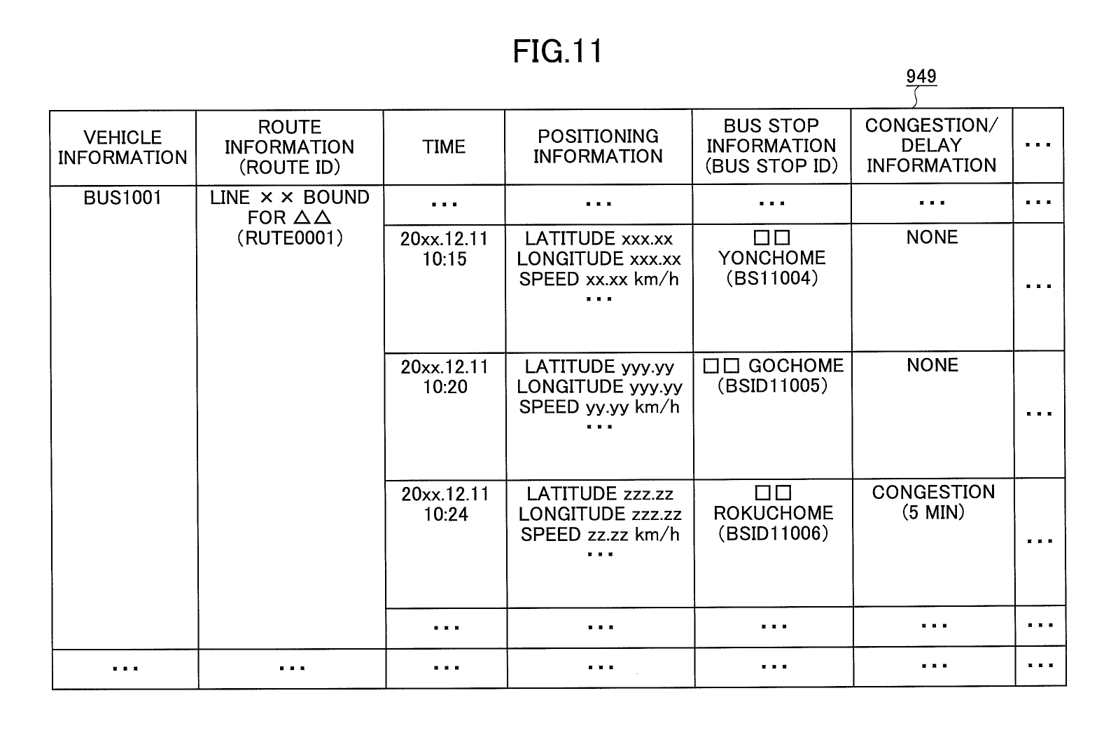

The operation management unit 941 stores and manages operation information 949 associated with the operation status of at least one bus 105 in the operation information storage unit 948. Note that the operation management unit 941 may be implemented by a program run on the CPU 601 of FIG. 6, for example. Also, note that functions of the operation management unit 941 may be implemented using existing equipment of a bus operation management system. The operation information 949 managed by the operation management unit 941 may have a configuration as illustrated in FIG. 11, for example.

FIG. 11 is a table illustrating an example of the operation information 949 managed by the operation management unit 941 according to the present embodiment. The operation information 949 may include information items, such as “vehicle information”, “route information (route ID)”, “date/time”, “positioning information”, “bus stop information (bus stop ID)”, and “congestion/delay information”, for example.

The “vehicle information” is information identifying a specific vehicle such as the bus 105. In the example of FIG. 11, a vehicle ID is stored as the vehicle information. The “route information (route ID)” is information identifying the route of the vehicle, such as the name of the route or the route ID of the route, for example. The “date/time” may correspond to information indicating the date/time the positioning information and the bus stop information was stored in the operation information 949.

The “positioning information” may correspond to GPS information acquired from the bus 105 indicating the position of the bus 105, for example. Based on such positioning information, the operation management unit 941 may be able to manage the position of the bus 105, the traveling direction of the bus 105, and the traveling speed of the bus 105, for example.

The “bus stop information (bus stop ID)” is information indicating the next bus stop that is acquired from the bus 105. Because positioning information obtained by a GPS device may include some errors, for example, it is difficult to determine whether the bus 105 is located before a bus stop or has already passed the bus stop. Accordingly, for example, the operation management unit 941 may use the bus stop information that is based on operations made by the driver of the bus 105 in conjunction with the positioning information obtained by the GPS device 204 of the bus 105 to more accurately manage the operation status of the bus 105.

The “congestion/delay information” is information relating to traffic congestion and/or delay that may be based on information acquired from the bus 105 and/or information acquired from another bus that has traveled the same route before the bus 105, for example.

Note that the configuration of the operation information 949 illustrated in FIG. 11 is merely one example. In other examples, the operation information 949 may include other information items, such as the arrival time at each bus stop and/or the number of passengers, for example.

Referring back to FIG. 9, the other functional elements of the operation management server 102 are described.

The communication control unit 942 uses the network I/F unit 605 of FIG. 6, for example, to establish communication with the content delivery server 103, the vehicle-mounted apparatus 201, and the information terminal 107. Note that the communication control unit 942 may be implemented by a program run on the CPU 601 of FIG. 6, for example.

The request information receiving unit 943 receives, from the information terminal 107 that has acquired the identification information included in the guidance information provided by the bus 105, request information including the acquired identification information and the app ID of the information terminal 107, via the communication control unit 942. Note that the request information receiving unit 943 may be implemented by a program run on the CPU 601 of FIG. 6, for example.

The operation information providing unit 944 provides relevant operation information to the information terminal 107 via the communication control unit 942. That is, based on the vehicle ID included in the request information received by request information receiving unit 943, the operation information providing unit 944 identifies the relevant operation information associated with this vehicle ID from the operation information 949 stored in the operation information storage unit 948 and provides the relevant operation information associated with the vehicle ID to the information terminal 107 via the communication control unit 942.

The request information forwarding unit 945 forwards the request information received by the request information receiving unit 943 to the content delivery server 103 as necessary. Note that the request information forwarding unit 945 may be implemented by a program run on the CPU 601 of FIG. 6, for example.

The stop information receiving unit 946 receives stop information indicating a bus stop that has been selected by the user 108 from the information terminal 107 that displays information on a plurality of bus stops at which passengers can get on/off the bus 105. Note that the stop information receiving unit 946 may be implemented by a program run on the CPU 601 of FIG. 6, for example.

The stop information providing unit 947 refers to the stop information received by the stop information receiving unit 946 and notifies the vehicle-mounted apparatus 201, via the communication control unit 942, information indicating that there is a passenger (user) that wishes to get off the bus 105 at the bus stop indicated in the stop information. Note that the stop information providing unit 947 may be implemented by a program run on the CPU 601 of FIG. 6, for example.

The operation information storage unit 948 stores the operation information 949 managed by the operation management unit 941. Note that the operation information storage unit 948 may be implemented by the storage unit 604, the RAM 602, and a program run on the CPU 601 of FIG. 6, for example.

With the above configuration, when the operation management server 102 receives request information from the information terminal 107, the operation management server 102 can provide operation information relating to the operation status of the bus 105 based on the vehicle ID of the bus 105 included in the received request information. Also, when the operation management server 102 receives stop information from the information terminal 107, the operation management server 102 can provide the vehicle-mounted apparatus 201 with information indicating that there is a user that wishes to get off the bus 105 at the bus stop identified by the bus stop ID included in the received stop information.

(Functional Configuration of Content Delivery Server)

The content delivery server 103 includes a communication control unit 961, a request information receiving unit 962, a content providing unit 963, a content information management unit 964, and a content information storage unit 965.

The communication control unit 961 uses the network I/F unit 605 of FIG. 6, for example, to establish communication with the operation management server 102, the vehicle-mounted apparatus 201, and the information terminal 107, for example. Note that the communication control unit 961 may be implemented by a program run on the CPU 601 of FIG. 6, for example.

The request information receiving unit 962 receives, from the information terminal 107 that has acquired the identification information included in the guidance information provided by the bus 105, request information including the acquired identification information and the app ID of the information terminal 107, via the control unit 961. Note that the request information receiving unit 943 may be implemented by a program run on the CPU 601 of FIG. 6, for example.

Note that the request information receiving unit 962 may receive the request information directly from the information terminal 107, or the request information may be forwarded to the request information receiving unit 962 from the operation management server 102, for example.

The content providing unit 963 acquires content associated with the identification information (e.g., content ID, bus stop ID) received by the request information receiving unit 962 from content information 966 stored in the content information storage unit 965 and provides the acquired content to the information terminal to provide to 107. Note that the content providing unit 963 may be implemented by a program run on the CPU 601 of FIG. 6, for example.

The content information management unit 964 stores and manages the content information 966 in the content information storage unit 965 and may be implemented by a program run on the CPU 601 of FIG. 6, for example. Note that administrators of the content delivery server 103 and/or content providers may be able to update the content information 966 from a web page provided by the content information management unit 964, for example. In this way, the information providing system 100 may be able to provide timely information to users of the bus 105.

The content information storage unit 965 stores the content information 966 and may be implemented by the storage unit 604, the RAM 602, and a program run on the CPU 601 of FIG. 6, for example.

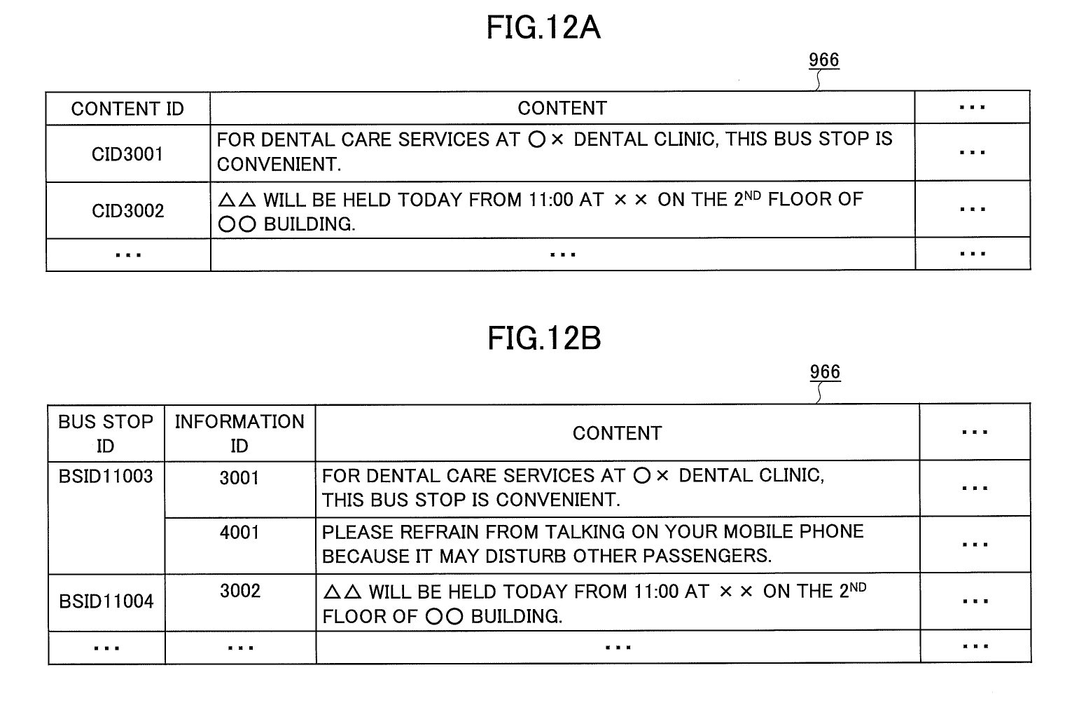

FIGS. 12A and 12B are tables indicating examples of the content information 966 according to the present embodiment.

FIG. 12A illustrates one example configuration of the content information 966. In the example of FIG. 12A, the content information 966 includes information items, such as “content ID” corresponding to identification information identifying the content and “content” corresponding to information describing the actual content. Note that FIG. 12A illustrates an example in which the content corresponds to text. However, the content may also include still images, video, audio, link information, and the like. Using the content information 966 having such a configuration, the content providing unit 963 may acquire content associated with a content ID that is included in additional audio information acquired by the information terminal 107 and provide the acquired content to the information terminal 107.

FIG. 12B illustrates another example configuration of the content information 966. In FIG. 12B, the content information 966 includes information items, such as “bus ID”, “information ID”, and “content”. In FIG. 12B, a bus stop ID may be stored in association with one or more corresponding pieces of content. The content providing unit 963 may use the content information 966 having such a configuration to acquire corresponding content based on a bus stop ID that has been acquired by the information terminal 107 and provide the corresponding content to the information terminal 107.

Note that although the bus 105 is described above as an example of a transport vehicle, the present invention may also be applied to other types of transport vehicles, such as ships and aircrafts, for example. Also, the term “operation” used in the above description may include navigation of a ship or flight operation of an aircraft, for example. Further, information associated with the operation status of a vehicle that is provided by the information providing system 100 may include information associated with the navigation status of a ship and information associated with the flight operation status of an aircraft, for example.

<Process Flow>

In the following, example information providing methods that may be implemented by the information providing system 100 according to embodiments of the present invention are described.

### First Embodiment

(Operation Information Providing Process)

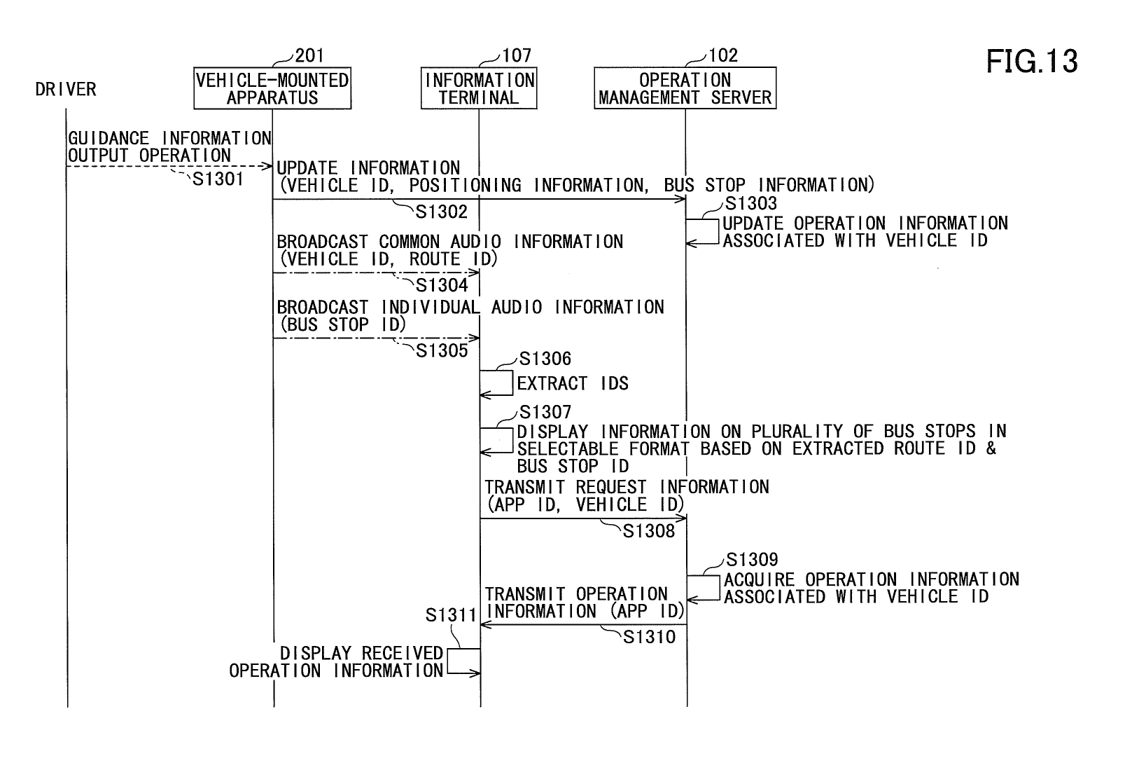

FIG. 13 is a sequence chart illustrating an example process of providing operation information according to the first embodiment.

In step S1301, the driver of the bus 105 may drop off a passenger at a bus stop, for example, and upon starting the bus 105 to head toward the next bus stop, the driver may operate the input device 207 to have guidance information output through audio broadcast, for example.

In step S1302, the operation control unit 902 of the vehicle-mounted apparatus 201 transmits update information on the operation status of the bus 105 to the operation management server 102 via the communication control unit 901. The update information may include the vehicle ID of the bus 105, positioning information obtained by the GPS device 204, and a bus stop ID of the next bus stop, for example.

In step S1303, based on the update information received from the vehicle-mounted apparatus 201, the operation management unit 941 of the operation management server 102 updates the operation information of the bus 105 that is associated with the vehicle ID included in the update information.

In step S1304, the audio information providing unit 906 of the vehicle-mounted apparatus 201 outputs common audio information as illustrated in FIG. 10A, for example, using the internal speakers 106a and 106b. The common audio information may have identification information, such as the vehicle ID of the bus 105 and the route ID of the route of the bus 105, embedded therein as a digital watermark, for example.

In step S1305, the audio information providing unit 906 of the vehicle-mounted apparatus 201 outputs individual audio information associated with the next bust stop included in the individual audio information of FIG. 10B, for example, using the internal speakers 106a and 106b. The individual audio information may include identification information such as the bus stop ID of the next bus stop embedded therein as a digital watermark, for example.

In step S1306, the information extracting unit 923 of the information terminal 107 extracts the identification information embedded as digital watermarks from the audio information acquired by the audio acquiring unit 922. For example, the vehicle ID, the route ID, and the bus stop ID that are embedded in the acquired audio information may be extracted.

In step S1307, the display control unit 925 of the information terminal 107 controls the display/input unit 806 to selectably display the information on the plurality of bus stops 502 as illustrated in FIG. 5A, for example, based on the extracted route ID and bus stop ID and the route information 930 included in the app run on the information terminal 107.

In step S1308, the request information transmitting unit 924 of the information terminal 107 transmits request information including the extracted vehicle ID of the bus 105 and the app ID of the information terminal 107 to the operation management server 102.

In step S1309, when the request information receiving unit 943 of the operation management server 102 receives the request information from the information terminal 107, the operation information providing unit 944 acquires from the operation information storage unit 948, the operation information of the bus 105 that is associated with the vehicle ID included in the received request information.

In step S1310, the operation information providing unit 944 of the operation management server 102 transmits the operation information on bus 105 acquired in step S1309 to the information terminal 107 based on the app ID received in step S1308.

In step S1311, the display control unit 925 of the information terminal 107 controls the display/input unit 806 to display the operation status message 506 indicting the operation status of the bus 105 as illustrated in FIG. 5A, for example, based on the operation information received from the operation management server 102. At this time, the display control unit 925 may also control the display/input unit 806 to display the map information 507 indicating the current position of the bus 105 as illustrated in FIG. 5A, for example, based on the operation information received from the operation management server 102.

Note that in a case where the communication control unit 921 of the information terminal 107 is unable to establish communication with the operation management server 102 in step S1308 (e.g., due to the information terminal 107 being out of communication range), the processes of step S1308 and subsequent steps are not performed. Even in such case, the user 108 of the information terminal 107 may still be able to obtain information on the next bus stop and the plurality of bus stops coming before and after the next bus stop.

By implementing the above-described process, the information providing system 100 may be able to provide the user 108 of the information terminal 107 with detailed information associated with the operation status of the bus 105 and thereby improve convenience for the user 108, for example.

(Content Providing Process)

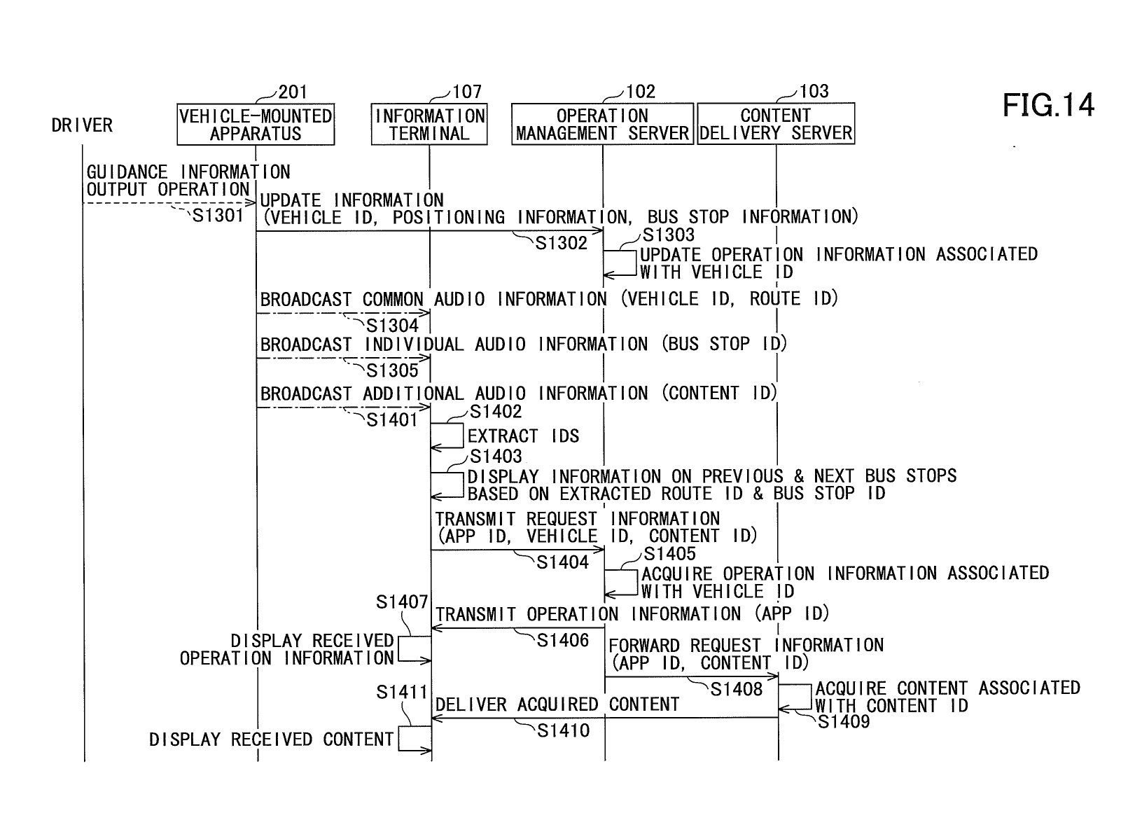

FIG. 14 is a sequence chart illustrating an example content providing process according to the first embodiment. Note that processes implemented in steps S1301 through S1305 of FIG. 14 are substantially identical to the processes of the corresponding steps in the above-described operation information providing process of FIG. 13, and as such, descriptions of these process steps are omitted.

In step S1401, the audio information providing unit 906 of the vehicle-mounted apparatus 201 outputs additional audio information (e.g., information ID “3001”) of FIG. 100 using the internal speakers 106a and 106b, for example. The additional audio information may have a content ID (e.g., “ADID2001”) embedded therein as a digital watermark, for example.

In this way, the vehicle-mounted apparatus 201 and the audio information providing unit 906 may be able to output additional audio information in addition to common audio information and individual audio information using the internal speakers 106a and 106b if necessary.

In step S1402, the information extracting unit 923 of the information terminal 107 extracts the identification information embedded as digital watermarks in the audio information that has been acquired by the audio acquiring unit 922. For example, the information extracting unit 923 may extract the vehicle ID, the route ID, the bus stop ID, and the content ID that are embedded in the audio information.

In step S1403, the display control unit 925 of the information terminal 107 controls the display/input unit 806 to selectably display the information on the plurality of bus stops 502 as illustrated in FIG. 5A, for example, based on the extracted route ID and bus stop ID and the route information 930 included in the app run on the information terminal 107.

In step S1404, the request information transmitting unit 924 of the information terminal 107 transmits request information including the extracted vehicle ID of the bus 105, the app ID of the information terminal 107, and the extracted content ID to the operation management server 102.

In step S1405, when the request information receiving unit 943 of the operation management server 102 receives the request information from the information terminal 107, the operation information providing unit 944 acquires from the operation information storage unit 948, the operation information of the bus 105 that is associated with the vehicle ID included in the request information.

In step S1406, the operation information providing unit 944 of the operation management server 102 transmits the operation information of the bus 105 acquired in step S1405 to the information terminal 107.

In step S1407, the display control unit 925 of the information terminal 107 controls the display/input unit 806 to display the operation status message 513 indicating the operation status of the bus 105 as illustrated in FIG. 5B, for example, based on the operation information received from the operation management server 102.

Also, when the operation management server 102 receives the request information from the information terminal 107 in step S1404, the operation management server 102 may execute processes of steps S1408 through S1411 as described below in parallel with (or before/after) the above-described processes of steps S1405 through S1407.

In step S1408, the request information transfer unit 945 of the operation management server 102 forwards the request information received from the information terminal 107 to the content delivery server 103. The request information that is forwarded to the content delivery server 103 may include the app ID for identifying the information terminal 107 and the content ID, for example.

In step S1409, when the request information receiving unit 962 of the content delivery server 103 receives the request information forwarded by the operation management server 102, the content providing unit 963 extracts content corresponding to the content ID included in the received request information from the content information 966. For example, assuming the content information 966 has the configuration as illustrated in FIG. 12A, if the content ID “CID3002” is included in the received request information, the content providing unit 963 may extract the text “ΔΔ will be held today from 11:00 at XX on the 2^{nd} floor of ◯◯ building,” as the corresponding content. As noted above, text is merely one example form of content included in the content information 966.

In step S1410, the content providing unit 963 of the content delivery server 103 delivers the content acquired in step S1409 to the information terminal 107.

In step S1411, the display control unit 925 of the information terminal 107 controls the display/input unit 806 to display the display screen as illustrated in FIG. 5B, for example, based on the content received from the content delivery server 103.

Note that in the above-described example, the content delivery server 103 delivers content to the information terminal 107 based on the content ID included in the request information. However, in another example, the content delivery server 103 may be configured to deliver content to the information terminal 107 based on the bus stop ID included in the request information.

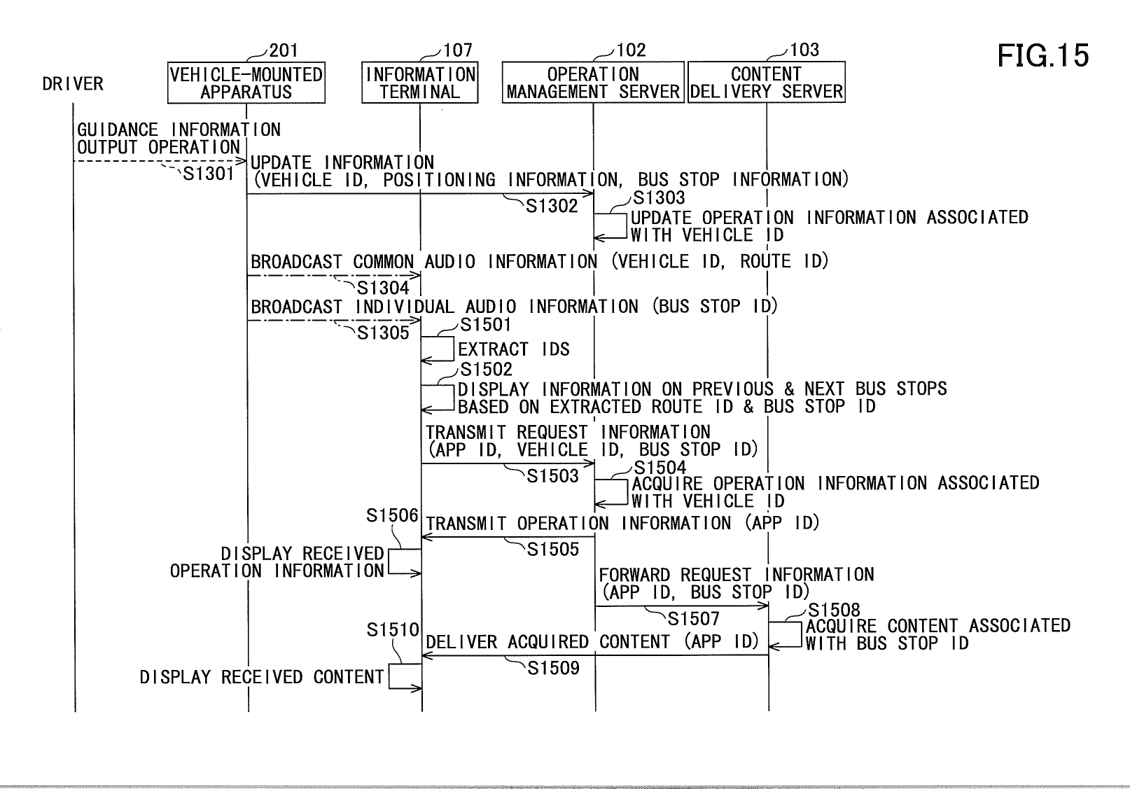

FIG. 15 is a sequence chart illustrating another example content providing process according to the first embodiment. Note that processes of steps S1301 through S1305 of FIG. 15 are substantially identical to the processes of the corresponding steps of the operation information providing process of FIG. 13, and as such descriptions of these processes are omitted.

Note that in the present example, the content delivery server 103 delivers content to the information terminal 107 without using the content ID included in the additional audio information. As such, the process of step S1401 of FIG. 14 for outputting the additional audio information through audio broadcast in the bus 105 may be performed but does not have to be performed in the present example.

In step S1501, the information extracting unit 923 of the information terminal 107 extracts the identification information embedded as digital watermarks in the audio information that has been acquired by the audio acquiring unit 922. For example, the information extracting unit 923 may extract the vehicle ID, the route ID, and the bus stops ID that are embedded in the acquired audio information.

In step S1502, the display control unit 925 of the information terminal 107 controls the display/input unit 806 to selectably display the information on the plurality of bus stops 502 as illustrated in FIG. 5A, for example, based on the extracted route ID and bus stop ID and the route information 930 included in the app run on the information terminal 107.

In step S1503, the request information transmitting unit 924 of the information terminal 107 transmits request information including the extracted vehicle ID of the bus 105, the app ID of the information terminal 107, and the extracted bus stop ID to the operation management server 102.

In step S1504, when the request information receiving unit 943 of the operation management server 102 receives the request information from the information terminal 107, the operation information providing unit 944 acquires from the operation information storage unit 948, the operation information of the bus 105 that is associated with the vehicle ID included in the received request information.

In step S1505, the operation information providing unit 944 of the operation management server 102 transmits the operation information of the bus 105 acquired in step S1504 to the information terminal 107.

In step S1506, the display control unit 925 of the information terminal 107 controls the display/input unit 806 to display the operation status message 513 indicating the operation status of the bus 105 as illustrated in FIG. 5B, for example, based on the operation information received from the operation management server 102.

Also, when the operation management server 102 received the request information from the information terminal 107 in step S1503, the operation management server 102 executes processes of steps S1507 through S1510 as described below in parallel with (or before/after) the above-described processes of steps S1504 through S1506.

In step S1507, the request information forwarding unit 945 of the operation management server 102 forwards the request information received from the information terminal 107 to the content delivery server 103. The request information that is forwarded to the content delivery server 103 may include, the app ID for identifying the information terminal 107 and the bus stop ID, for example.

In step S1508, when the request information receiving unit 962 of the content delivery server 103 receives the request information from the operation management server 102, the content providing unit 963 extracts from the content information 966, content corresponding to the bus stop ID included in the received request information. For example, assuming the content information 966 has the configuration as illustrated in FIG. 12B, if the bus stop ID is “BSID11004” is included in the received request information, the content providing unit 963 may extract the text “ΔΔ will be held today from 11:00 at XX on the 2^{nd} floor of ◯◯ building,” as the corresponding content. As noted above, text is merely one example form of content included in the content information 966.

In step S1509, the content providing unit 963 of the content delivery server 103 delivers the content acquired in step S1508 to the information terminal 107.

In step S1510, the display control unit 925 of the information terminal 107 controls the display/input unit 806 to display the display screen as illustrated in FIG. 5B, for example, based on the content received from the content delivery server 103.

As described above, the information providing system 100 according to the present embodiment can provide the user 108 of the information terminal 107 with a variety of content, such as event information and information on commercial establishments located near a bus stop, in addition to the operation information of the bus 105.

### Second Embodiment

In the following, a process implemented by the information providing system 100 according to a second embodiment of the present invention is described. The process according to the second embodiment is implemented when the user 108 on the bus 105 uses the information terminal 107 to register a destination bus stop at which the user intends to get off the bus 105.

(Display Screen)

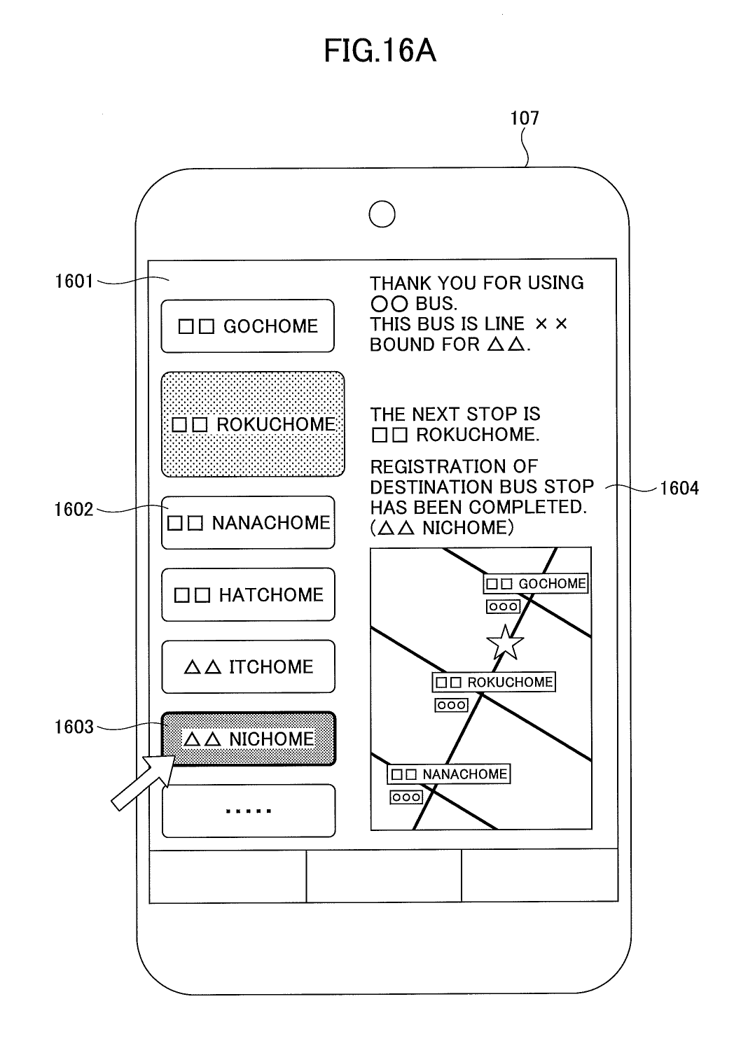

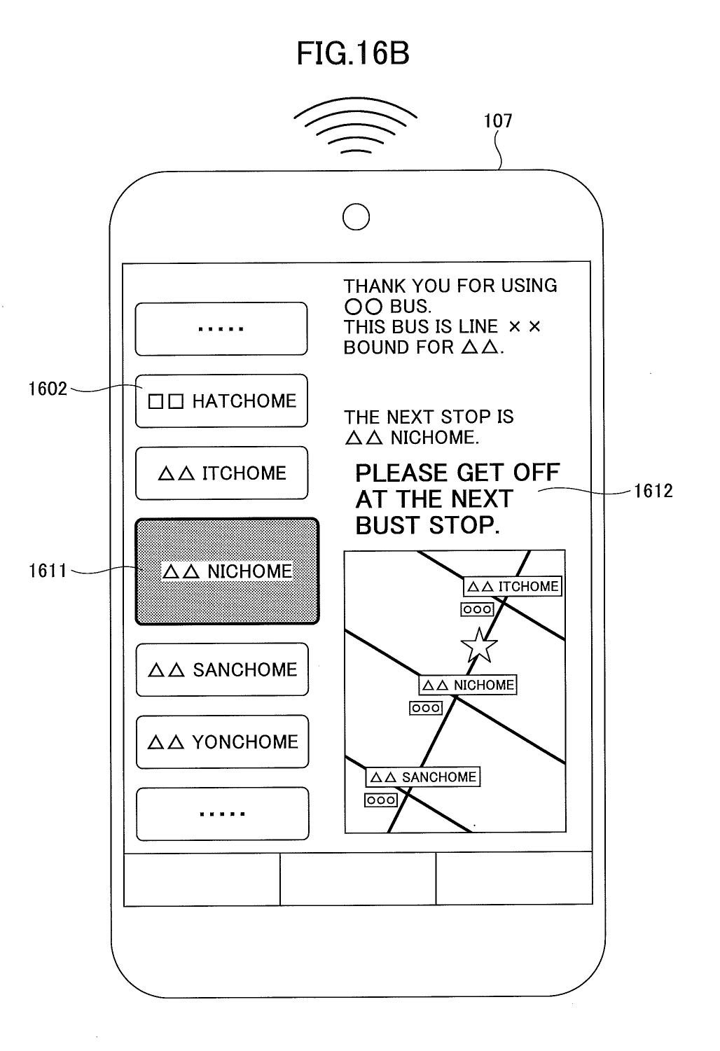

FIGS. 16A and 16B are diagrams illustrating example display screens of the information terminal 107 according to the second embodiment.

FIG. 16A illustrates an example display screen 1601 for designating a destination bus stop. For example, by implementing a process similar to step S1307 of FIG. 13, the display screen 1601 of the information terminal 107 may selectably display information on a plurality of bus stops 1602 that are included in the route traveled by the bus 105.

The information on the plurality of bus stops 1602 may be scrolled up or down by a swiping operation, for example. Also, a destination bus stop may be selected from the information on the plurality of bus stops 1602 by a tapping operation, for example, to notify the driver of the bus 105 of the intention to get off the bus 105 at the selected destination bus stop.

FIG. 16B illustrates an example notification screen indicating that the bus 105 is about to arrive at the destination bus stop. The information terminal 107 updates the information on the plurality of bus stops 1602 based on guidance information provided by the bus 105 through audio broadcast. Also, when the bus 105 approaches the bus stop registered as the destination bus stop, the information terminal 107 notifies the user 108 that the bus 105 is about to arrive at the registered destination bus stop by displaying a text message 1612, outputting a sound, or generating a vibration, for example. Note that the notification screen illustrated in FIG. 16B is merely one example, and the information terminal 107 may alternatively indicate the number of bus stops to be passed and/or the estimated time before reaching the registered destination bus stop, for example.

<Process Flow>

(Bus Stop Registration Process)

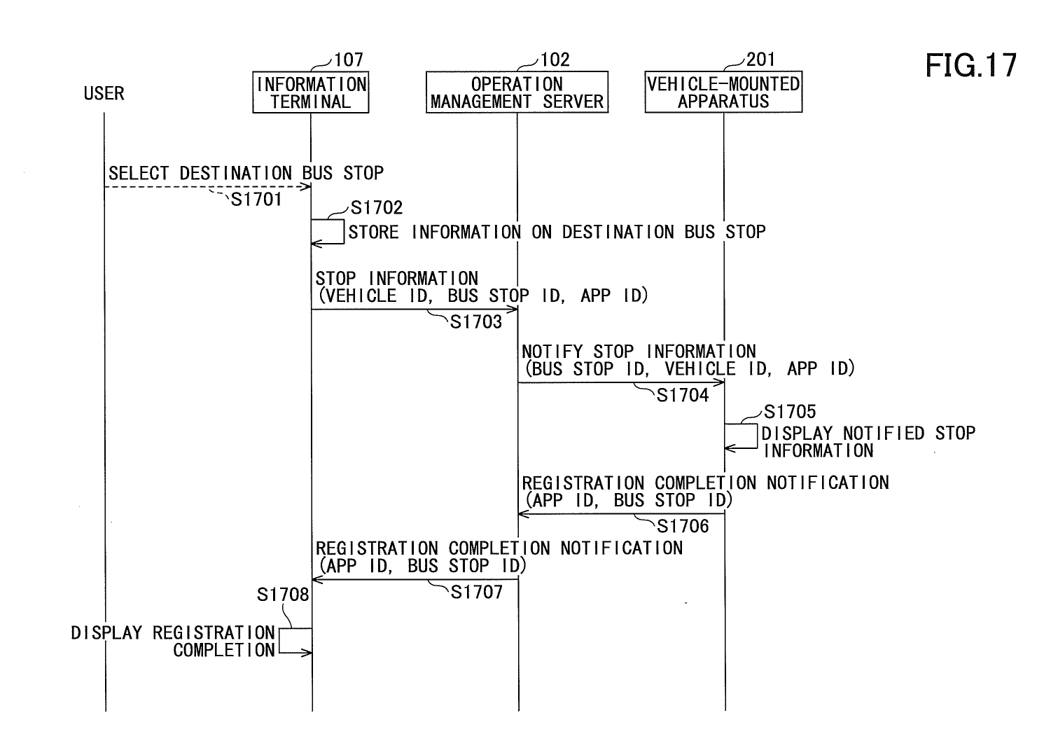

FIG. 17 is a sequence illustrating an example bus stop registration process according to the second embodiment.

In step S1701, the user 108 of the information terminal 107 performs a selection operation for selecting a destination bus stop (e.g., “ΔΔ sanchome”) from the display screen of FIG. 16A, for example.

In step S1702, the operation accepting unit 926 of the information terminal 107 accepts the destination bus stop selection operation and stores information on the selected destination bus stop in the storage unit 929 of the information terminal 107, for example.

In step S1703, the stop information transmitting unit 927 of the information terminal 107 transmits stop information indicating that the user 108 wishes to get off the bus 105 at the selected destination bus stop to the operation management server 102. The stop information may include the vehicle ID of the bus 105, the bus stop ID identifying the destination bus stop, and the app ID identifying the information terminal 107, for example.

In step S1704, when the stop information receiving unit 946 of the operation management server 102 receives the stop information from the information terminal 107, the stop information providing unit 947 sends notification of the received stop information to the vehicle-mounted apparatus 201. The notification of the stop information may include the vehicle ID of the bus 105, the bus stop ID identifying the destination bus stop, and the app ID identifying the information terminal 107, for example.

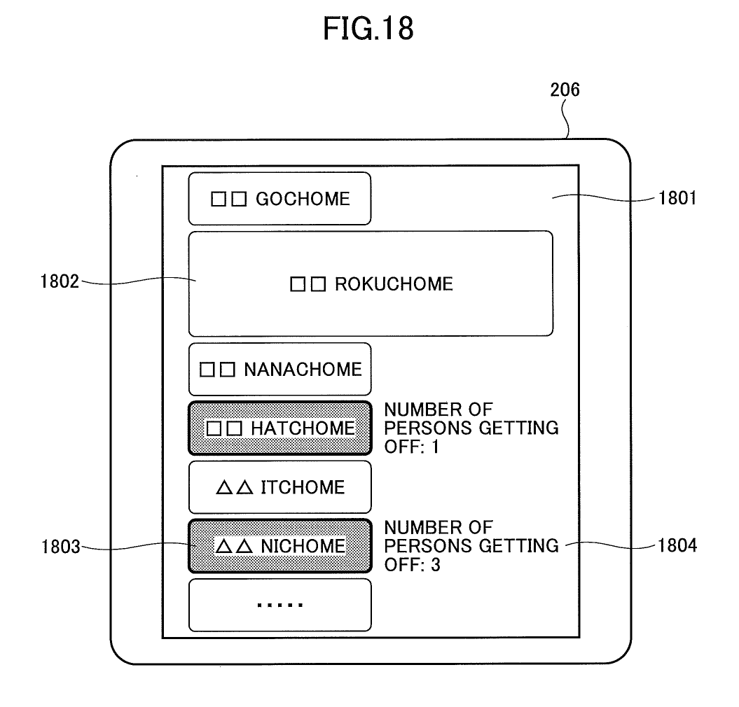

In step S1705, when the communication control unit 901 of the vehicle-mounted apparatus 201 receives the notification of the stop information from the operation management server 102, the operation information display unit 903 controls the display device 206 to display the received stop information. As a result, for example, a display screen as illustrated in FIG. 18 may be displayed on the display device 206.

FIG. 18 is a diagram illustrating an example display screen 1801 that may be displayed on the display device 206 of the vehicle-mounted system 101 according to the second embodiment. In the example of FIG. 18, the display screen 1801 displayed on the display device 206 of the vehicle-mounted system 101 displays information on a plurality of bus stops on the route traveled by the bus 105.

Also, in the example of FIG. 18, the information on the plurality of bus stops includes information on the next bus stop 1802 that is displayed larger than the other bus stops. Also, when the vehicle-mounted apparatus 201 receives stop information indicating that a user (passenger) wishes to get off at a specific bus stop (destination bus stop), the operation information display unit 903 of the vehicle-mounted apparatus 201 may control the display device 206 to distinguishably display bus stop information 1803 of the specific bus stop by inverting the color of the bus stop information 1803 or displaying the bus stop information 1803 in a different color from the other bus stops, for example. Also, when stop information indicating that a user (passenger) wishes to get off at the specific bus stop is received again, for example, the operation information display unit 903 of the vehicle-mounted apparatus 201 may control the display device 206 to display information 1804 indicating the number of passengers that are to get off at the specific bus stop (destination bus stop), for example.

Referring back to FIG. 17, further process steps of the bus stop registration process are described.

In step S1706, the operation information display unit 903 of the vehicle-mounted apparatus 201 transmits a registration completion notification to the operation management server 102 indicating that the stop information has been displayed. The registration completion notification may include the app ID of the information terminal 107 and the bus stop ID of the bus stop displayed as the destination bus stop for a passenger, for example.

In step S1707, the stop information providing unit 947 of the operation management server 102 forwards the registration completion notification received from the vehicle-mounted apparatus 201 to the information terminal 107.

In step S1708, the display control unit 925 of the information terminal 107 displays on the display screen 1601 a message 1604 indicating that the destination bus stop registration process has been completed as illustrated in FIG. 16A, for example.

By implementing the above-described process, for example, discrepancies between the destination bus stop registration status at the information terminal 107 and the destination bus stop registration status displayed on the display device 206 of the vehicle-mounted system 101 of the bus 105 may be reduced.

(Notification Process of Information Terminal)

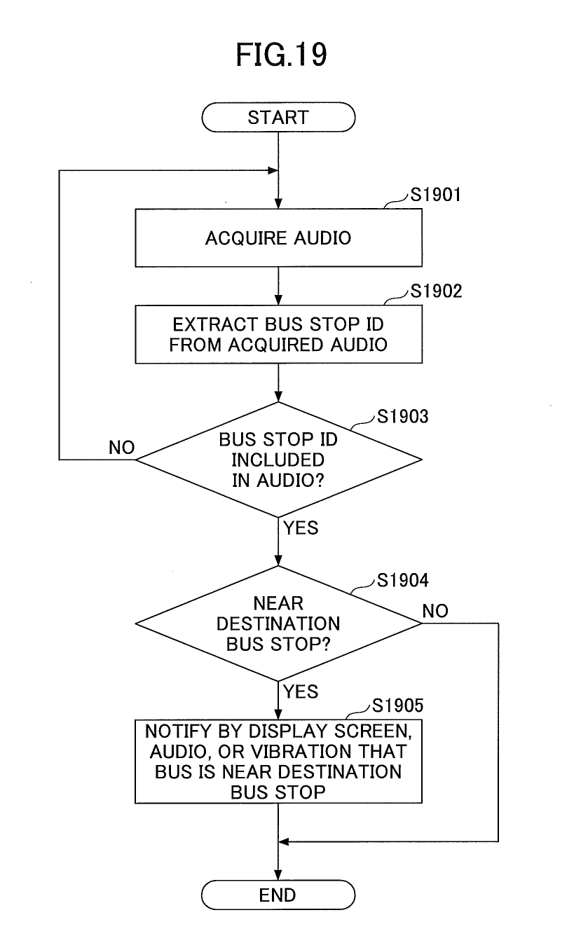

FIG. 19 is a flowchart illustrating an example notification process of the information terminal according to the second embodiment. The illustrated process of FIG. 19 may be implemented by the information terminal 107 after a destination bus stop is selected at the display screen 1601 for designating a destination bus stop as illustrated in FIG. 16A, for example.

In step S1901, the audio acquiring unit 922 of the information terminal 107 acquires audio of the surroundings.

In step S1902, the information extracting unit 923 of the information terminal 107 performs a process for extracting a bus stop ID embedded as a digital watermark the in the audio acquired by the audio acquiring unit 922.

In step S1903, if the audio acquired by the audio acquiring unit 922 does not include a bus stop ID, the information terminal 107 (NO in step S1903), the process goes back to step S1901. On the other hand, if the audio acquired by the audio acquiring unit 922 includes a bus stop ID, the process of the information terminal 107 proceeds to step S1904. In step S1904, the notification unit 928 of the information terminal 107 determines whether the bus stop identified by the bus stop ID acquired in step S1902 is close to the registered destination bus stop. Note that the method of determining whether the bus stop identified by the acquired bus stop ID is close to the destination bus stop is not particularly limited. For example, the bus stop is may be determined to be close to the destination bus stop if the number of the bus stops between the bus stop and the destination bus stop is less than or equal to a predetermined number (e.g., one).

If it is determined that the bus stop identified by the acquired bus stop ID is not close to the destination bus stop, the notification unit 928 ends the process. On the other hand, if it is determined that the bus stop is close to the destination bus stop, the notification unit 928 proceeds to step S1905.

In step S1905, the notification unit 928 notifies the user 108 that the bus 105 is near the destination bus stop by displaying a relevant screen on the display/input unit 806, generating a vibration by the vibrator unit 809, or outputting a sound by the speaker unit 808, for example.

As described above, according to the present embodiment, the user 108 of the information terminal 107 may use the information terminal 107 to register in advance information on a destination bus stop at which the user 108 wishes to get off the bus 105. In this way, the registered destination bus stop information may be displayed on the display device 206 of the vehicle-mounted system 101. Also, when the bus 105 approaches the registered destination bus stop, the information terminal 107 may be able to notify the user.

### Third Embodiment

In the following, the information providing system 100 according to a third embodiment of the present invention is described. In the following description of the third embodiment, an example case is described where the vehicle-mounted system 101 uses the external speaker 211 to provide information to a user that is located outside the bus 105.

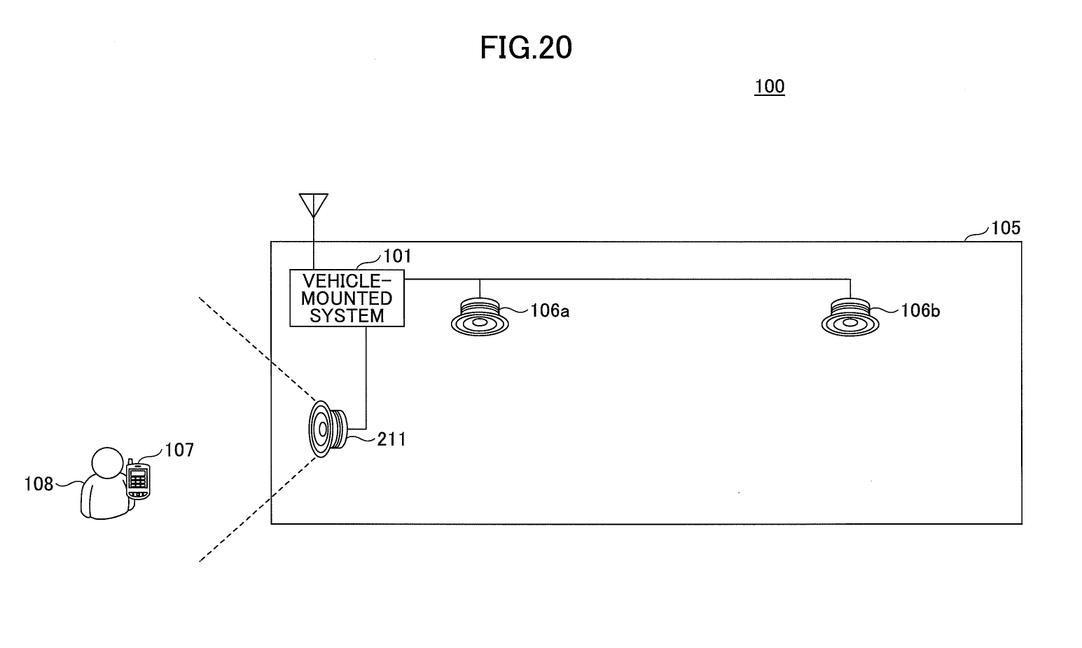

FIG. 20 is a diagram illustrating an example configuration of the information providing system 100 according to the third embodiment.

In some cases, it may be difficult for a user getting on a bus 105 from a bus stop or a bus terminal to determine whether the bus 105 will stop at the user's desired destination, for example. Such may be the case when the user is getting on the bus 105 from an unfamiliar location, or the bus 105 travels through different routes with different bus stops even when the destination is the same, for example.

Thus, the vehicle-mounted system 101 according to the present embodiment is configured to embed identification information such as a route ID as a digital watermark in guidance information (audio information) to be output through audio broadcast by the external speaker 211 and provide such guidance information to the information terminal 107 that is located outside the bus 105, for example. In this way, the information terminal 107 carried by the user 108 may be able to display information such as the plurality of bus stops that will be on the route of the bus 105, for example.

(Display Screen of Information Terminal)

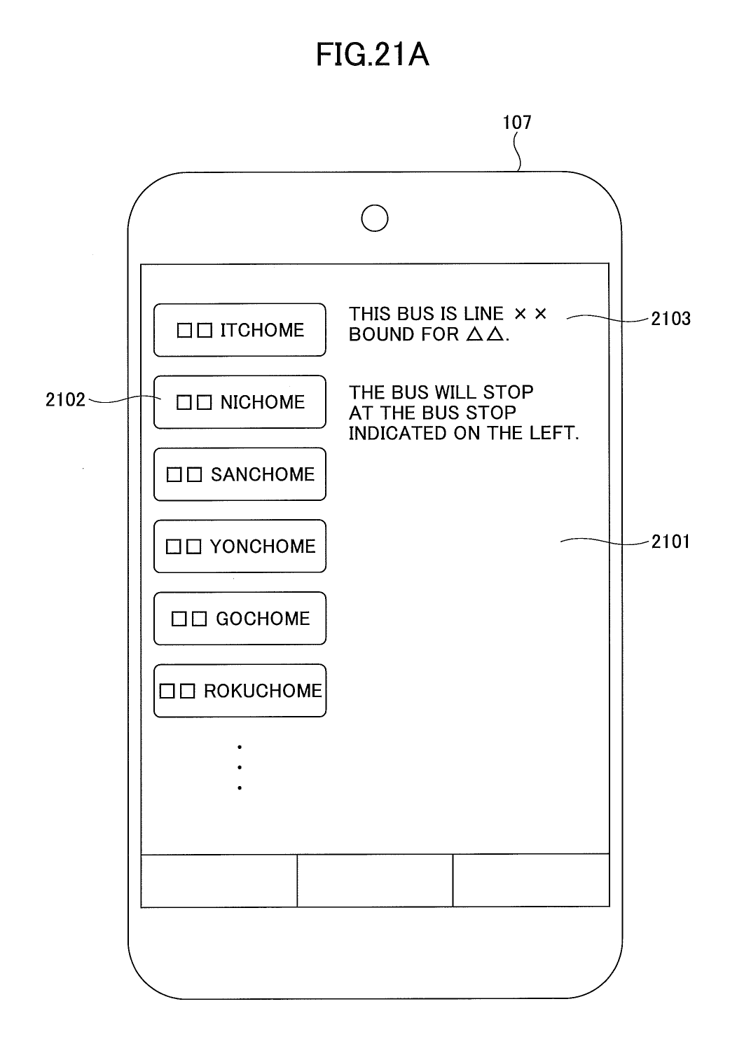

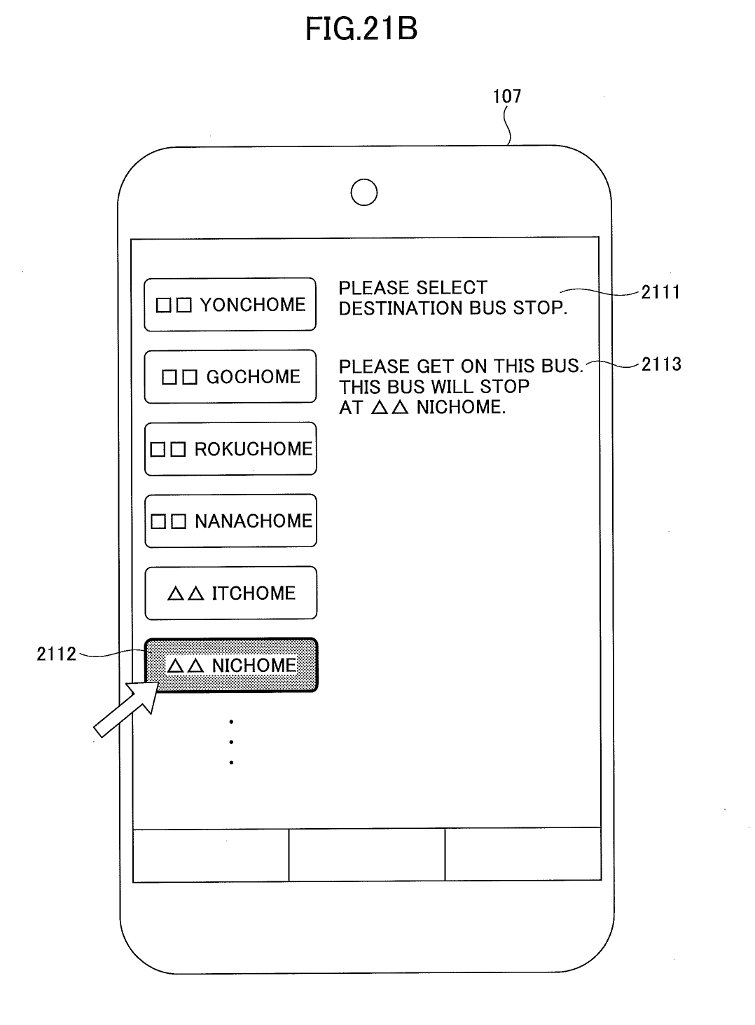

FIGS. 21A and 21B are diagrams illustrating example display screens of the information terminal 107 according to the third embodiment.

FIG. 21A illustrates an example display screen 2101 displaying information on a plurality of accessible bus stops 2102 that are accessible using the bus 105 based on a route ID embedded in audio information output by the external speaker 211 of the bus 105 and route information included in the app run on the information terminal 107. Also, the information terminal 107 may display route information 2103 on the display screen 2101 based on the above information, for example.

Thus, for example, the user of the information terminal 107 may check the information on the plurality of accessible bus stops 2102 displayed on the display screen 2101 to determine whether the bus 105 will stop at the user's desired destination.

FIG. 21B is a diagram showing another example display screen. In the example of FIG. 21B, information on a plurality of accessible bus stops may be displayed in advance on the display screen of the information terminal 107 based on a route selected by the user 108 of the information terminal 107, for example. The display screen of the information terminal 107 also displays a message 2111 prompting the user 108 to select a destination bus stop. When the user 108 selects bus stop information 2112 of one bus stop in response to the message 2111, the selected bus stop information 2112 is distinguishably displayed by inverting the color of the bus stop information 2112 or changing the color of the bus stop information 211, for example.

When the information terminal 107 that is displaying the above-described information on the display screen acquires a route ID embedded in audio output by the external speaker 211 of the bus 105, the information terminal 107 further displays on the display screen information 2113 indicating whether the bus 105 will stop at the selected bus stop.

<Process Flow>

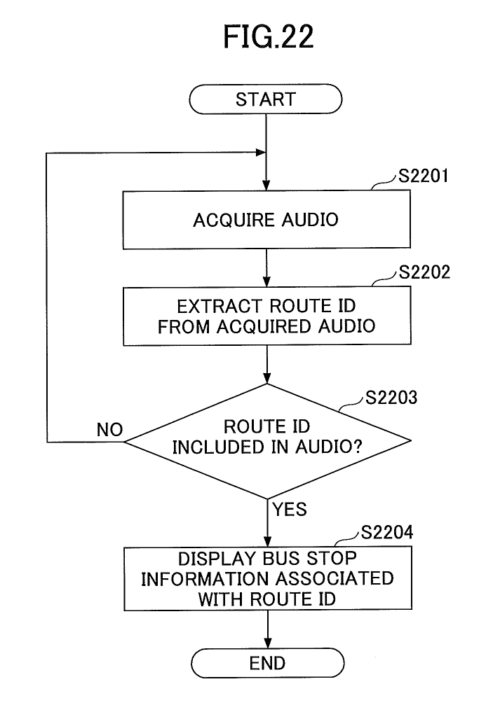

FIG. 22 is a flowchart illustrating an example process of the information terminal 107 according to the third embodiment. Note that the process of FIG. 22 corresponds to an example process of displaying the display screen as illustrated in FIG. 21A.

In step S2201, the audio acquiring unit 922 of the information terminal 107 acquires audio from the surroundings of the information terminal 107.

In step S2202, the information extracting unit 923 of the information terminal 107 performs a process for extracting a route ID embedded as a digital watermark in the audio acquired by the audio acquiring unit 922. In this way, for example, as illustrated in FIG. 20, when the user 108 of the information terminal 107 approaches the bus 105, the information terminal 107 may be able to acquire the route ID for identifying the route of the bus 105.

In step S2203, the information extracting unit 923 of the information terminal 107 determines whether a route ID is included in the audio acquired by the audio acquiring unit 922.

If the audio acquired by the audio acquiring unit 922 does not include a route ID, the information terminal 107 proceeds to step S2201. On the other hand, if the audio acquired by the audio acquiring unit 922 includes a route ID, the information terminal 107 proceeds to step S2204.

In step S2204, the information terminal 107 controls the display/input unit 806 to display the information on the plurality of accessible bus stops 2102 as illustrated in FIG. 21A, for example, based on the extracted route ID and the route information 930 included in the app run on the information terminal 107.

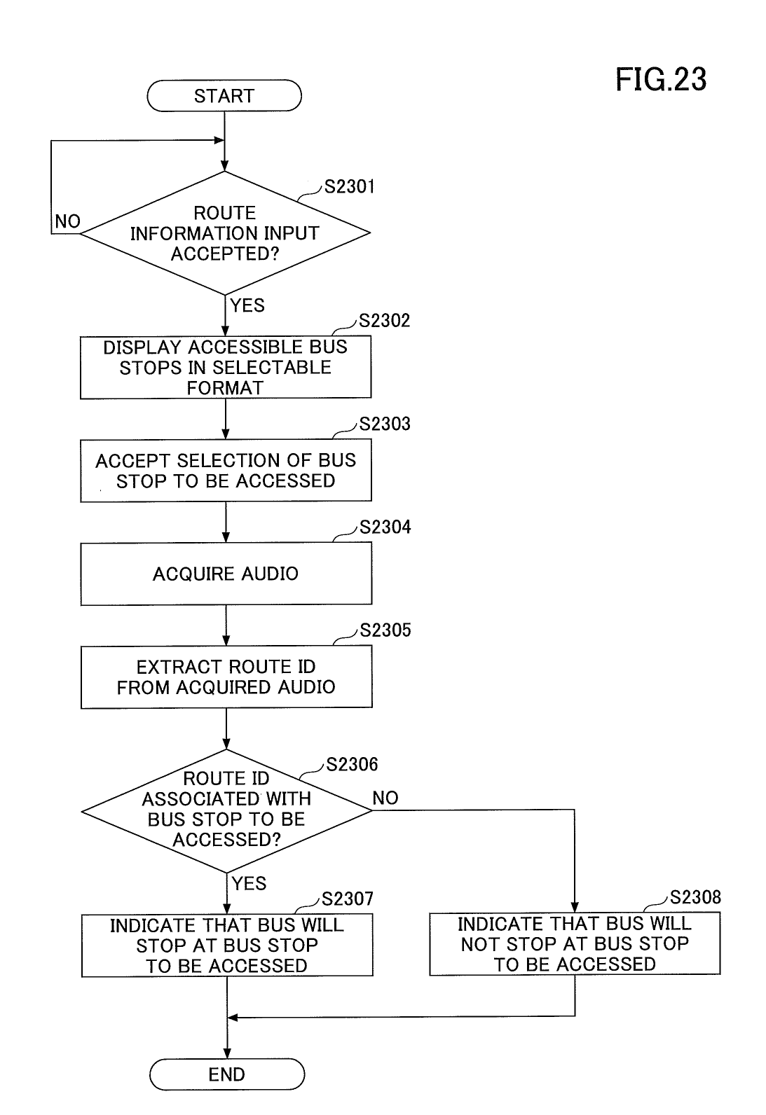

FIG. 23 is a flow chart illustrating another example process of information terminal 107 according to the third embodiment. Note that the process of FIG. 23 corresponds to an example process of displaying the display screen as illustrated in FIG. 21B.

In step S2301, when the operation accepting unit 926 of the information terminal 107 accepts an input of route information (YES in step S2301), the information terminal 107 executes the processes of step S2302 and subsequent steps.

In step S2302, the display control unit 925 of the information terminal 107 controls the display/input unit 806 to selectably display information on a plurality of accessible bus stops that can be accessed on the corresponding route based on the route information accepted in step S2301.

In step S2303, the operation reception unit 926 of the information terminal 107 accepts a selection of a bus stop to be accessed by the user 108 (destination bus stop for the user 108).

In step S2304, the audio acquiring unit 922 of the information terminal 107 acquires audio of the surroundings of the information terminal 107.

In step S2305, the information extracting unit 923 of the information terminal 107 performs a process for extracting a route ID embedded as a digital watermark in the audio acquired by the audio acquiring unit 922.

In step S2306, the information terminal 107 determines whether the route corresponding to the route ID acquired in step S2305 includes the destination bus stop selected by the user 108.

If the route corresponding to the route ID acquired in step S2305 includes the destination bus stop selected by the user 108 (YES in step S2306), the process proceeds to step S2307 where the display control unit 925 of the information terminal 107 controls the display/input unit 806 to indicate that the bus 105 will stop at the selected destination bus stop (e.g., the information 2113 of FIG. 21B).

On the other hand, if the route corresponding to the route ID acquired in step S2305 does not include the destination bus stop selected by the user 108 (NO in step 2306), the process proceeds to step S2308 where the display control unit 925 of the information terminal 107 controls the display/input unit 806 to indicate that the bus 105 will not stop at the selected destination bus stop.

As described above, the information providing system 100 according to the present embodiment can provide detailed information associated with the operation status of the bus 105 to the user 108 even when the user 108 is located outside the bus 105 such that convenience for the user 108 may be further improved.

### Fourth Embodiment

In the above-described first through third embodiments of the present invention, the bus 105 is illustrated as an example transport vehicle included in the information providing system 100. However, the bus 105 is merely one example of a transport vehicle, and other examples of transport vehicles according to embodiments of the present invention include a ship, an aircraft, a train, and various other types of transport vehicles. In the following, an information providing system according to a fourth embodiment of the present invention that includes a ship, such as a passenger ship, as a transport vehicle is described.

(Ship Layout)

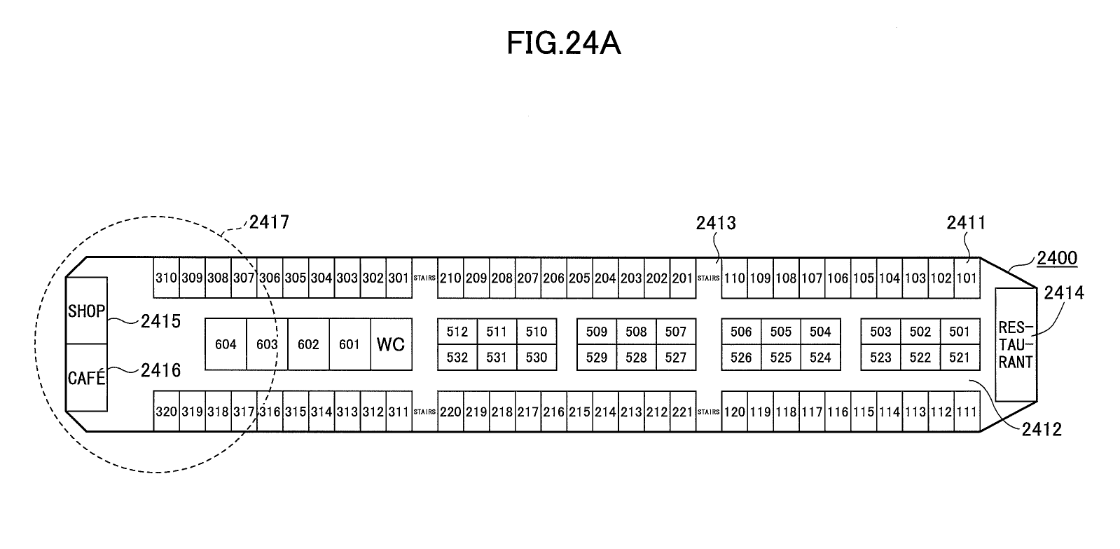

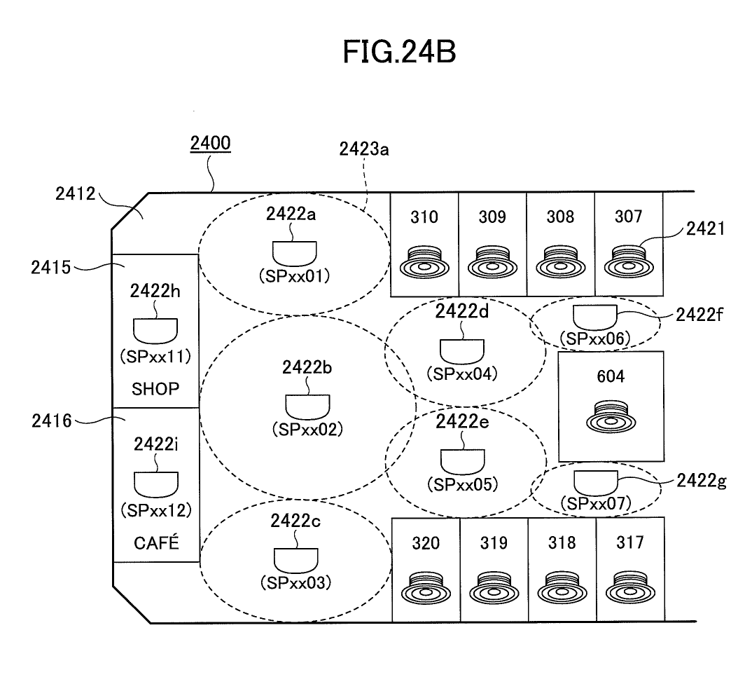

FIGS. 24A and 24B are diagrams illustrating an example ship layout 2400 according to the fourth embodiment. The ship layout 2400 of FIG. 24A illustrates the layout of one floor among a plurality of floors of a ship, such as a passenger ship.

In FIG. 24A, it is assumed that a plurality of spaces 2411 each having a 3-digit number represent rooms. In FIG. 24A, a plurality of rooms 2411, passages 2412, stairs 2413 are arranged in the ship layout 2400. Also, a restaurant 2414 is arranged at the bow side (right side in FIG. 24A), a shop 2415 and a cafés 2416 are arranged on the stern side (left side of FIGS. 24A and 24B) of the ship layout 2400.

FIG. 24B is an enlarged view of an area 2417 represented by a dotted circle within the ship layout 2400 of FIG. 24A. As illustrated in FIG. 24B, a speaker 2421 for outputting inboard audio broadcasts is provided in each of the rooms corresponding to individual spaces for the passengers on the ship. Also, in common spaces for the passengers, such as the passages 2412, the shop 2415, and the café 2416, output devices 2422a-2422i are arranged instead of or in addition to the speakers 2411. Note that in the following descriptions, a given output device of the output devices 2422a-2422i may be generically referred to as “output device 2422”.

As with the speaker 2411, the output device 2422 may output inboard audio broadcasts. In addition, the output device 2422 is configured to output audio including identification information for identifying the output device 2422 or the installation position of the output device 2422 (hereinafter referred to as “internal position ID”), for example.

With the above configuration, the speakers 2421 and the output devices 2422 may be used to provide audio information within the ship as audio broadcasts using audio information having predetermined identification information embedded therein in the audible sound range of the audio information in a manner similar to that described above in connection with the first embodiment, for example.

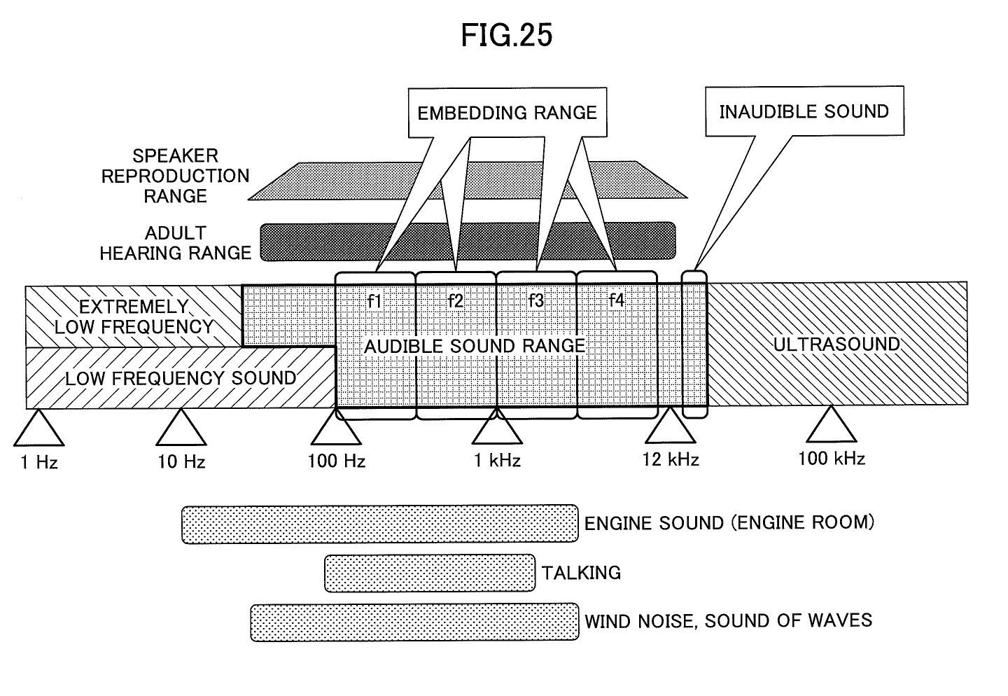

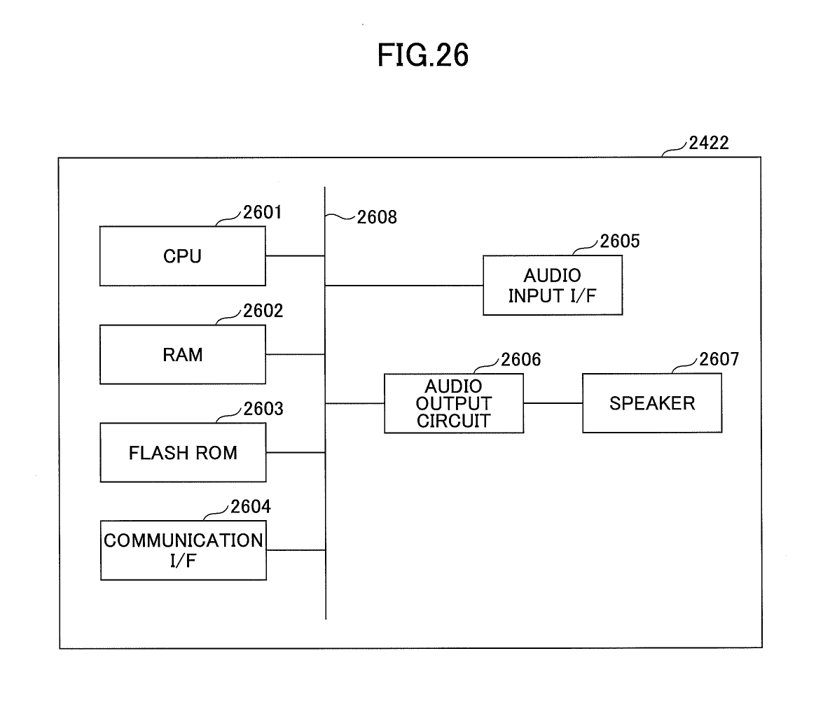

FIG. 25 is a diagram illustrating an example method of embedding identification information in audio information according to the fourth embodiment. Note that the method of embedding identification information as illustrated in FIG. 26 substantially correspond to the method of embedding identification information in a plurality of frequency bands according to the first embodiment as illustrated in FIG. 4A. In the ship according to the present embodiment, audio information may receive influences from noise that differ from those of the bus 105, such as an engine sound in the engine room, wind noise, and the sound of waves, for example.

However, even in a ship, influences of noise on audio information may be reduced as in a bus by dividing a frequency range from 100 Hz to 12 kHz into a plurality of frequency bands as in the example of FIG. 4A and embedding identification information in at least two of the frequency bands. Note that similar effects may also be achieved in other transport vehicles, such as an aircraft and a train, for example. Thus, even in the fourth embodiment and further embodiments described below, the same identification information is preferably embedded at least twice at different start times and/or different frequency bands of audio information as in the example illustrated in FIG. 4B.

<Hardware Configuration>

(Hardware Configuration of Output Device)

FIG. 26 is a diagram showing an example hardware configuration of the output device 2422 according to the fourth embodiment. The output device 2422 includes a CPU 2601, a RAM 2602, a flash ROM 2603, a communication I/F 2604, an audio input I/F 2605, an audio output circuit 2606, a speaker 2607, and a bus 2608.

The CPU 2601 is a processor that implements various functions of the output device 2422 by loading programs and data stored in the flash ROM 2603 or the like in the RAM 2602 and executing processed based on the loaded programs and data. The RAM 2602 is a volatile storage device that is used as a working area of the CPU 2601. The flash ROM 2603 is a non-volatile storage device that can retain programs and data even when the power is turned off. The flash ROM 2603 may store programs for the output device 2422 and the audio information including an internal position ID as described above, for example.

The communication I/F 2604 is a communication interface for establishing communication with a mounted apparatus on a ship via a wired/wireless LAN, for example. Note that the mounted apparatus is described in detail below.

The audio input I/F 2605 is an interface for inputting an audio signal of an inboard broadcast output by the mounted apparatus to the output device 2422.

The audio output circuit 2606 outputs to the speaker 2607 the audio signal input to the audio input I/F 2605 and an audio signal including the internal position ID as described above, for example. The speaker 2607 converts the audio signal output from audio output circuit 2606 into audio. The bus 2608 is connected to the above hardware elements of the output device 2422 and is used to transmit address signals, data signals, and various control signals, for example.

(Hardware Configuration of Mounted Apparatus)

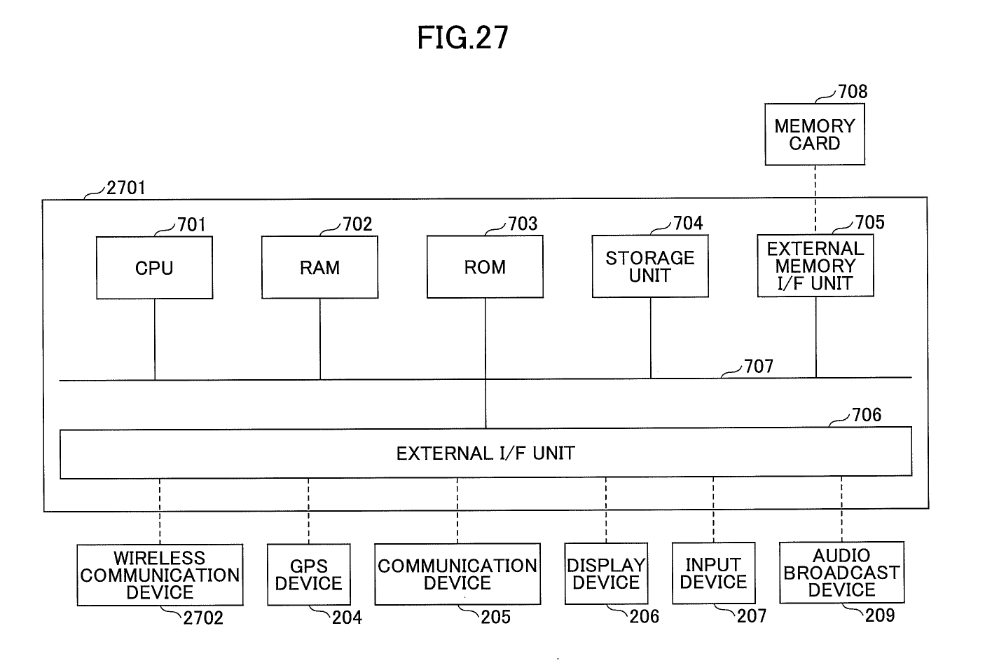

FIG. 27 is a diagram showing an example hardware configuration of a mounted apparatus 2701 that is mounted on the ship according to the fourth embodiment. The mounted apparatus 2701 of FIG. 27 has a configuration similar to that of the vehicle-mounted apparatus 201 of FIG. 7 but does not include devices used for the operation of a bus, such as the fare indicator 202, the fare box 203, and the stop display control device 208. Also, the mounted apparatus 2701 includes a wireless communication device 2702. Note that the other hardware elements of the mounted apparatus 2701 are substantially identical to the hardware elements of the vehicle-mounted apparatus 201 of FIG. 7, and as such, descriptions thereof will be omitted. The following descriptions focus on features of the mounted apparatus 2701 that differ from those of the vehicle-mounted apparatus 201 of FIG. 7.

The wireless communication device 2702 is a wireless communication interface for establishing predetermined wireless communication with a navigation management system which is described below.

<Functional Configuration>

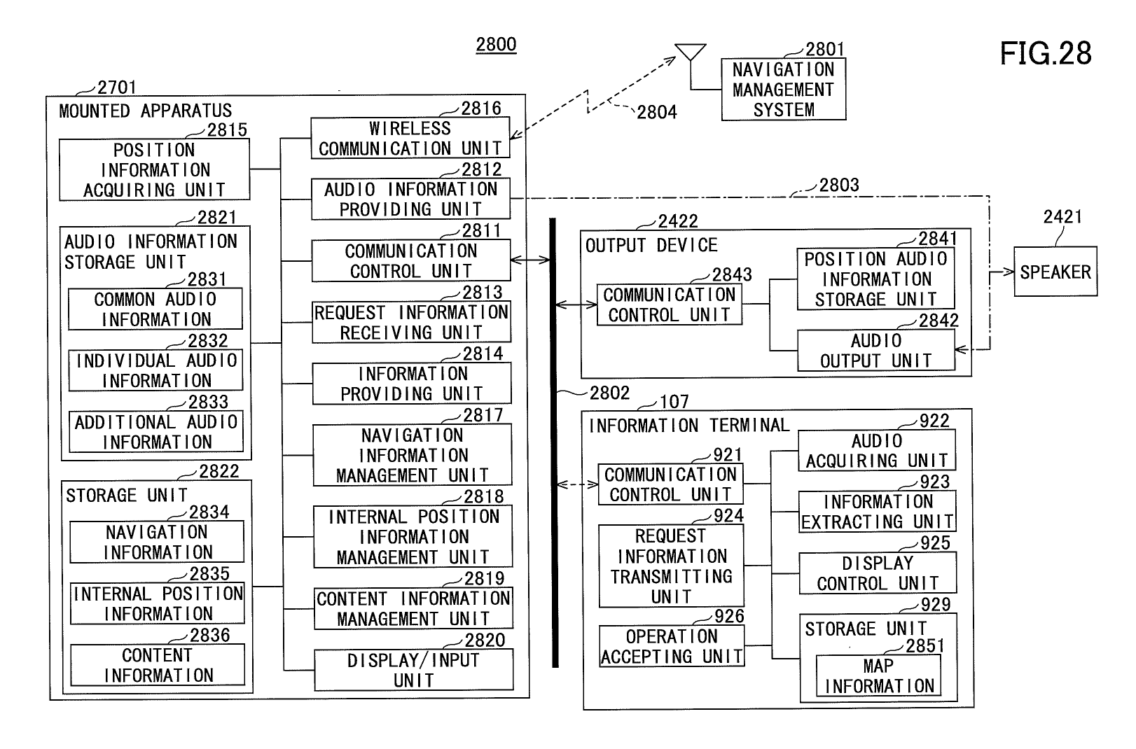

FIG. 28 is a block diagram illustrating an example functional configuration of an information providing system 2800 according to the fourth embodiment. As illustrated in FIG. 28, the information providing system 2800 includes the mounted apparatus 2701, the speaker 2421 and the output device 2422 that output audio based on an audio signal 2803 output by the mounted apparatus 2701, and the information terminal 107 that is used by the user 108 corresponding to a passenger on the ship on which the mounted apparatus 2701 is mounted.

The mounted apparatus 2701 may be configured by at least one information processing apparatus (computer) which may correspond to the computer 600 configuring the vehicle-mounted apparatus 201, the operation management server 102, and the content delivery server 103 of the information providing system 100 illustrated in FIG. 9, for example. The mounted apparatus 2701 is mounted on a ship, such as a passenger ship, and is connected to a network 2802, such as a wired/wireless LAN that is provided in the ship.

The mounted apparatus 2701 is preferably configured to be capable of acquiring navigation information of other ships from the navigation management system 2801, which may be located on land, for example, through a predetermined wireless communication 2804.

The information terminal 107 is used by the user 108 corresponding to a passenger on the ship. The information terminal 107 of the present embodiment has an app for implementing the information providing system 2800 installed therein. The information terminal 107 is capable of communicating with the mounted apparatus 2701 by establishing connection with the network 2802 using a wireless LAN, for example.

The speaker 2421 and the output device 2422 are described above with reference to FIG. 24 and may be installed at various positions on the ceiling of the ship, for example.

Note that the output device 2422 is preferably connected to the network 2802 such that it can communicate with the mounted apparatus 2701. However, the output device 2422 does not necessarily have to be connected to the network 2802.

(Functional Configuration of Mounted Apparatus)

The mounted apparatus 2701 includes a communication control unit 2811, an audio information providing unit 2812, a request information receiving unit 2813, an information providing unit 2814, a position information acquiring unit 2815, a wireless communication unit 2816, a navigation information management unit 2817, an internal position information management unit 2818, a content information management unit 2819, a display/input unit 2820, an audio information storage unit 2821, and a storage unit 2822.

The communication control unit 2811 may use the communication device 205 of FIG. 27, for example, to connect the mounted apparatus 2701 to the network 2802 and establish communication with the information terminal 107 and the output device 2422, for example. The communication control unit 2911 may be implemented by a program run on the CPU 701 of FIG. 27, for example.

The audio information providing unit 2812 may use the audio broadcast device 209 of FIG. 27, for example, to provide audio information associated with the navigation status of the ship by audio broadcast based on audio information stored in the audio information storage unit 2821. The audio information providing unit 2812 may be implemented by a program run on the CPU 701 of FIG. 27, for example.

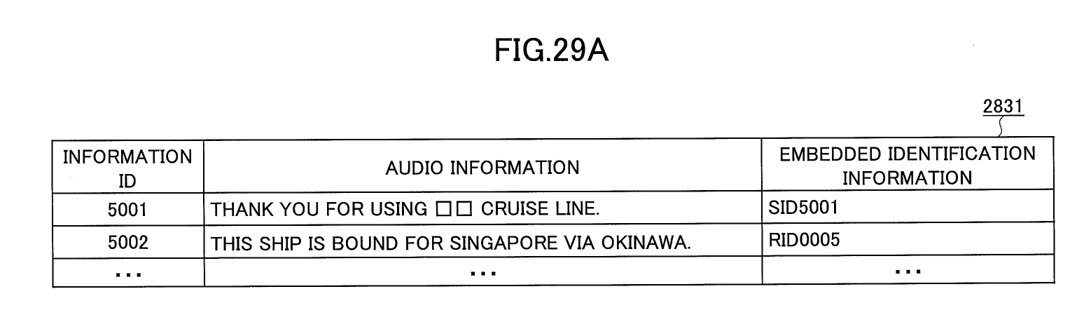

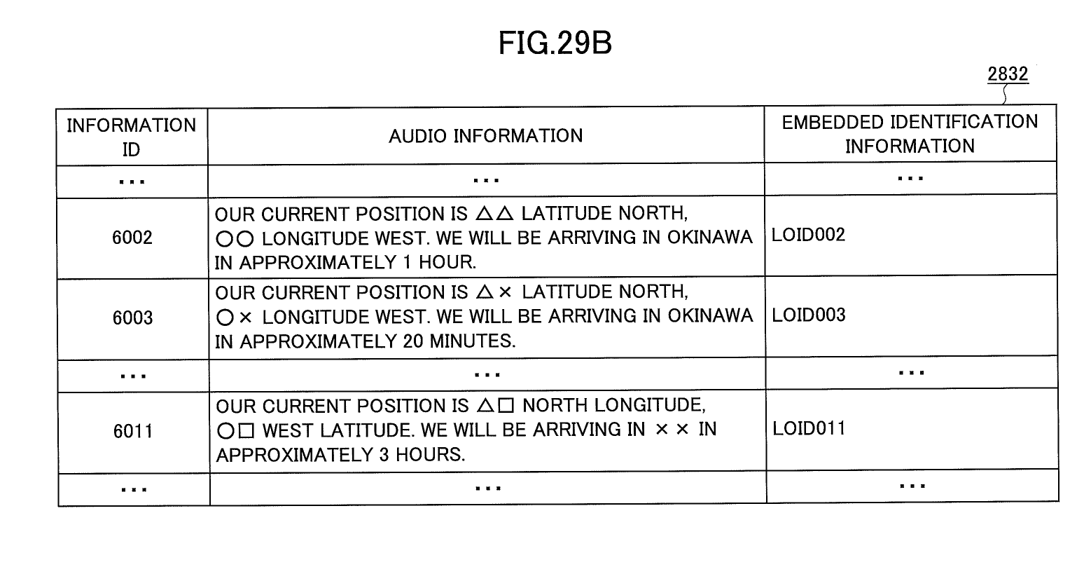

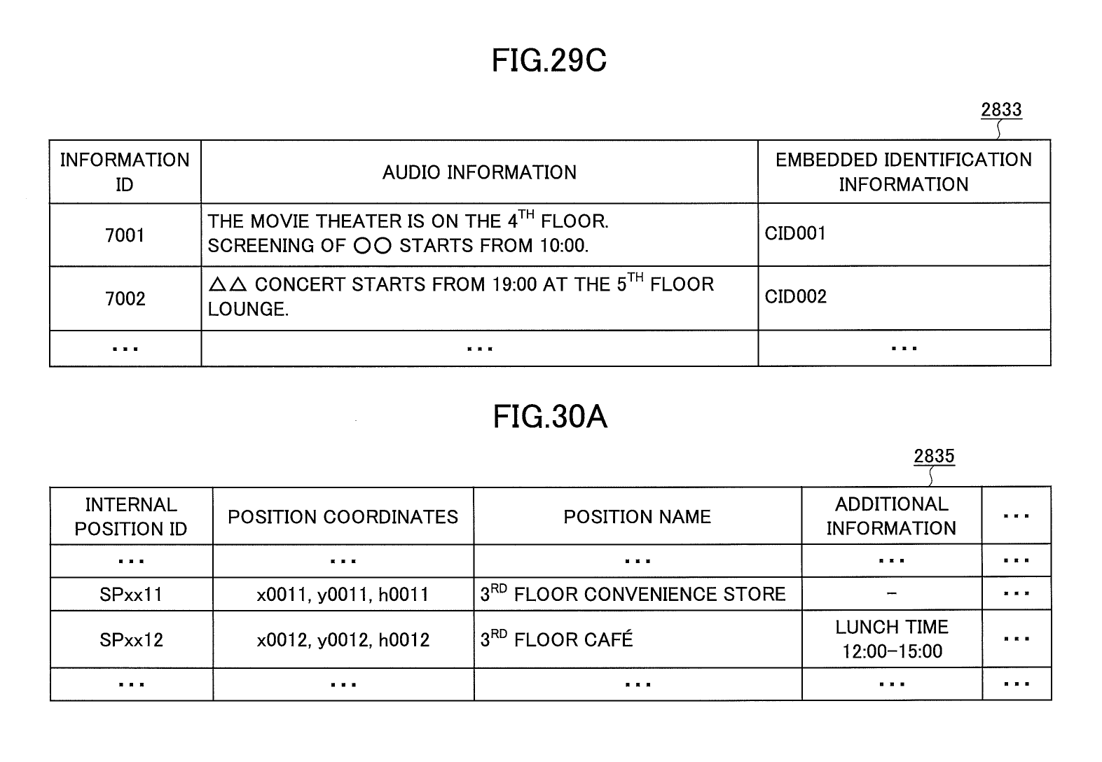

FIGS. 29A-29C illustrate examples of the audio information stored in the audio information storage unit 2821. FIG. 29A illustrates an example of common audio information 2831 stored in the audio information storage unit 2821. The common audio information 2831 may store audio data including common audio information for the ship, such as “Thank you for using □□ cruise line,” having a ship ID such as “SID5001” embedded therein as a digital watermark, for example. Also, the common audio information 2831 may store audio data including common audio information for a navigation route, such as “This ship is bound for Singapore via Okinawa,” having a route ID such as “RID0005” embedded therein as digital watermark, for example. Note that in FIGS. 29A-29C, “information ID” corresponds to identification information for managing each item of audio data.

FIG. 29B illustrate an example of individual audio information 2832 stored in the audio information storage unit 2821. The individual audio information 2832 may store a plurality of items of audio data associated with different navigation statuses. For example, the individual audio information 2832 may store audio data including audio information indicating a navigation status, such as “Our current position is ΔΔ north latitude, ◯◯ west longitude. We will be arriving in Okinawa in approximately 1 hour,” having a navigation position ID such as “LOID002” embedded therein as a digital watermark, for example.

FIG. 29C illustrates an example of additional audio information 2833 stored in the audio information storage unit 2821. The additional audio information 2833 may store audio data including audio information on content, such as “The movie theater is on the 4th floor. Screening of ◯◯ starts from 10:00,” having a content ID such as “CID001” embedded therein as a digital watermark, for example. Note that a plurality of items of audio data each associated with a specific content ID may be stored in the additional audio information 2833, for example.

Referring back to FIG. 28, the other functional elements of the mounted apparatus 2701 are described below.

The request information receiving unit 2813 receives from the information terminal 107 that has acquired the identification information included in the guidance information provided by the audio information providing unit 2812, via the communication control unit 2811, request information including the identification information acquired by the information terminal 107 and the app ID of the information terminal 107. The request information receiving unit 2813 may be implemented by a program run on the CPU 701 of FIG. 27, for example.

The information providing unit 2814 provides information (e.g., navigation information, internal position information, content information as described below) associated with the identification information included in the request information received by the request information receiving unit 2813 to the information terminal 107 corresponding to the sender of the request information. The information providing unit 2814 may be implemented by a program run on the CPU 701 of FIG. 27, for example.

The position information acquiring unit 2815 acquires position information indicating the position of the ship on which the mounted apparatus 2701 is mounted using the GPS device 204 of FIG. 27, for example. The position information acquiring unit 2815 may be implemented by a program run on the CPU 701 of FIG. 27, for example.

The wireless communication unit 2816 establishes communication with the navigation management system 2801 using the wireless communication device 2702 of FIG. 27, for example. The wireless communication unit 2816 may be implemented by a program run on the CPU 701 of FIG. 27, for example.

The navigation information management unit 2817 stores and manages navigation information 2834 of the ship on which the mounted apparatus 2701 in the storage unit 2822. The navigation information management unit 2817 may be implemented by a program run on the CPU 701 of FIG. 27, for example. Note that the navigation information 2834 managed by the navigation information management unit 2817 may include, for example, the destination of the ship, ports of call, the expected arrival date/time, and the position information of the ship acquired by the position information acquiring unit 2815. The navigation information 2834 may further include information acquired by the wireless communication unit 2816 from the navigation management system 2801, such as navigation information of other ships and weather information, for example.

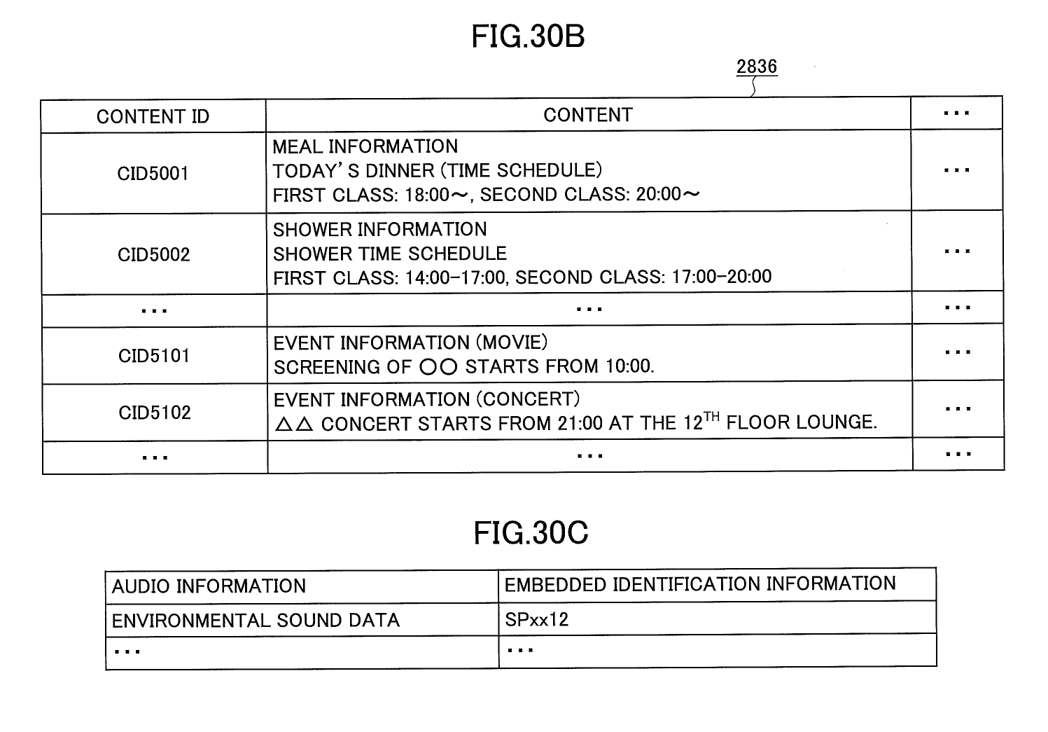

The internal position information management unit 2818 stores and manages internal position information 2835 relating to the installation position of the output device 2422 in the storage unit 2822. The internal position information management unit 2818 may be implemented by a program run on the CPU 701 of FIG. 27, for example. FIG. 30A illustrates an example configuration of the internal position information 2835 managed by the internal position information management unit 2818.

In the example of FIG. 30A, the internal position information 2835 includes information items, such as “internal position ID”, “position coordinates”, “position name”, and “additional information”, for example.

The “internal position ID” is identification information uniquely assigned to each output device 2422 that is installed in the ship and is included in audio information (hereinafter referred to as “position audio information”) that is output by the corresponding output device 2422 in addition to inboard broadcasts, for example.

The “position coordinates” is coordinate information indicating the position the output device 2422 within the ship corresponding to the internal position ID. In FIG. 30A, the “position coordinates” is represented by 3-dimensional coordinate information, including coordinate information in the x-direction, the y-direction as well as the height (h) direction (e.g., information indicating the floor).

The “position name” is text information indicating a name or a brief description of the position of the output device 2422 within the ship corresponding to the internal position ID. The “additional information” is additional information associated with the position of the output device 2422 within the ship corresponding to the internal position ID.

The content information management unit 2819 stores and manages content information 2836 that is provided by the information providing system 2800 in the storage unit 2822. The content information management unit 2819 may be implemented by a program run on the CPU 701 of FIG. 27, for example. FIG. 30B illustrates an example configuration of the content information 2836 managed by the content information management unit 2819.

In the example of FIG. 30B, the content information 2836 stores “content ID” corresponding to identification information identifying content in association with “content” describing the content itself. Note that FIG. 30B illustrates an example case where the content corresponds to text. However, the content may also include still images, video, audio, and/or link information, for example. Based on such content information 2836, the information providing unit 2814 may be able to provide to the information terminal 107, content associated with a content ID included in additional information acquired by the information terminal 107, for example.

The display/input unit 2820 controls the display device 206 of FIG. 27 to display a display screen of the mounted apparatus 2701 and accepts an operation on the input device 207 made by an operator of the mounted apparatus 2701. The display/input unit 2820 may be implemented by a program run on the CPU 701 of FIG. 27, for example.

The audio information storage unit 2821 stores in advance audio information, such as the common audio information 2831, the individual audio information 2832, and the additional audio information 2833 as described above, for example. The audio information storage unit 2821 may be implemented by the storage unit 704 and a program run on the CPU 701 of FIG. 27, for example.

The storage unit 2822 stores the navigation information 2834, the internal position information 2835, and the content information 2836 as described above, for example. The storage unit 2822 may be implemented by the storage unit 704 and a program run on the CPU 701 of FIG. 27, for example.

(Functional Configuration of Output Device)

The output device 2422 includes a position audio information storage unit 2841 and an audio output unit 2842. Preferably, the output device 2422 further includes a communication control unit 2843.

The position audio information storage unit 2841 stores in advance position audio information including the internal position ID that is uniquely assigned to the output device 2422. The position audio information storage unit 2841 may be implemented by the flash ROM 2603 and a program run on the CPU 2601 of FIG. 26, for example. FIG. 30C illustrates on example configuration of the position audio information stored in the position audio information storage unit 2841.

Note that the position audio information storage unit 2841 is preferably capable of storing position audio information that is received by the communication control unit 2843.

In the example of FIG. 30C, the position audio information stored in the position audio information storage unit 2841 stores audio data, such as environmental sound data, having an internal position ID such as “SPxx12” embedded therein. Note that environmental sound data is merely one example of audio data included in the position audio information. The audio data may also include music, audio messages, and the like.

The audio output unit 2842 converts an audio signal 2803 output by the mounted apparatus 2701 and audio information stored in the position audio information storage unit 2841 into audio using the output circuit 2606 and the speaker 2607 of FIG. 26, for example, and outputs the converted audio. The audio output unit 2842 may be implemented by a program run on the CPU 2601 of FIG. 26, for example.

The communication control unit 2843 connects the output device 2422 to the network 2802 using the communication I/F 2604 of FIG. 26, for example, to establish communication with the mounted apparatus 2701. The communication control unit 2843 may be implemented by a program run on the CPU 2601 of FIG. 26, for example.

(Functional Configuration of Information Terminal)

The information terminal 107 according to the present embodiment includes the communication control unit 921, the audio acquiring unit 922, the information extracting unit 923, the request information transmitting unit 924, the display control unit 925, the operation accepting unit 926, and the storage unit 929 that are substantially identical to the corresponding functional elements of the information terminal 107 of FIG. 9.

Note, however, that the storage unit 929 of the information terminal 107 according to the present embodiment stores map information 2851 including a map indicating the ship layout (e.g., see FIG. 24A) and a map indicating the route of the ship, for example. The map information 2851 may be provided by an app of the information providing system 2800 that is installed in the information terminal 107, for example. Note that the other functional elements of the information terminal 107 according to the present embodiment may be substantially identical to the corresponding functional elements of the information terminal 107 of FIG. 9, and as such, descriptions thereof are omitted.

<Process Flow>

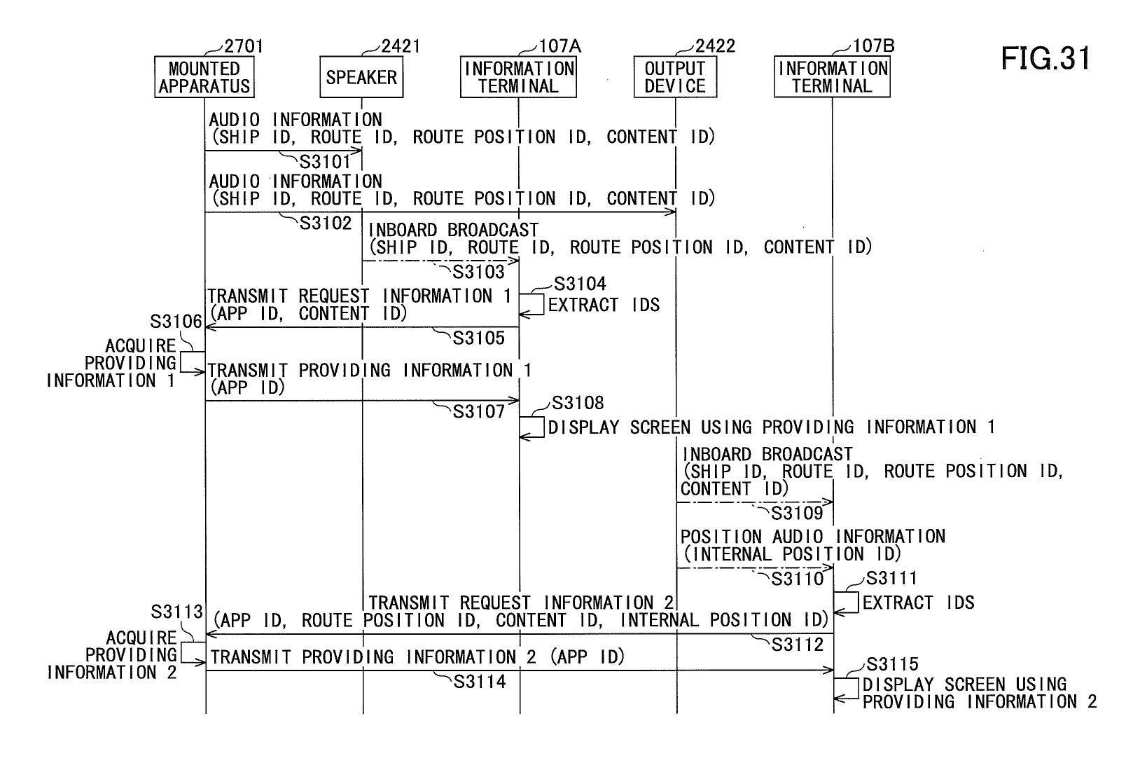

FIG. 31 is a sequence chart illustrating an example information providing process according to the fourth embodiment.

In step S3101, the audio information providing unit 2812 of the mounted apparatus 2701 outputs audio information (audio signal) including the common audio information, the individual audio information, and the additional audio information as illustrated in FIGS. 29A-29C, for example, to the plurality of speakers 2421 within the ship. The audio information output in step S3101 may include identification information, such as a ship ID identifying the ship, a route ID identifying the route of the ship, a route position ID identifying a position on the route, and one or more content IDs identifying specific content, for example. Note that in this step, the audio information providing unit 2812 outputs the individual audio information corresponding to the position information acquired by the position information acquiring unit 2815 of the mounted apparatus 2701, automatically or in response to an operation by the operator, for example.

In step S3102, the audio information providing unit 2812 of the mounted apparatus 2701 outputs audio information (audio signal) including the common audio information, the individual audio information, and the additional audio information as illustrated in FIGS. 29A-29C, for example, to the output device 2422. Note that in some embodiments, the audio information providing unit 2812 may be configured to provide the same audio information to the speakers 2421 and the output device 2422 at the same time in step S3101, for example.

In step S3103, the speaker 2421 converts the audio information (audio signal) from the mounted apparatus 2701 into audio and outputs the converted audio as an inboard broadcast.

In step S3104, the information extracting unit 923 of an information terminal 107A extracts identification information embedded as digital watermarks or the like in audio that has been acquired by the audio acquiring unit 922. For example, the information extracting unit 923 may extract the ship ID, the route ID, the route position ID, the content ID and the like that are included in the audio output by the speaker 2421 in step S3103.

In step S3105, the request information transmitting unit 924 of the information terminal 107A transmits, for example, request information 1 including an app ID identifying the information terminal 107A and the content ID extracted by the information extracting unit 923 to the mounted apparatus 2701. Note that the request information 1 may include one or more content ID, for example.

In step S3106, when the request information receiving unit 2813 of the mounted apparatus 2701 receives the request information from the information terminal 107A, the information providing unit 2814 acquires information (providing information 1) including content corresponding to the one or more content IDs included in the request information. For example, assuming the request information from the information terminal 107A includes the content ID “CID5101” of FIG. 30B, the information providing unit 2814 acquires the corresponding content (text) “Event information (movie): Screening of ◯◯ starts from 10:00” that is associated with the above content ID.

In step S3107, the information providing unit 2814 of the mounted apparatus 2701 transmits the providing information acquired in step S3106 to the information terminal 107A corresponding to the sender of the request information 1.

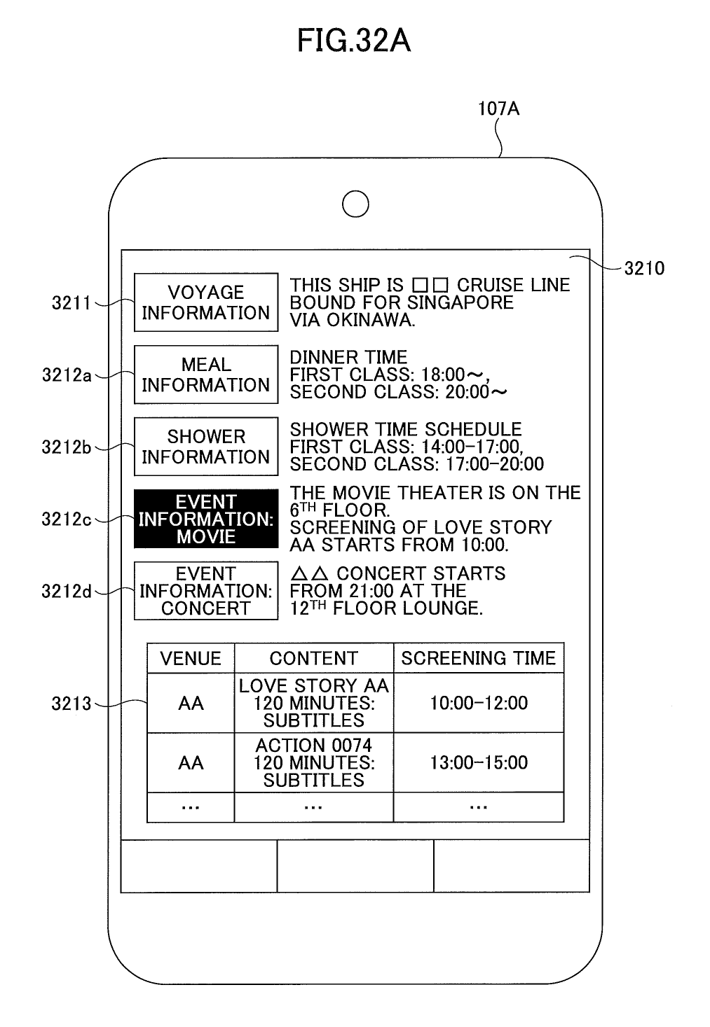

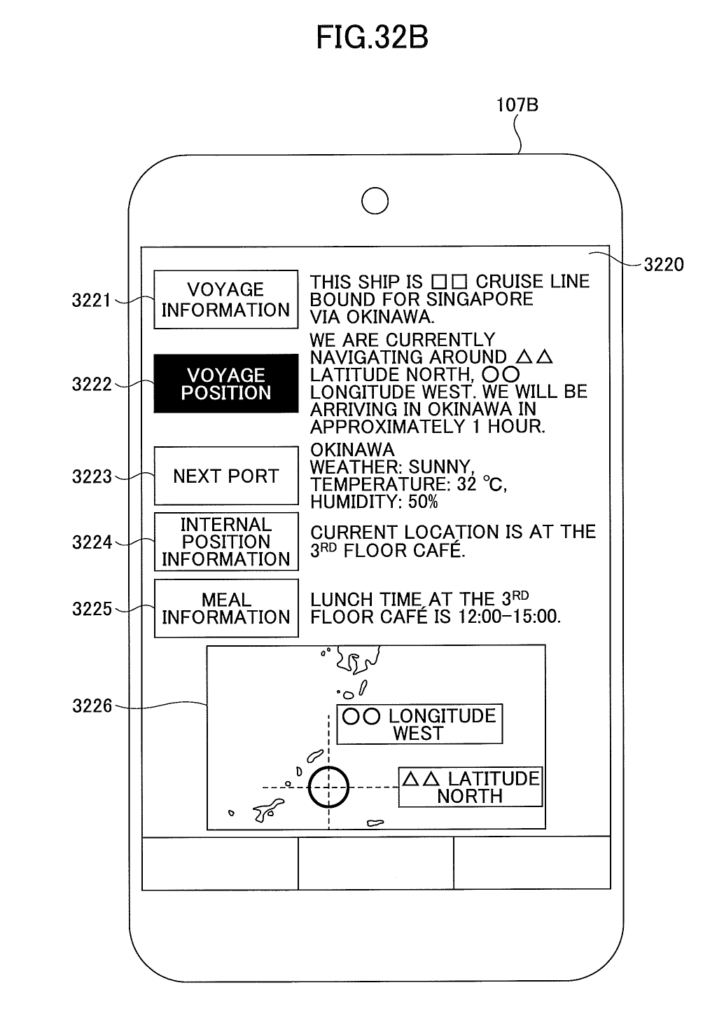

In step S3108, the display control unit 925 of the information terminal 107A uses the providing information 1 received from the mounted apparatus 2701 to control the display/input unit 806 to display a display screen as illustrated in FIG. 32A, for example.

FIG. 32A illustrates an example display screen 3210 of the information terminal 107A according to the present embodiment. In the example of FIG. 32A, the display screen 3210 of the information terminal 107A displays voyage information 3211 and a plurality of items of content information 3212a-3212d.

The voyage information 3211 may be displayed based on information included in the app of the information providing system 2800 and identification information, such as the navigation ID and the navigation route ID, extracted in step S3104 of FIG. 31, for example. Note that in some embodiments, the voyage information 3211 may be provided by the mounted apparatus 2701 based on the ship ID, the route ID, the route position ID, and the content ID included in the request information, for example.

The plurality of items of content information 3212a-3212d may be displayed by the display control unit 925 of the information terminal 107A based on content (e.g., text data) included in the providing information 1 acquired in step S3107 of FIG. 31, for example.

In a preferred example, when the user of the information terminal 107A selects one item of content information from among the plurality of items of content information 3212a-3212d, such as the content information “Event Information: Movies” 3212c, further detailed information relating to the selected content may be displayed. For example, the request information transmitting unit 924 of the information terminal 107A may transmit request information including a content ID of the content information “Event Information: Movies” 3212c to the mounted apparatus 2701 and display detailed information 3213 provided by the mounted apparatus 2701.

Referring back to FIG. 31, further process steps of the information providing process will be described.

In step S3109, the audio output unit 2842 of the output device 2422 converts audio information (audio signal) output by the mounted apparatus 2701 in step S3102 into audio and outputs the resulting audio as an inboard broadcast. Note that this process step may be executed in parallel with the process of step S3103, for example.

In step S3110, the audio output unit 2842 of the output device 2422 converts the position audio information stored in the position audio information storage unit 2841 into audio and outputs the resulting audio. Note that the position audio information includes the internal position ID corresponding to the installation position of the output device 2422 within the ship.

In step S3111, the information extracting unit 923 of an information terminal 107B extracts the identification information embedded as digital watermarks in the audio acquired by the audio acquiring unit 922 and the internal position ID included in the position audio information acquired by the audio acquiring unit 922, for example.

In step S3112, the request information transmitting unit 924 of the information terminal 107B transmits to the mounted apparatus 2701, request information 2 including the app ID identifying the information terminal 107B, the route position ID, the content ID, and the internal position ID as another example of request information.

In step S3113, when the request information receiving unit 2813 of the mounted apparatus 2701 receives the request information from the information terminal 107B, the information providing unit 2814 acquires information (providing information 2) associated with the route position ID, the content ID, and the internal position ID included in the received request information. For example, the information providing unit 2814 may acquire navigation information associated with the route position ID from the navigation information management unit 2817 and acquire content information associated with the content ID from the content information management unit 2819. Also, the information providing unit 2814 may acquire internal position information associated with the internal position ID from the internal position information management unit 2818.

In step S3114, the information providing unit 2814 of the mounted apparatus 2701 transmits the providing information 2 acquired in step S3113 to the information terminal 107B corresponding to the sender of the request information 2.

In step S3115, the display control unit 925 of the information terminal 107B controls the display/input unit 806 to display a display screen as illustrated in FIG. 32B, for example, using the providing information 2 received from the mounted apparatus 2701.

FIG. 32B illustrates an example display screen 3220 of the information terminal 107B according to the present embodiment. In the example of FIG. 32B, the display screen 3220 of the information terminal 107B displays voyage information 3221, a voyage position 3222, a next port 3223, internal position information 3224, and meal information 3225.

The voyage information 3211 may be displayed on the display screen 3220 by the display control unit 925 of the information terminal 107B based on information included in the app of the information providing system 2800 and navigation information included in the providing information 2 received from the mounted apparatus 2701, for example.

The voyage position 3222 may be displayed on the display screen 3220 by the display control unit 925 of the information terminal 107B based on the navigation information included in the providing information 2 received from the mounted apparatus 2701, for example.

The next port 3223 may be displayed on the display screen 3220 by the display control unit 925 of the information terminal 107B based on the navigation information and the content information included in the providing information 2 received from the mounted apparatus 2701, for example.

The internal position information 3224 may be displayed on the display screen 3220 by the display control unit 925 of the information terminal 107A based on the internal position information included in the providing information 2 received from the mounted apparatus 2701, for example.

The meal information 3225 may be displayed on the display screen 3220 by the display control unit 925 of the information terminal 107B based on the internal position information and the content information included in the providing information 2 received from the mounted apparatus 2701, for example.

In a preferred example, when the user of the information terminal 107B selects one of the plurality of information items as described above, such as the “voyage position” 3222, further detailed information, such as detailed voyage position information 3226, may be displayed on the display screen 3220. For example, the request information transmitting unit 924 of the information terminal 107B may transmit request information including the content ID of the “voyage position” 3222 to the mounted apparatus 2701 and display the detailed voyage position information 3226 that is provided by the mounted apparatus 2701. The detailed voyage position information 3226 may include information indicating the positions of other ships acquired by the navigation management system 2801, for example.

As another preferred example, when the user of the information terminal 107B selects the “internal position information” 3224 from the above information items, detailed internal position information may be displayed. For example, the display control unit 925 of the information terminal 107B may display the ship layout as illustrated in FIG. 24A using the map information 2851 stored in the storage unit 929 and display a display component indicating a current position on the ship layout based on the internal position information.

As described above, the information providing system 2800 according to the present embodiment is capable of providing detailed information associated with the navigation status of a transport vehicle, such as a ship, to a user (passenger) to thereby improve convenience for the user, for example. Further, according to the present embodiment, the output device 2422 that outputs internal position information indicating its corresponding installation position within the ship may be used to provide the user of the information terminal 107 with the internal position information 3224 indicating a current position within the ship, for example.

### Fifth Embodiment

In the following, an information providing system 3300 according to a fifth embodiment of the present invention is described. The information providing system 3300 according to the fifth embodiment includes an aircraft as another example of a transport vehicle. Note that some features of the present embodiment may be substantially identical to those of the fourth embodiment, and as such, the following descriptions focus on features of the fifth embodiment that differ from those of the fourth embodiment.

<Functional Configuration>

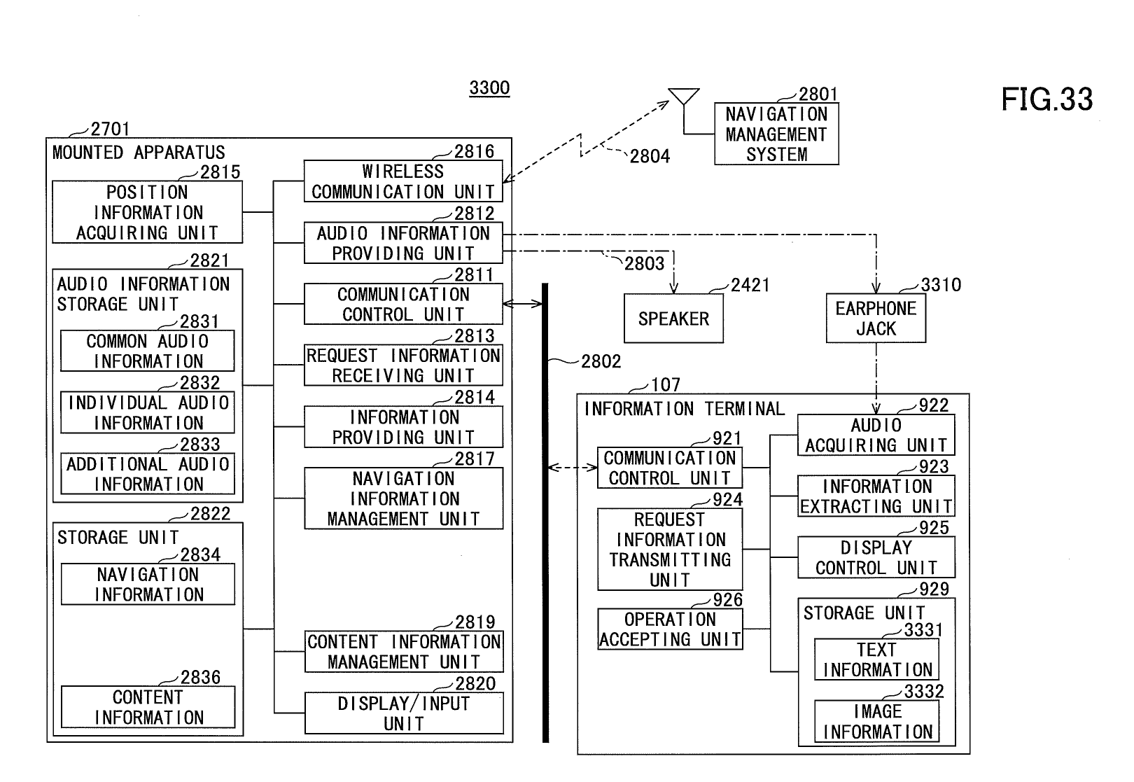

FIG. 33 is a block diagram illustrating an example functional configuration of the information providing system 3300 according to the fifth embodiment. The information providing system 3300 according to the present embodiment differs from the information providing system 2800 according to the fourth embodiment as illustrated in FIG. 28 in that it does not include the output device 2422, the internal position information management unit 2818, and the internal position information 2835. This is because users (passengers) of an aircraft, such as a passenger aircraft, are often in their seats, and the internal space of an aircraft is not as large as that of a ship. Thus, it may be presumed that internal position information within an aircraft would not be as important as that within a ship.

Also, note that in the present embodiment, not only the speakers 2421 but earphone jacks 3310 provided at the seats of the aircraft may be used to provide audio information. In this way, the information providing system 3300 according to the present embodiment may be able to provide differing audio information with respect to seats of differing classes, such as first class seats, business class seats, and economy class seats, for example. Similarly, the information providing system 3300 according to the present embodiment may provide differing audio information with respect to differing seat positions, such as window side seats, aisle side seats, front row seats, and back row seats, for example.

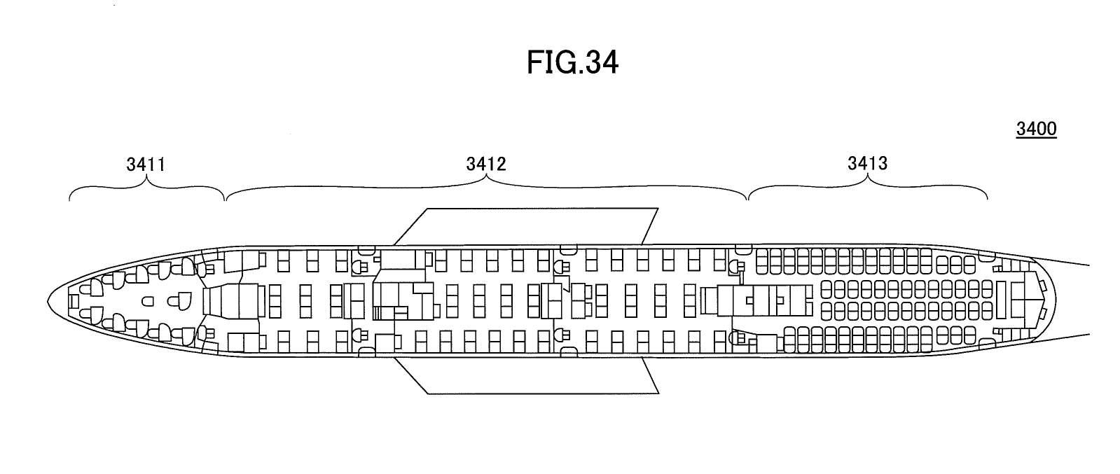

FIG. 34 is a diagram illustrating an example seat layout 3400 of an aircraft according to the present embodiment. In FIG. 34, the aircraft includes a plurality of seats of differing classes, including first class seats 3411, business class seats 3412, and economy class seats 3413. In the present embodiment, the information providing system 3300 may be able to provide differing audio information to the first class seats 3411, the business class seats 3412, and the economy class seats 3413 via the speakers 2421 and the earphone jacks 3310, for example.

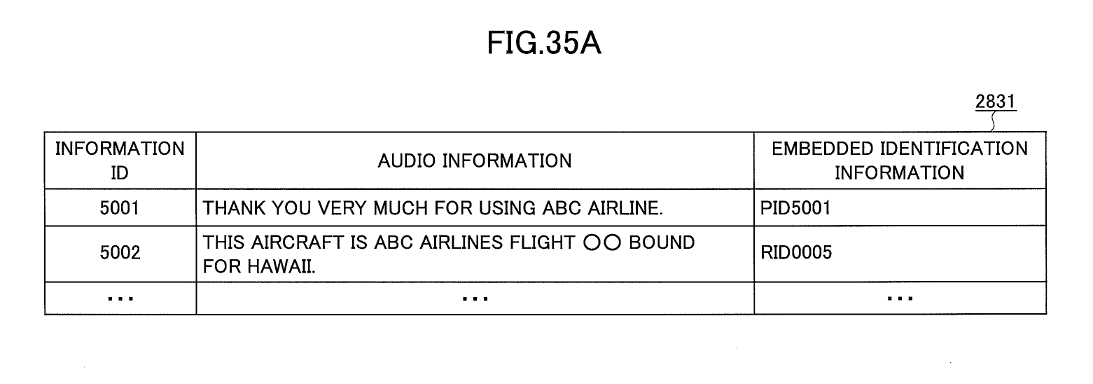

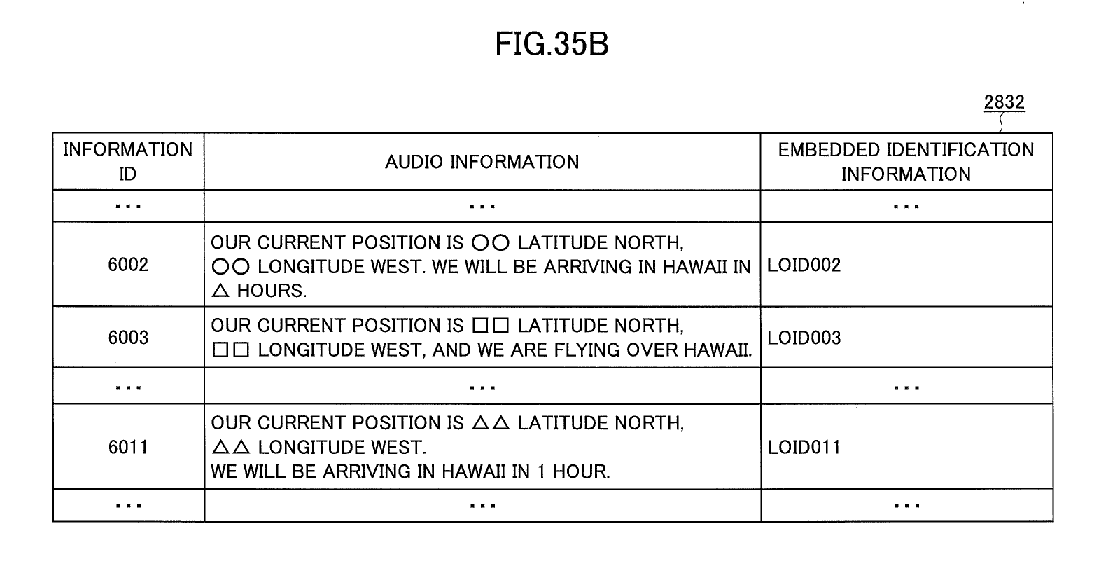

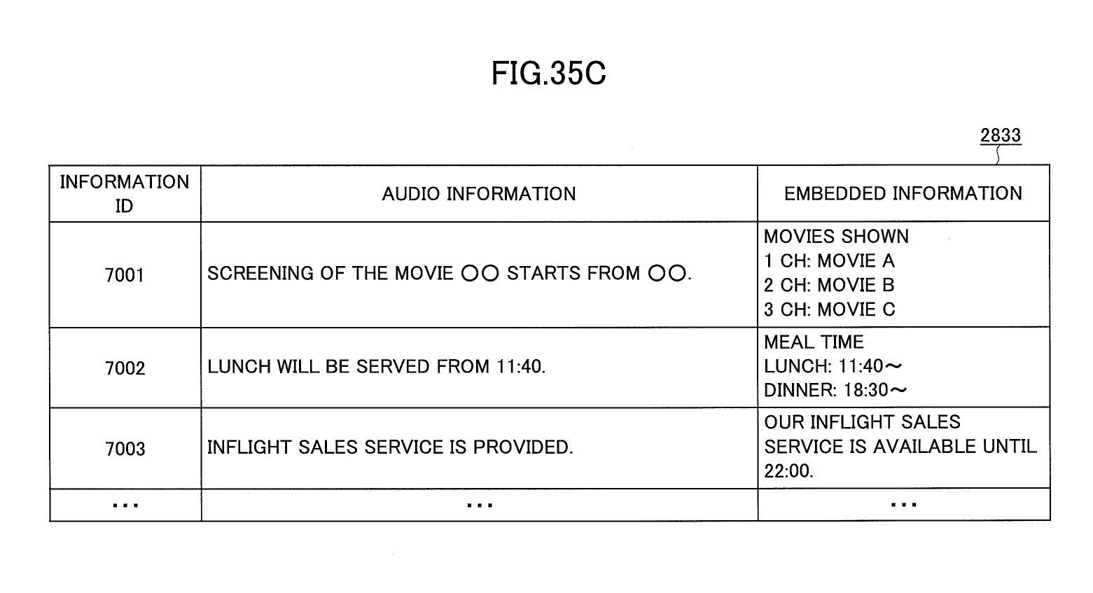

The audio information storage unit 2821 of the mounted apparatus 2701 according to the present embodiment may store audio information as illustrated in FIGS. 35A-35C, for example.

FIG. 35A illustrates an example of the common audio information 2831 stored in the audio information storage unit 2821 according to the present embodiment. The common audio information 2831 of FIG. 31A has a configuration similar to that of the common audio information 2831 according to the fourth embodiment as illustrated in FIG. 29A but stores audio signals (audio information) representing different messages from those of the common audio information 2831 of FIG. 29A.

FIG. 35B illustrates an example of the individual audio information 2832 stored in the audio information storage unit 2821 according to the present embodiment. The individual audio information 2832 of FIG. 35B has a configuration similar to that of the individual audio information 2832 according to the fourth embodiment as illustrated in FIG. 29B but stores audio signals (audio information) representing different messages from those of the individual audio information 2821 of FIG. 29B.

FIG. 35C illustrates an example of the additional audio information 2833 stored in the audio information storage unit 2821 according to the present embodiment. Note that the additional audio information 2833 of FIG. 35C has text information, such as a message, embedded therein rather than identification information, such as a content ID, as in the additional audio information 2833 according to the fourth embodiment illustrated in FIG. 29C. The additional audio information 2833 according to the present embodiment preferably has such a configuration in view of the fact that use of a wireless device within an aircraft may be restricted during takeoff, landing, flight, or the like, such that the information terminal 107 may not be able to acquire relevant information from the mounted apparatus 2701 using a content ID, for example. Thus, in the present embodiment, text information representing a message may be embedded in the audio information provided by the mounted apparatus 2701 instead of identification information, such as a content ID. In this way, the information providing system 3300 may be able to cause the information terminal 107 to display information that differs from the information included in the app installed in the information terminal 107, for example.

Note that in other examples, the additional audio information 2833 according to the present embodiment may have a content ID embedded therein in a manner similar to the additional audio information 2833 according to the fourth embodiment as illustrated in FIG. 29C, for example. In this case, the information terminal 107 may acquire content information associated with the content ID from the mounted apparatus 2701 in a manner similar to the fourth embodiment when wireless communication is allowed within the aircraft, for example.

Also, the storage unit 929 of the information terminal 107 according to the present embodiment may have text information 3331 and image information 3332 stored in advance, for example. In this way, the information terminal 107 may be able to display an image (e.g., map information, catalog information) corresponding to the content ID included in additional audio information acquired by the audio acquiring unit 922, for example. In this case, the text information 3331 and the image information 3332 stored in the storage unit 929 of the information terminal 107 may be provided by an app installed in the information terminal 107 for implementing the information providing system 3300 according to the present embodiment, for example.

The mounted apparatus 2701 according to the present embodiment may be configured to embed a class ID for identifying the corresponding class of a seat in the audio information to be provided to the earphone jack 3310, for example. In this way, differing content information, such as inflight shopping catalog information, may be provided based on the seat class represented by the class ID, for example.

<Process Flow>

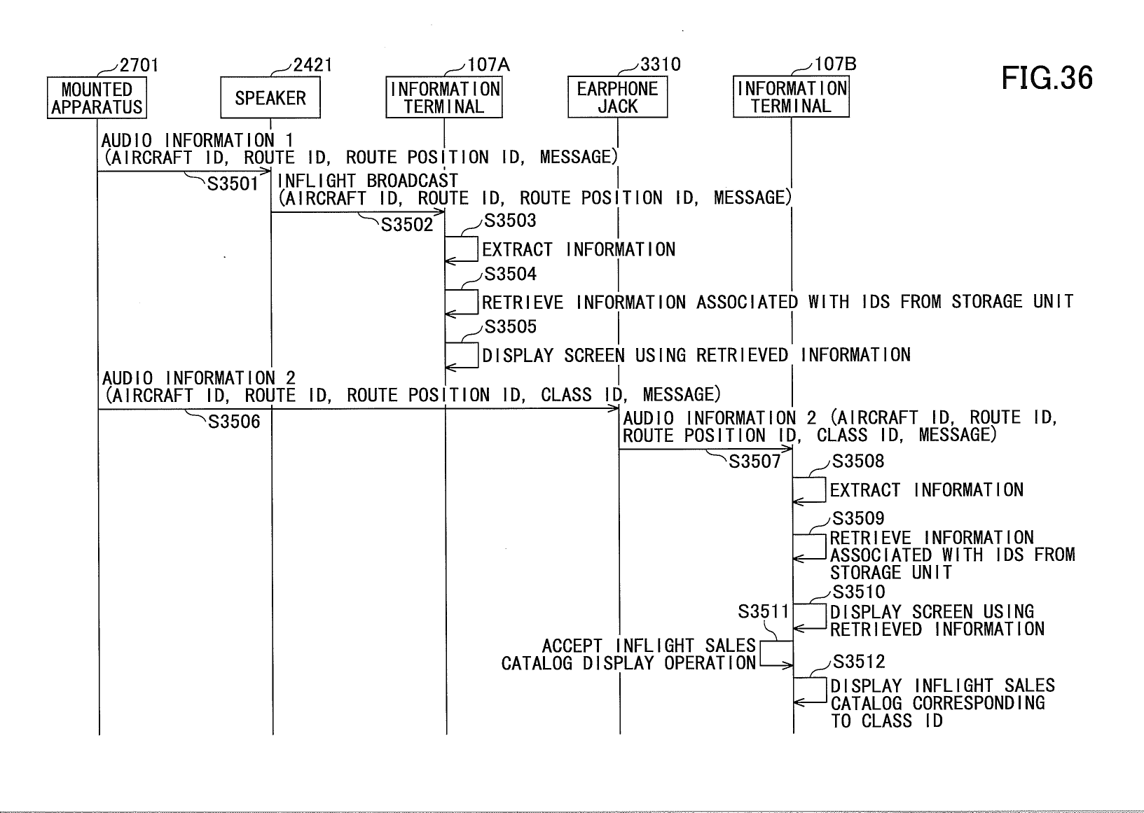

FIG. 36 is a sequence chart illustrating an example information providing process according to the fifth embodiment.

In step S3501, the audio information providing unit 2812 of the mounted apparatus 2701 outputs audio information (audio signal) 1 including the common audio information, the individual audio information, and the additional audio information as illustrated in FIGS. 35A-35C, for example, to the speaker 2421.

The audio information 1 may include an aircraft ID identifying the aircraft, a route ID identifying the route of the aircraft, a route position ID identifying a route position, for example. The audio information 1 preferably includes content information such as a message (e.g., text) that is embedded in the additional audio information as illustrated in FIG. 35C.

As described above, the audio information 1 may alternatively include a content ID instead of a message as information that is embedded in the additional audio information, for example. In this case, for example, the information providing system 3300 may implement the information providing process according to the fourth embodiment as illustrated in FIG. 31, for example. In the following, an example information providing process that may be implemented in a case where wireless communication within the aircraft is not allowed is described.

In step S3502, the speaker 2421 converts audio information (audio signal) output by the mounted apparatus 2701 into audio and outputs the resulting audio as an inflight broadcast.

In step S3503, the information extracting unit 923 of the information terminal 107A extracts information (e.g., aircraft ID, route ID, route position ID, and message) embedded in the audio acquired by the audio acquiring unit 922.

In step S3504, the display control unit 925 of the information terminal 107A acquires (reads) information associated with each of the IDs extracted in step S3503 (e.g., aircraft ID, route ID, route location ID) from the text information 3331 and the image information 3332 stored in the storage unit 929.

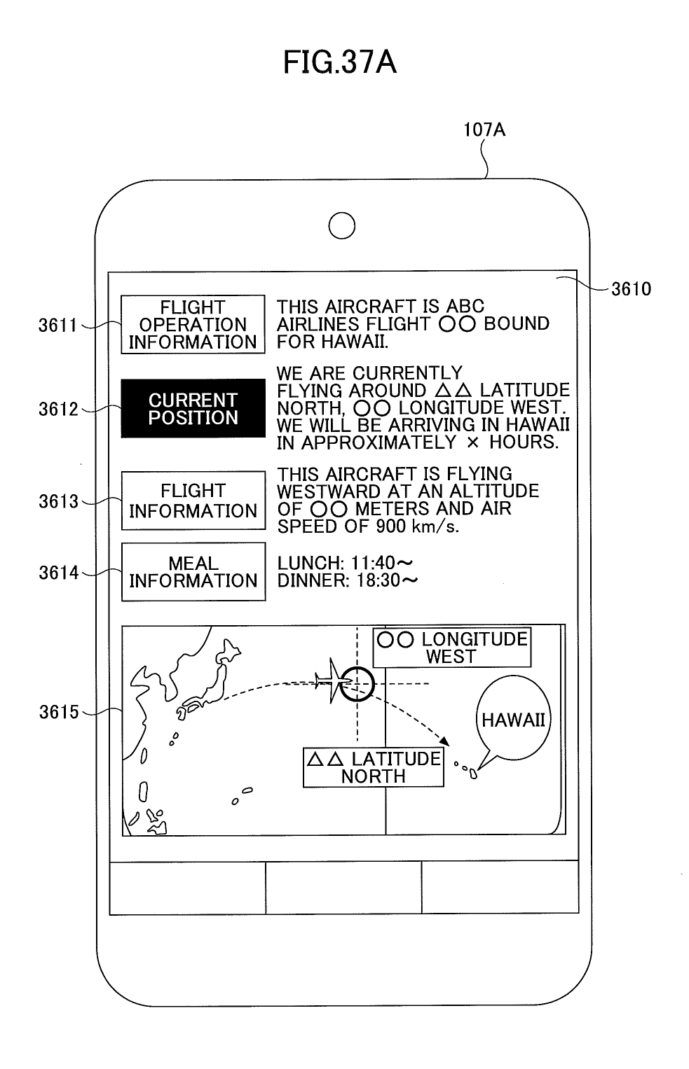

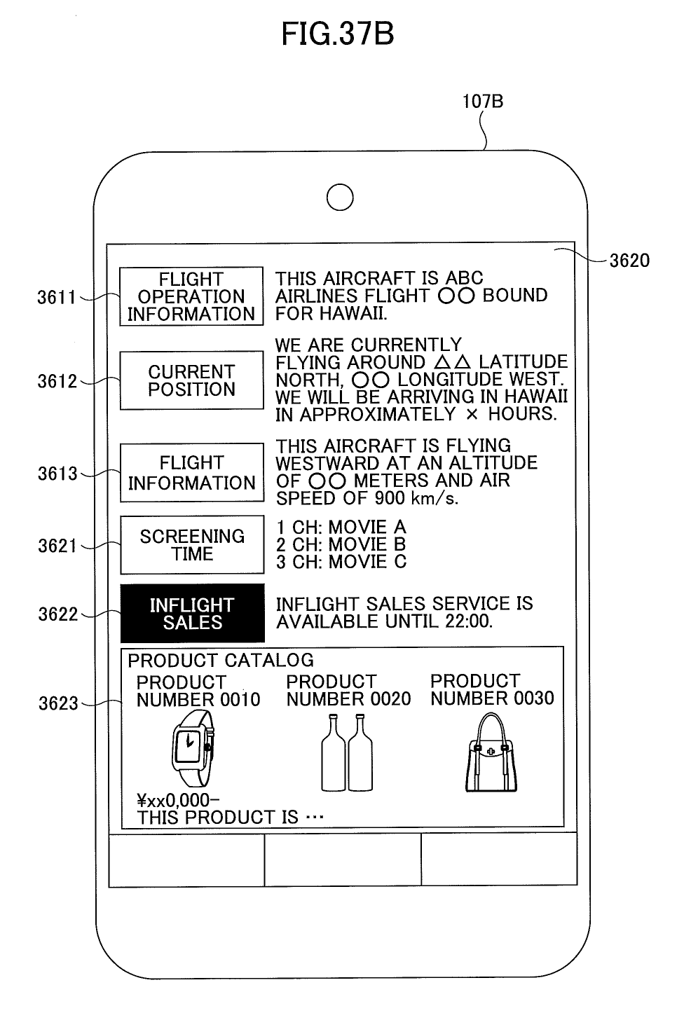

In step S3505, the display control unit 925 of the information terminal 107A uses the information acquired in step S3504 to display a corresponding display screen. For example, the display control unit 925 of the information terminal 107A may use the information acquired in step S3504 and the message extracted in step S3503 to control the display/input unit 806 to display a display screen as illustrated in FIG. 37A, for example.

FIG. 37A illustrates an example display screen 3610 that may be displayed by the information terminal 107A according to the present embodiment. In the example of FIG. 37A, the display screen 3610 of the information terminal 107A displays information items, such as flight operation information 3611, a current location 3612, flight information 3613, and meal information 3614.

The flight operation information 3611 may be displayed on the display screen 3610 by the display control unit 925 based on text information associated with the extracted aircraft ID and the extracted route ID, for example, that is acquired by the display control unit 925 from the text information 3331 that is stored in the storage unit 929 by the app of the information providing system 3300, for example.

The current position 3612 may be displayed on the display screen 3610 by the display control unit 925 based on text information associated with the extracted route position ID, for example, that is acquired by the display control unit 925 from the text information 3331 that is stored in the storage unit 929 by the app of the information providing system 3300, for example.

The flight information 3613 may be displayed on the display screen 3610 by the display control unit 925 based on text information associated with the extracted route position ID, for example, that is acquired by the display control unit 925 from the text information 3331 that is stored in the storage unit 929 by the app of the information providing system 3300, for example. Alternatively, the flight information 3613 may be displayed on the display screen 3610 by the display control unit 925 using the message extracted from the additional audio information in step S3503, for example.

The meal information 3614 is an example of content information and may be displayed on the display screen 3610 by the display control unit 925 using the message extracted from the additional audio information in step S3503, for example.

In a preferred example, when the user of the information terminal 107A selects one of the plurality of information items displayed on the display screen 3610, such as the current position 3612, further detailed information such as detailed current position information 3615 may be be displayed on the screen 3610. For example, the display control unit 925 of the information terminal 107A may acquire a map image as illustrated in FIG. 37A from the image information 3332 stored in the storage unit 929 and display information (e.g., latitude, longitude, icon, circle mark) indicating the current position on the acquired map image.

Referring back to FIG. 36, further process steps of the information providing process are described.

In step S3506, the audio information providing unit 2812 of the mounted apparatus 2701 outputs audio information (audio signal) 2 including the common audio information, the individual audio information, and the additional audio information as illustrated in FIGS. 35A-35C, for example, to the earphone jack 3310.

Like the audio information 1, the audio information 2 may include the aircraft ID, the route ID, and the route position ID, for example. The audio information 2 also preferably includes content information such as a message (e.g., text) that is embedded in the additional audio information as illustrated in FIG. 35C. Further the audio information 2 preferably includes a class ID identifying a seat class (e.g., first class, business class, economy class), for example.

In step S3507, the audio acquiring unit 922 of the information terminal 107B that is connected to the earphone jack 3310 acquires the audio information (audio signal) 2 that is output by the earphone jack 3310.

In step S3508, the information extracting unit 923 of the information terminal 107B extracts information (e.g., aircraft ID, route ID, route position ID, message, class ID) embedded in the audio information 2 that has been acquired by the audio acquiring unit 922.

In step S3509, the display control unit 925 of the information terminal 107B acquires (reads) information associated with each of the IDs (e.g., aircraft ID, route ID, route location ID) extracted in step S3508 from the text information 3331 and the image information 3332 stored in the storage unit 929.

In step S3510, the display control unit 925 of the information terminal 107B uses the information acquired in step S3509 to display a corresponding display screen. For example, the display control unit 925 of the information terminal 107B may use the information acquired in step S3509 and the message extracted in step S3508 to control the display/input unit 806 to display the display screen as illustrated in FIG. 37B, for example.

FIG. 37B illustrates an example display screen 3620 that may be displayed on the information terminal 107B according to the present embodiment. In the example of FIG. 37B, the display screen 3620 of the information terminal 107B displays information items, such as the flight operation information 3611, the current location 3612, the flight information 3613, screening time 3621, and inflight sales 3622.

Note that the flight operation information 3611, the current position 3612, and the flight information 3613 may be displayed on the display screen 3620 by the display control unit 925 of the information terminal 107B in a manner similar to that for displaying the above information on the display screen 3610 of FIG. 37A, for example.

The screening time 3621 is an example of content information and may be displayed on the display screen 3620 by the display control unit 925 using the message extracted from the additional audio information in step S3503, for example.

The inflight sales 3622 is another example of content information and may be displayed on the display screen 3620 by the display control unit 925 using the message extracted from the additional audio information in step S3503, for example.

In a preferred example, when the user of the information terminal 107B selects one of the plurality of information items displayed on the display screen 3620, such as the flight sales 3622, further detailed information such as a product catalog 3623 may be displayed on the display screen 3620. For example, the display control unit 925 of the information terminal 107B may acquire from the image information 3332 stored in the storage unit 929, image information of a product catalog associated with the class ID extracted in step S3508 and display the acquired image information (product catalog) on the display screen 3610.

As described above, in the information providing system 3300 according to the present embodiment, audio information including a class ID identifying the class of a seat may be provided by the earphone jack 3310 installed in the seat of an aircraft, and in this way, information corresponding to the class of the seat may be provided to the user (passenger).

Note that the information providing process of FIG. 36 is one example information providing process that may be implemented when wireless communication cannot be used within the aircraft. In some embodiments, the mounted apparatus 2701 of the information providing system 3300 may have a configuration similar to that of the mounted apparatus 2701 according to the fourth embodiment as illustrated in FIG. 28, for example. That is, the mounted apparatus 2701 of the information providing system 3300 may be configured to provide information associated with the flight operation status of the aircraft and relevant content information in response to receiving request information from the information terminal 107, for example.

As described above, according to an aspect of the present embodiment, detailed information associated with the transport status (operation status) of a transport vehicle, such as an aircraft, may be provided to the user of the transport vehicle to thereby improve convenience for the user.

### Sixth Embodiment

In the following, an information providing system 3700 according to a sixth embodiment of the present invention is described. The information providing system 3700 according to the sixth embodiment includes a train as another example of a transport vehicle. Note that many features of the sixth embodiment may be substantially identical to those of the first embodiment, and as such the following descriptions focus mainly on features of the sixth embodiment that differ from those of the first embodiment.

<System Configuration>

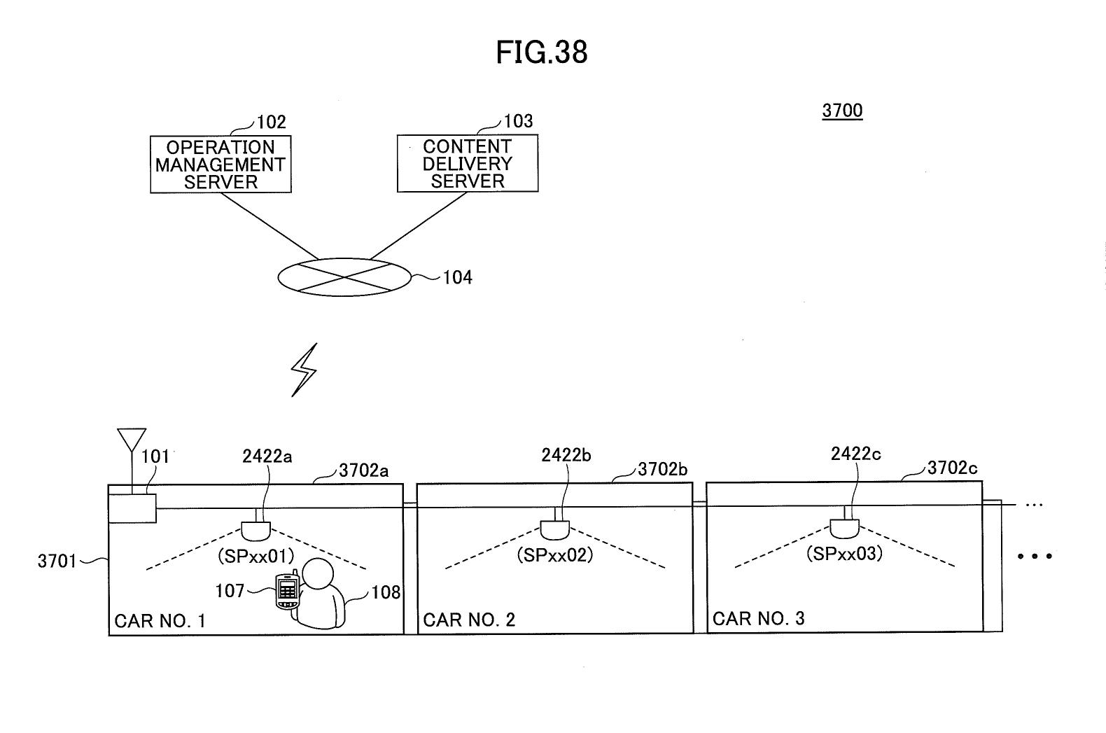

FIG. 38 is a diagram illustrating an example configuration of the information providing system 3700 according to the sixth embodiment. The information providing system 3700 according to the present embodiment may include devices similar to those included in the information providing system 100 according to the first embodiment as illustrated in FIG. 1, such as the vehicle-mounted system 101, the operation management server 102, the content delivery server 103, and the information terminal 107.

In the present embodiment, the vehicle-mounted system 101 is installed in a train 3701 including a plurality of cars 3702a-3702c, and audio information having relevant information embedded therein is output as in-vehicle broadcasts using a plurality of output devices 2422a-2422c (generically referred to as “output device 2422” hereinafter) that are respectively provided in the cars 3702a-3702c, for example.

Note that the output device 2422 used in the present embodiment may have substantially the same configuration as the output device 2422 according to the fourth embodiment as illustrated in FIG. 26, for example. The output device 2422 is configured to output an in-vehicle broadcast using audio information output by the vehicle-mounted apparatus 201 of the vehicle-mounted system 101 and also output position audio information including identification information (internal position ID) for identifying the output device 2422 or the car in which the output device 2422 is installed.

With the above configuration, the information terminal 107 carried by the user 108 may be able to acquire and use the identification information embedded in the in-vehicle broadcast and the internal position ID embedded in the position audio information that are output by the output unit 2422 to display relevant information, such as operation information of the train 3701 and a position within the train, for example.

<Functional Configuration>

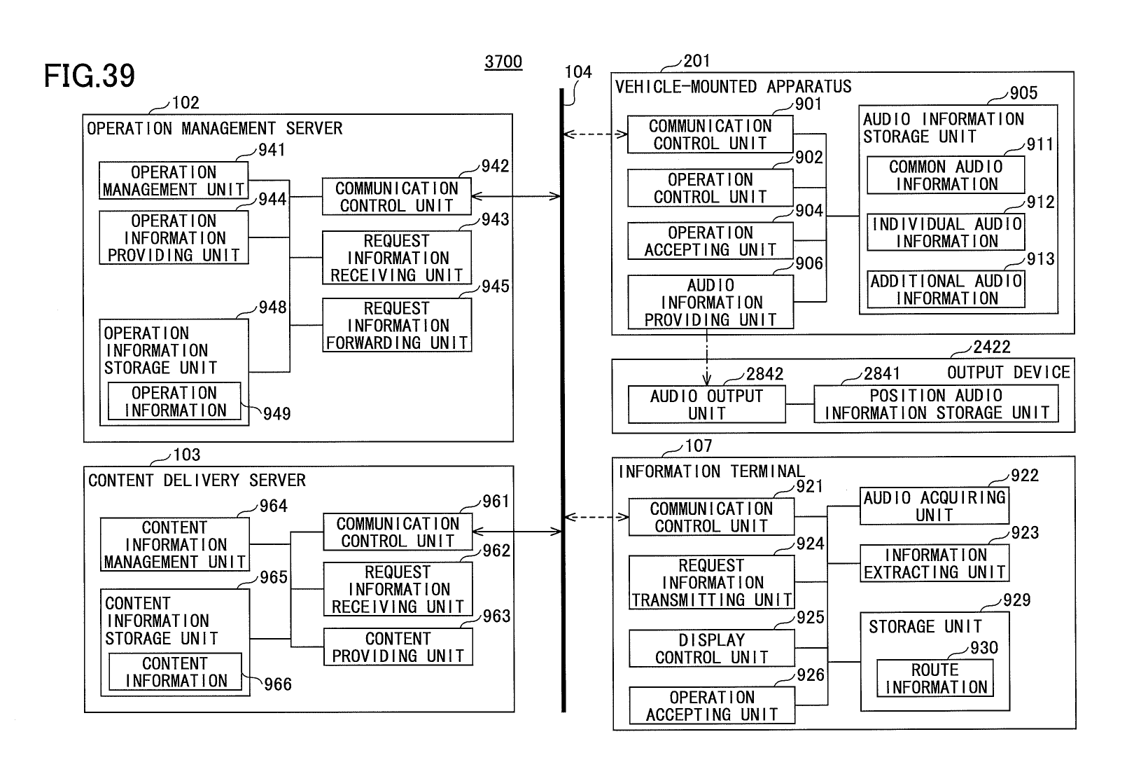

FIG. 39 is a block diagram illustrating an example functional configuration of the information providing system 3700 according to the sixth embodiment. The information providing system 3700 according to the present embodiment differs from the information providing system 100 according to the first embodiment as illustrated in FIG. 9 in that is does not include the stop information providing unit 947, the stop information receiving unit 946, the stop information transmitting unit 927, and the operation information display unit 903, for example. This is because the train 3701 stops at each pre-designated train station, and as such, an attendant/operator of the train 3701 does not have to determine whether there are passengers getting off at each train station.

Also, in the present embodiment, audio information provided by the vehicle-mounted apparatus 201 is output by the output device 2422 that is installed in each car of the train 3701. The audio output unit 2842 of the output device 2422 outputs audio based on audio information (audio signal) output by the vehicle-mounted apparatus 201 and also outputs audio based on position audio information stored in the position audio information storage unit 2841.

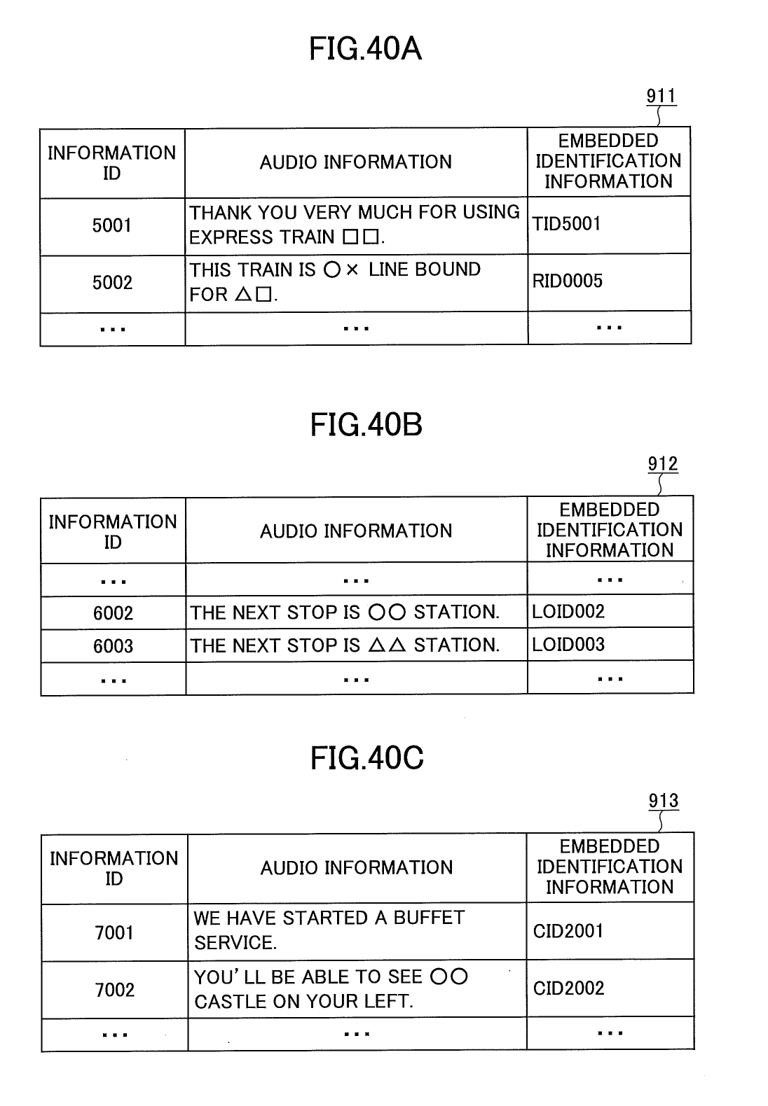

The audio information storage unit 905 of the vehicle-mounted apparatus 201 according to the present embodiment may store audio information as illustrated in FIGS. 40A-40C, for example.

FIG. 40A illustrates an example of the common audio information 911 stored in the audio information storage unit 905 according to the present embodiment. The common audio information 911 of FIG. 40A has a configuration similar to that of the common audio information 911 according to the first embodiment as illustrated in FIG. 10A but stores audio signals (audio information) representing differing messages from those of the common audio information 911 of FIG. 10A.

FIG. 40B illustrates an example of the individual audio information 912 stored in the audio information storage unit 905 according to the present embodiment. The individual audio information 912 of FIG. 40B has a configuration similar to that of the individual audio information 912 according to the first embodiment as illustrated in FIG. 10B but stores audio signals (audio information) representing differing messages from those of the individual audio information 911 of FIG. 10B.

FIG. 40C illustrates an example of the additional audio information 913 stored in the audio information storage unit 905 according to the present embodiment. The additional audio information 913 of FIG. 40B has a configuration similar to that of the additional audio information 913 according to the first embodiment as illustrated in FIG. 100 but stores audio signals (audio information) representing differing messages from those of the additional audio information 913 of FIG. 100.

Note that the operation management server 102 of FIG. 39 is configured to manage operation information of a plurality of trains including the train 3701. Also, note that in some embodiments, the information providing system 3700 may have a functional configuration substantially identical to that of the information providing system 100 according to the first embodiment as illustrated in FIG. 9, for example

<Process Flow>

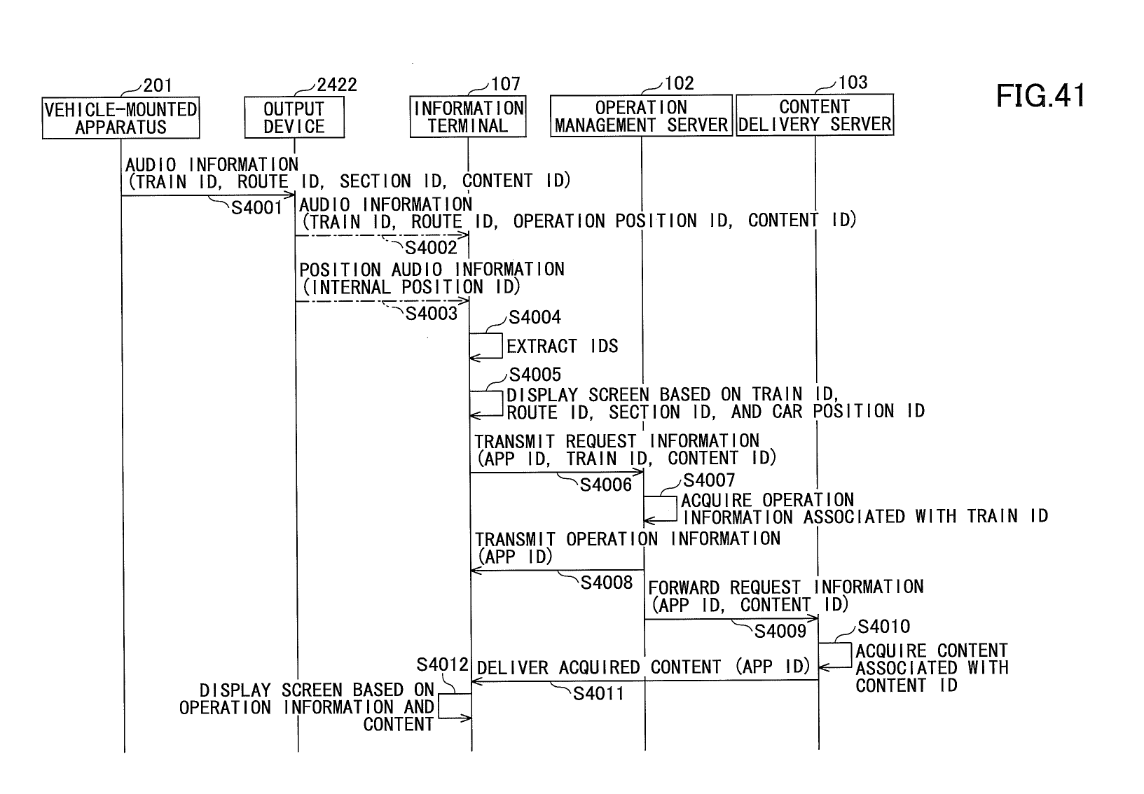

FIG. 41 is a sequence chart illustrating an example information providing process according to the sixth embodiment.

In step S4001, the audio information providing unit 906 of the vehicle-mounted apparatus 201 may output audio information (audio signal) including the common audio information, the individual audio information, and the additional audio information as illustrated in FIGS. 39A-39C, for example, to the output device 2422 installed in each car of the train 3701. The audio information output in step S4001 may include a train ID identifying the train 3701, a route ID identifying the route of the train 3701, section ID identifying a section being traveled, and a content ID identifying content, for example. Note that in this step, the audio information providing unit 2812 outputs the individual audio information including the section ID that identifies the specific section that is being traveled by the train 3701, automatically or in response to an operation made by an attendant/operator of the train 3701, for example.

In step S4002, an audio output unit 2842 of the output device 2422 converts the audio information (audio signal) output by the vehicle-mounted apparatus 201 into audio and outputs the resulting audio as an in-vehicle broadcast.

In step S4003, the audio output unit 2842 of the output device 2422 converts the position audio information stored in the position audio information storage unit 2841 into audio and outputs the resulting audio. The position audio information output by the output device 2422 may include an internal position ID for identifying the vehicle (position) in which the output device 2422 is installed, for example.

In step S4004, the information extracting unit 923 of the information terminal 107 extracts the internal position ID embedded in the position audio information and the identification information (IDs) embedded in the audio that have been acquired by the audio acquiring unit 922.

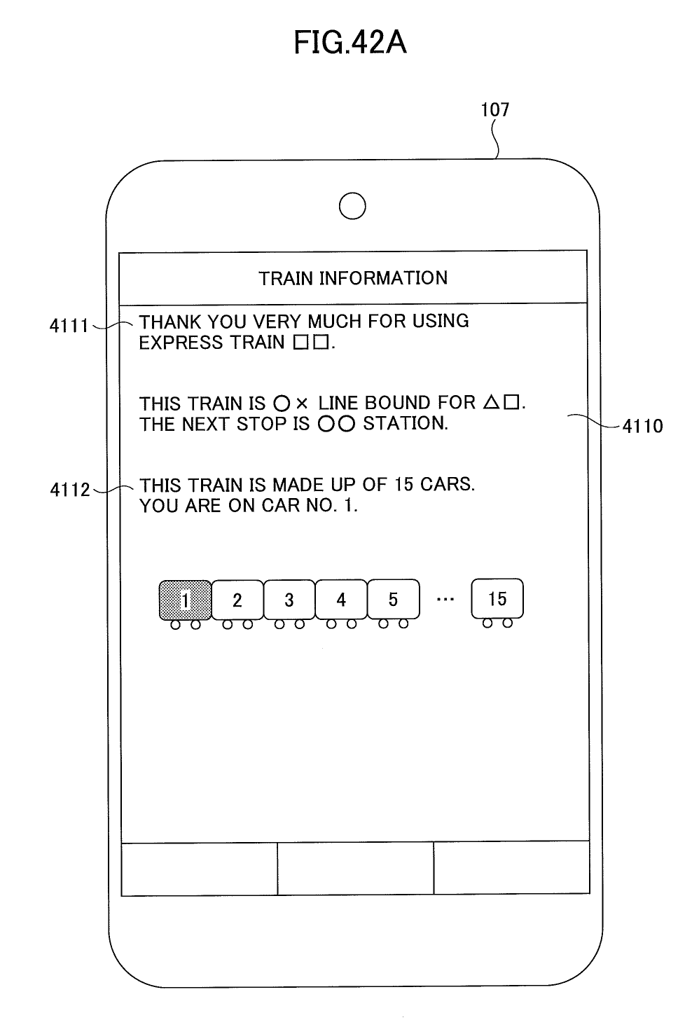

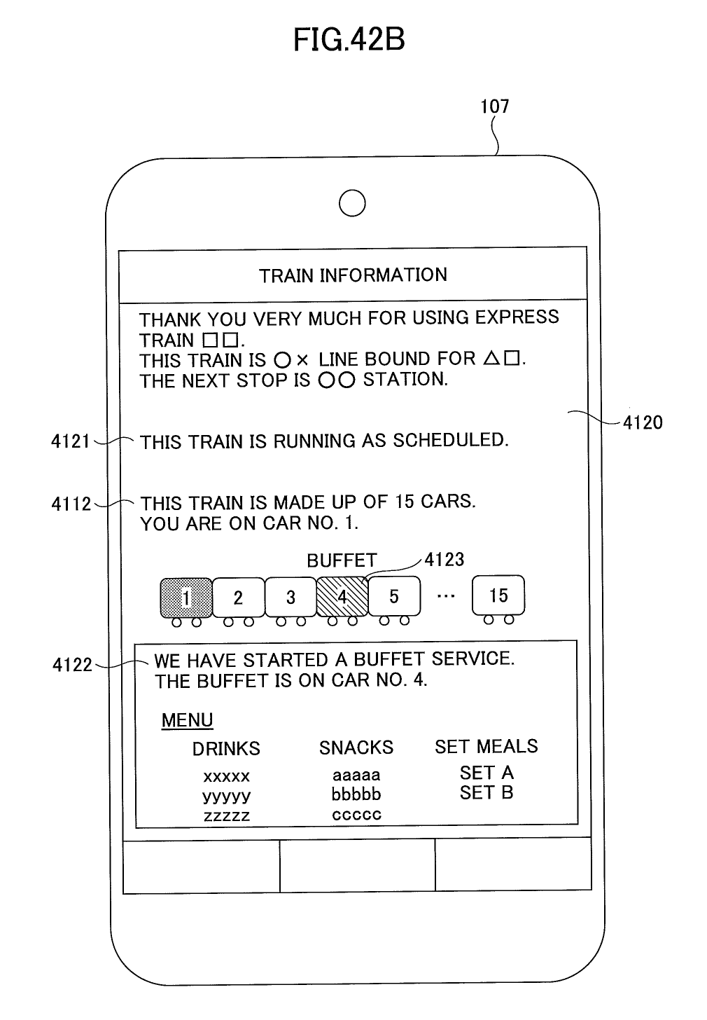

In step S4005, the display control unit 925 of the information terminal 107 displays a display screen as illustrated in FIG. 42A, for example, based on the train ID, the route ID, and the section ID extracted in step S4004 and the route information 930 stored in the storage unit 929.

Note that the route information 930 stored in the storage unit 929 of the information terminal 107 in the present embodiment may include train information associated with a train ID, route information associated with a route ID, information on train stations associated with a section ID, and information on a car number associated with an internal position ID, for example. Such information may be provided by an app installed in the information terminal 107 for implementing the information providing system 3700, for example.

FIG. 42A illustrates an example display screen 4100 that may be displayed by the information terminal 107 according to the present embodiment. In the example of FIG. 42A, the display screen 4110 of the information terminal 107 displays a message 4111 indicating the operation status of the train 3701 and internal position information 4112 indicating the car number of the car in which the user 108 of the information terminal 107 is situated.

Referring back to FIG. 41, further process steps of the information providing process according to the present embodiment are described.

In step S4006, the request information transmitting unit 924 of the information terminal 107 transmits request information including the app ID of the information terminal 107 and the extracted train ID and content ID to the operation management server 102.

In step S4007, the request information receiving unit 943 of the operation management server 102 receives the request information from the information terminal 107, and the operation information providing unit 944 acquires operation information associated with the train ID that is included in the request information from the operation information storage unit 948.

In step S4008, the operation information providing unit 944 of the operation management server 102 transmits the operation information acquired in step S4007 to the information terminal 107 corresponding to the sender of the request information.

In step S4009, the request information forwarding unit 945 of the operation management server 102 forwards the request information received in step S4006 to the content delivery server 103. The request information that is forwarded to the content delivery server 103 includes at least the app ID of the information terminal 107 corresponding to the sender of the request information and the content ID included in the received request information.

In step S4010, the request information receiving unit 962 of the content delivery server 103 receives the request information from the operation management server 102, and the content providing unit 963 acquires content corresponding to the content ID from the content information storage unit 965.

In step S4011, the content providing unit 963 of the content delivery server 103 delivers (transmits) the content acquired in step S4010 to the information terminal 107 corresponding to the sender of the request information.

In step S4012, the display control unit 925 of the information terminal 107 uses the operation information received from the operation management server 102 and the content received from the content delivery server 103 to display a display screen 4120 as illustrated in FIG. 42B, for example.

FIG. 42B illustrates an example display screen 4120 that may be displayed by the information terminal 107 according to the present embodiment. In the example of FIG. 42B, the display screen 4120 of the information terminal 107 displays a message 4121 indicating the operation status of the train 3701 and content 4122 in addition to the information items displayed on the display screen 4110 of FIG. 42A.

In the example of FIG. 42B, the content 4122 indicating services available at a buffet is displayed as an example. Further, in a preferred example, the display screen 4120 of FIG. 42B additionally displays information 4123 indicating the position of the buffet along with the internal position information 4112. Note that content that may be displayed on the display screen 4120 may include other types of information, such as a description of the view from the window or tourist information of the area surrounding the next train station, for example.

As described above, according to an aspect of the present embodiment, detailed information associated with the transport status (operation status) of a transport vehicle, such as a train, may be provided to a user (passenger) to thereby improve convenience for the user.

### Other Embodiments

Although the present invention has been described above with reference to certain illustrative embodiments, the present invention is not limited to these embodiments, and numerous variations and modifications may be made without departing from the scope of the present invention.

Note that the functional configurations of the information providing system as illustrated in FIGS. 9, 28, 33, and 38 are merely examples and the information providing system according to embodiments of the present invention may have various other system configurations. For example, in FIG. 9, at least a part of the functional elements of the content delivery server 103 may be included in the operation management server 102. Also, at least a part of the functional elements of the operation management server 102 may be included in the content delivery server 103, for example.

Also, although the operation management server 102 is used to manage operation information of the bus 105 in the example of FIG. 9, in other embodiments, the vehicle-mounted apparatus 201 of the bus 105 may be configured to manage the operation information of the bus 105 and provide the operation information of the bus 105. For example, at least one of the operation management unit 941, the operation information providing unit 944, the stop information providing unit 947, the operation information storage unit 948, the request information receiving unit 943, the request information forwarding unit 945, and the stop information receiving unit 946 included in the operation management server 102 of FIG. 9 may be included in the vehicle-mounted apparatus 201.

Further, although the information terminal 107 is configured to use an app to display various items of information in the example of FIG. 9, in other embodiments, one or more of the functions of the display control unit 925 of the information terminal 107 may be implemented by the content delivery server 103. In this case, the information terminal 107 may be configured to use a web browser to access a web server that is provided by the content delivery server 103 to display a relevant display screen, for example.

Further, the above-described bus 105 is one example of a transport vehicle for transporting passengers, such as the user 108. Embodiments of the present invention may also be applied to various other types of transport vehicles including land vehicles, such as a train, a monorail, a tram, and a taxi, and non-land vehicles, such as a ship, an aircraft, and an elevator, for example.

What is claimed is:

1. An information providing system for providing information associated with a transport status of a transport vehicle, the information providing system comprising:
a mounted apparatus that is mounted in the transport vehicle and is configured to provide guidance information associated with the transport status of the transport vehicle through audio broadcast; and
an information processing apparatus that is capable of establishing communication with the mounted apparatus;
wherein the mounted apparatus includes
an audio information storage device configured to store in advance a plurality of items of audio information having predetermined identification information embedded in an audible sound range of the audio information; and
a first processor configured to execute a first program stored in a first memory to implement a process of providing the guidance information associated with the transport status of the transport vehicle through audio broadcast using the plurality of items of audio information stored in the audio information storage device; and
wherein the information processing apparatus includes a second processor configured to execute a second program stored in a second memory to implement processes of
receiving from an information terminal that has acquired the predetermined identification information included in the guidance information, request information including the predetermined identification information and terminal identification information identifying the information terminal; and
providing to the information terminal, information that is associated with the predetermined identification information included in the received request information.

2. The information providing system according to claim 1, wherein
the audio information storage device stores in advance common audio information having transport vehicle identification information identifying the transport vehicle embedded in the audible sound range and a plurality of items of individual audio information having position identification information identifying a position of the transport vehicle embedded in the audible sound range; and
the first processor of the mounted apparatus provides the guidance information that includes the common audio information and one of the plurality of items of individual audio information that is associated with the transport status of the transport vehicle.

3. The information providing system according to claim 2, wherein the second processor of the information processing apparatus
receives from the information terminal that has acquired the transport vehicle identification information included in the guidance information, the request information that includes the transport vehicle identification information and the terminal identification information; and
provides to the information terminal, transport information relating to the transport status of the transport vehicle that is associated with the transport vehicle identification information included in the received request information.

4. The information providing system according to claim 2, wherein the second processor of the information processing apparatus
receives from the information terminal that has acquired the position identification information included in the guidance information, the request information that includes the position identification information and the terminal identification information; and
provides to the information terminal,
content that is associated with the position identification information included in the received request information.

5. The information providing system according to claim 2, wherein the second processor of the information processing apparatus further implements processes of
receiving from the information terminal,
stop information relating to a selected stopover location that has been selected from a plurality of stopover locations of the transport vehicle selectably displayed by the information terminal based on the position identification information included in the guidance information; and
providing to the mounted apparatus of the transport vehicle, notification information indicating the presence of a user that is to get off the transport vehicle at the selected stopover location.

6. The information providing system according to claim 1, wherein
the audio information storage device stores in advance additional audio information having content identification information identifying predetermined content embedded in the audible sound range;
the first processor of the mounted apparatus provides the guidance information that includes the additional audio information; and
the second processor of the information processing apparatus provides to the information terminal, the predetermined content that is associated with the content identification information included the received request information.

7. The information providing system according to claim 1, wherein
the predetermined identification information is embedded in a frequency band from 100 Hz to 12 kHz of the audio information.

8. The information providing system according to claim 1, wherein
the predetermined identification information is embedded as a digital watermark in the audio information.

9. The information providing system according to claim 1, wherein
the first processor of the mounted apparatus provides the guidance information using at least one internal speaker that is installed inside the transport vehicle or an external speaker that is installed outside the transport vehicle.

10. The information providing system according to claim 1, wherein
each of the plurality of items of audio information has the predetermined identification information embedded at least twice in the audible sound range.

11. The information providing system according to claim 1, wherein
each of the plurality of items of audio information has the predetermined identification information embedded in at least two of a plurality of different frequency bands of the audible sound range.

12. The information providing system according to claim 1, wherein
each of the plurality of items of audio information has the predetermined identification information embedded in at least two different temporal positions of the audio information.

13. A mounted apparatus that is mounted in a transport vehicle and is configured to provide guidance information associated with a transport status of the transport vehicle through audio broadcast, the mounted apparatus comprising:
an audio information storage device configured to store in advance a plurality of items of audio information having predetermined identification information embedded in an audible sound range of the audio information; and
a processor configured to execute a program stored in a memory to implement a process of providing the guidance information associated with the transport status of the transport vehicle through audio broadcast using the plurality of items of audio information stored in the audio information storage device.

14. The mounted apparatus according to claim 13, wherein the processor further implements processes of
receiving from an information terminal that has acquired the predetermined identification information included in the guidance information, request information including the predetermined identification information and terminal identification information identifying the information terminal; and
providing to the information terminal, information that is associated with the predetermined identification information included in the received request information.

15. An information processing apparatus that is capable of establishing communication with a mounted apparatus, which is mounted in a transport vehicle and is configured to provide guidance information associated with a transport status of the transport vehicle through audio broadcast using a plurality of items of audio information having predetermined identification information embedded in an audible sound range of the audio information, the information processing apparatus comprising:
a memory storing a program; and
a processor configured to execute the program to implement processes of
receiving from an information terminal that has acquired the predetermined identification included in the guidance information, request information including the predetermined identification information and terminal identification information identifying the information terminal; and
providing to the information terminal, information that is associated with the predetermined identification information included in the received request information.
